(19) United States
(12) Patent Application Publication
(10) Pub. No.: US 2022/0034561 A1
(43) Pub. Date: Feb. 3, 2022

(54) REFRIGERATION CYCLE DEVICE

(71) Applicant: DENSO CORPORATION, Kariya-city (JP)

(72) Inventors: Yuuji SUWA, Kariya-city (JP); Etsuhisa YAMADA, Kariya-city (JP); Masao YASUNO, Kariya-city (JP); Daiki KATOU, Kariya-city (JP); Masaaki KAWAKUBO, Kariya-city (JP); Atsushi INABA, Kariya-city (JP); Yuuichi KAMI, Kariya-city (JP)

(21) Appl. No.: 17/501,094

(22) Filed: Oct. 14, 2021

Related U.S. Application Data
(63) Continuation of application No. PCT/JP2020/016167, filed on Apr. 10, 2020.

(30) Foreign Application Priority Data
Apr. 19, 2019 (JP) 2019-080064
Jan. 10, 2020 (JP) 2020-002876

(51) Int. Cl. F25B 41/20; F25B 5/02

(52) U.S. Cl. CPC F25B 41/20; F25B 5/02

(57) ABSTRACT

A refrigeration cycle device includes a refrigerant circuit switching device. The refrigerant circuit switching device is configured to switch among at least a first circuit and a second circuit. The first circuit conducts refrigerant, which is outputted from a heat releasing device, to a liquid storage and conducts the refrigerant, which is outputted from the liquid storage, to a first depressurizing device and conducts the refrigerant, which is depressurized by the first depressurizing device, to an external heat exchanger. The second circuit conducts the refrigerant, which is outputted from the external heat exchanger, to the liquid storage and conducts the refrigerant, which is outputted from the liquid storage, to a second depressurizing device and conducts the refrigerant, which is depressurized by the second depressurizing device, to an evaporating device.

### CROSS REFERENCE TO RELATED APPLICATIONS

This application is a continuation application of International Patent Application No. PCT/JP2020/016167 filed on Apr. 10, 2020, which designated the U.S. and claims the benefit of priority from Japanese Patent Application No. 2019-080064 filed on Apr. 19, 2019 and Japanese Patent Application No. 2020-002876 filed on Jan. 10, 2020. The entire disclosures of all of the above applications are incorporated herein by reference.

### TECHNICAL FIELD

The present disclosure relates to a refrigeration cycle device that is configured to switch a refrigerant circuit.

### BACKGROUND

Previously, there has been proposed a refrigeration cycle device that is configured to switch a refrigerant circuit for circulating refrigerant. The refrigeration cycle device is applied to a vehicle air conditioning apparatus. The refrigeration cycle device is configured to switch among: a refrigerant circuit of a heating mode for heating and discharging blown air into a vehicle cabin; and a refrigerant circuit of a cooling mode for cooling and discharging the blown air into the vehicle cabin.

### SUMMARY

This section provides a general summary of the disclosure, and is not a comprehensive disclosure of its full scope or all of its features.

According to the present disclosure, there is provided a refrigeration cycle device comprising:

a compressor that is configured to compress and discharge refrigerant;

a heat releasing device that is configured to release heat from the refrigerant discharged from the compressor;

a liquid storage that is configured to store the refrigerant which is surplus in a cycle in the refrigeration cycle device;

a first depressurizing device that is configured to depressurize the refrigerant;

an external heat exchanger that is configured to exchange heat between the refrigerant, which is outputted from the first depressurizing device, and outside air;

a second depressurizing device that is configured to depressurize the refrigerant;

an evaporating device that is configured to evaporate the refrigerant which is depressurized by the second depressurizing device; and

a refrigerant circuit switching device that is configured to switch a refrigerant circuit, wherein the refrigerant circuit switching device is configured to switch among at least:
a first circuit that is configured to conduct the refrigerant, which is outputted from the heat releasing device, to the liquid storage and conduct the refrigerant, which is outputted from the liquid storage, to the first depressurizing device and conduct the refrigerant, which is depressurized by the first depressurizing device, to the external heat exchanger; and
a second circuit that is configured to conduct the refrigerant, which is outputted from the external heat exchanger, to the liquid storage and conduct the refrigerant, which is outputted from the liquid storage, to the second depressurizing device and conduct the refrigerant, which is depressurized by the second depressurizing device, to the evaporating device.

### BRIEF DESCRIPTION OF DRAWINGS

The drawings described herein are for illustrative purposes only of selected embodiments and not all possible implementations, and are not intended to limit the scope of the present disclosure.

FIG. 1 is an overall structure diagram of a refrigeration cycle device of a first embodiment.

FIG. 2 is a schematic structure diagram of a cabin air conditioning unit of the first embodiment.

FIG. 3 is a block diagram of an electrical control unit of a vehicle air conditioning apparatus of the first embodiment.

FIG. 4 is an overall structure diagram of a refrigeration cycle device of a second embodiment.

FIG. 5 is an overall structure diagram of a refrigeration cycle device of a third embodiment.

FIG. 6 is an overall structure diagram of a refrigeration cycle device of a fourth embodiment.

FIG. 7 is an overall structure diagram of a refrigeration cycle device of a fifth embodiment.

FIG. 8 is a Mollier diagram showing a change in a state of refrigerant in the refrigeration cycle device of the fifth embodiment.

FIG. 9 is an overall structure diagram of a refrigeration cycle device of a modification of the fifth embodiment.

FIG. 10 is an overall structure diagram of a refrigeration cycle device of another modification of the fifth embodiment.

FIG. 11 is a schematic cross-sectional view of an integrated valve of a sixth embodiment.

FIG. 12 is a Mollier diagram showing a change in a state of refrigerant in a refrigeration cycle device of the sixth embodiment.

FIG. 13 is an overall structure diagram of a refrigeration cycle device of a seventh embodiment.

FIG. 14 is an overall structure diagram of a refrigeration cycle device of an eighth embodiment.

FIG. 15 is an overall structure diagram of a refrigeration cycle device of a ninth embodiment.

FIG. 16 is an overall structure diagram of a refrigeration cycle device of a modification of the ninth embodiment.

FIG. 17 is an overall structure diagram of a refrigeration cycle device of another modification of the ninth embodiment.

FIG. 18 is an overall structure diagram of a refrigeration cycle device of a tenth embodiment.

FIG. 19 is an overall structure diagram of a refrigeration cycle device of an eleventh embodiment.

FIG. 20 is an overall structure diagram of a refrigeration cycle device of a twelfth embodiment.

FIG. 21 is an overall structure diagram of a refrigeration cycle device of a thirteenth embodiment.

FIG. 22 is an overall structure diagram of a refrigeration cycle device of a fourteenth embodiment.

FIG. 23 is an overall structure diagram of a refrigeration cycle device of a fifteenth embodiment.

FIG. 24 is an overall structure diagram of a refrigeration cycle device of a sixteenth embodiment.

FIG. 25 is an overall structure diagram of a refrigeration cycle device of another embodiment.

FIG. 26 is an overall structure diagram of a refrigeration cycle device having a four-way joint according to another embodiment.

FIG. 27 is a descriptive diagram for describing a heat exchange mode of an internal heat exchanger in a refrigeration cycle device of another embodiment.

### DETAILED DESCRIPTION

Previously, there has been proposed a refrigeration cycle device that is configured to switch a refrigerant circuit for circulating refrigerant. The refrigeration cycle device is applied to a vehicle air conditioning apparatus. The refrigeration cycle device is configured to switch among: a refrigerant circuit of a heating mode for heating and discharging blown air into a vehicle cabin; and a refrigerant circuit of a cooling mode for cooling and discharging the blown air into the vehicle cabin.

Furthermore, the refrigeration cycle device includes an accumulator. The accumulator is placed in a refrigerant flow passage that extends from a refrigerant outlet of a heat exchange device, which functions as an evaporator for evaporating the refrigerant, to a suction inlet of a compressor. The accumulator is a low-pressure side liquid storage that stores surplus refrigerant in a cycle as liquid-phase refrigerant. Therefore, in the refrigeration cycle device, even when the amount of the surplus refrigerant changes at the time of, for example, changing an operating mode, the refrigerant can be circulated at an appropriate flow rate.

However, as in the above-described refrigeration cycle device having the accumulator, it is difficult to improve a coefficient of performance (COP) of the cycle. In other words, in the refrigeration cycle device having the accumulator, it is difficult to improve the cooling performance for cooling the blown air.

This is due to the following reason. That is, in the refrigeration cycle device having the accumulator, the state of the refrigerant flowing out from the heat exchanging device serving as the evaporator approaches a state of saturated vapor phase refrigerant, so that it is difficult to increase the amount of heat absorption of the refrigerant at the heat exchange device functioning as the evaporator.

According to a first aspect of the present disclosure, there is provided a refrigeration cycle device comprising:

a compressor that is configured to compress and discharge refrigerant;

a heat releasing device that is configured to release heat from the refrigerant discharged from the compressor;

a liquid storage that is configured to store the refrigerant which is surplus in a cycle in the refrigeration cycle device;

a first depressurizing device that is configured to depressurize the refrigerant;

an external heat exchanger that is configured to exchange heat between the refrigerant, which is outputted from the first depressurizing device, and outside air;

a second depressurizing device that is configured to depressurize the refrigerant;

an evaporating device that is configured to evaporate the refrigerant which is depressurized by the second depressurizing device; and

a refrigerant circuit switching device that is configured to switch a refrigerant circuit, wherein the refrigerant circuit switching device is configured to switch among at least:
a first circuit that is configured to conduct the refrigerant, which is outputted from the heat releasing device, to the liquid storage and conduct the refrigerant, which is outputted from the liquid storage, to the first depressurizing device and conduct the refrigerant, which is depressurized by the first depressurizing device, to the external heat exchanger; and
a second circuit that is configured to conduct the refrigerant, which is outputted from the external heat exchanger, to the liquid storage and conduct the refrigerant, which is outputted from the liquid storage, to the second depressurizing device and conduct the refrigerant, which is depressurized by the second depressurizing device, to the evaporating device.

According to this, since the refrigerant circuit switching device is provided, it is possible to switch among the first circuit and the second circuit.

At the time of switching to and establishing the first circuit, the refrigerant, which is depressurized by the first depressurizing device, can be evaporated at the external heat exchanger. At this time, the high pressure liquid-phase refrigerant, which is condensed at the heat releasing device, can be stored in the liquid storage as the surplus refrigerant. Therefore, the refrigerant at the outlet of the external heat exchanger can have the superheat degree.

Furthermore, at the time of switching to and establishing the second circuit, the refrigerant, which is depressurized by the second depressurizing device, can be evaporated at the evaporating device. At this time, the high pressure liquid-phase refrigerant, which is condensed at the external heat exchanger, can be stored in the liquid storage as the surplus refrigerant. Therefore, the refrigerant at the outlet of the evaporating device can have the superheat degree.

That is, according to the refrigeration cycle device of the first aspect, at the time of switching to and establishing any one of the first circuit and the second circuit, it is possible to implement the superheat degree of the refrigerant at the outlet of the external heat exchanger, which functions as the evaporator, or the evaporating device. Accordingly, it is possible to increase the amount of heat absorption of the refrigerant at the external heat exchanger, which functions as the evaporator, or the evaporating device.

Thus, it is possible to provide the refrigeration cycle device that is configured to switch the refrigerant circuit and is capable of improving the coefficient of performance.

Furthermore, according to a second aspect of the present disclosure, there is provided a refrigeration cycle device comprising:

a compressor that is configured to compress refrigerant and includes:
a suction inlet which is configured to suction the refrigerant having a low pressure;
an intermediate-pressure suction inlet which is configured to suction the refrigerant having an intermediate pressure that is higher than the low pressure; and
a discharge outlet which is configured to discharge the refrigerant compressed by the compressor;

a heat releasing device that is configured to release heat from the refrigerant discharged from the discharge outlet;

a liquid storage that is configured to store the refrigerant which is surplus in a cycle in the refrigeration cycle device;

a first depressurizing device that is configured to depressurize the refrigerant;

an external heat exchanger that is configured to exchange heat between the refrigerant, which is outputted from the first depressurizing device, and outside air;

a second depressurizing device that is configured to depressurize the refrigerant;

an evaporating device that is configured to evaporate the refrigerant which is depressurized by the second depressurizing device; and

a third depressurizing device that is configured to depressurize at least a portion of one of:
the refrigerant, which is on an upstream side of the liquid storage; and
the refrigerant, which is outputted from the liquid storage, wherein the third depressurizing device is configured to output the refrigerant, which is depressurized by the third depressurizing device, toward the intermediate-pressure suction inlet; and

a refrigerant circuit switching device that is configured to switch a refrigerant circuit, wherein:

the refrigerant circuit switching device is configured to switch among at least:
a first circuit that is configured to conduct the refrigerant, which is outputted from the heat releasing device, to the liquid storage and conduct the refrigerant, which is outputted from the liquid storage, to the first depressurizing device and conduct the refrigerant, which is depressurized by the first depressurizing device, to the external heat exchanger; and
a second circuit that is configured to conduct the refrigerant, which is outputted from the external heat exchanger, to the liquid storage and conduct the refrigerant, which is outputted from the liquid storage, to the second depressurizing device and conduct the refrigerant, which is depressurized by the second depressurizing device, to the evaporating device; and

in a state where the refrigerant circuit switching device switches to and thereby establishes at least one of the first circuit and the second circuit, the refrigerant circuit switching device is configured to switch to and thereby establish a refrigerant circuit that conducts the refrigerant, which is depressurized by the third depressurizing device, to the intermediate-pressure suction inlet.

According to this, like the refrigeration cycle device of the first aspect, since the refrigerant circuit switching device is provided, it is possible to switch among the first circuit and the second circuit. At the time of switching to and establishing the first circuit, the refrigerant at the outlet of the external heat exchanger functioning as the evaporator can have the superheat degree. Furthermore, at the time of switching to and establishing the second circuit, the refrigerant at the outlet of the evaporating device functioning as the evaporator can have the superheat degree.

That is, according to the refrigeration cycle device of the second aspect, at the time of switching to and establishing any one of the first circuit and the second circuit, it is possible to implement the superheat degree of the refrigerant at the outlet of the external heat exchanger, which functions as the evaporator, or the evaporating device. Accordingly, it is possible to increase the amount of heat absorption of the refrigerant at the external heat exchanger, which functions as the evaporator, or the evaporating device.

Thus, it is possible to provide a refrigeration cycle device that is configured to switch the refrigerant circuit and is capable of improving the coefficient of performance.

Furthermore, at the time of switching to and establishing at least one of the first circuit and the second circuit, the refrigerant, which is depressurized by the third depressurizing device, is suctioned into the intermediate-pressure suction inlet of the compressor. According to this, since a so-called gas injection cycle can be formed, the coefficient of performance can be further improved.

Hereinafter, embodiments of the present disclosure will be described with reference to the drawings. In the respective embodiments, the same reference signs may be given to the parts corresponding to the parts described in the preceding embodiment(s), and redundant description thereof may be omitted. When only a part of the structure is described in each of the following embodiments, the description of the structure of the preceding embodiment(s) can be applied to the rest of the structure. Beside the combination of the parts explicitly mentioned in each embodiment, the embodiments may be partially combined even if such a combination is not explicitly mentioned as long as there is no particular problem in the combination.

### First Embodiment

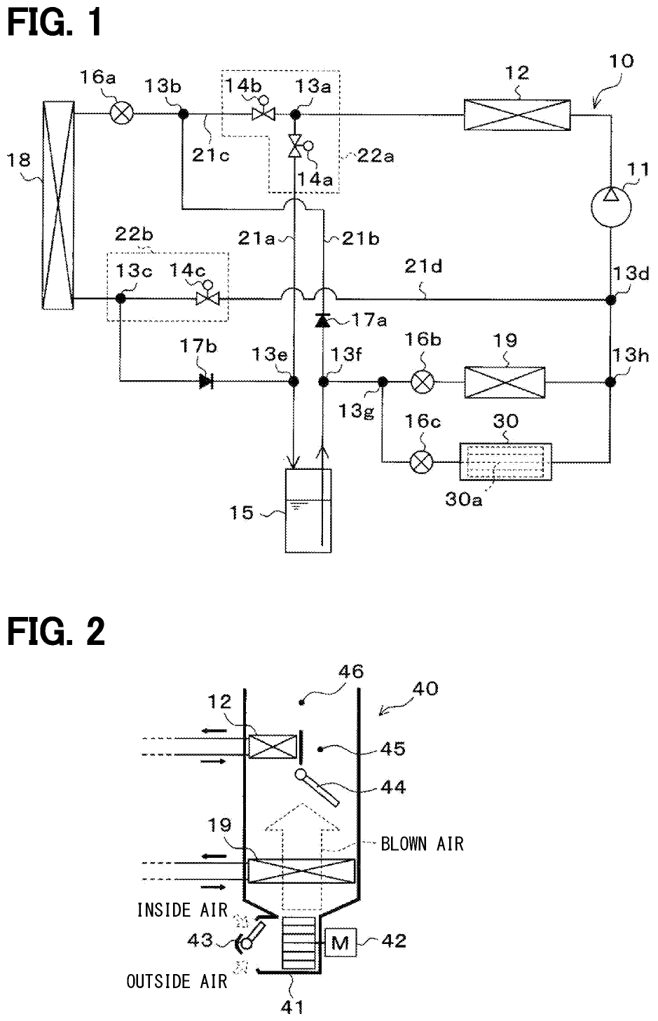

A first embodiment of a refrigeration cycle device 10 of the present disclosure will be described with reference to FIGS. 1 to 3. The refrigeration cycle device 10 is applied to a vehicle air conditioning apparatus installed on an electric vehicle. The electric vehicle is a vehicle that obtains a drive force for driving the vehicle from an electric motor. The vehicle air conditioning apparatus of the present embodiment is an air conditioning apparatus that has an in-vehicle device cooling function for cooling a battery (serving as an in-vehicle device) 30 besides a function of air conditioning a vehicle cabin (serving as an air conditioning subject space) at the electric vehicle.

In the vehicle air conditioning apparatus, the refrigeration cycle device 10 cools or heats blown air to be blown into the vehicle cabin. Furthermore, the refrigeration cycle device 10 cools the battery 30. Therefore, temperature adjustment subjects of the refrigeration cycle device 10 are the blown air and the battery 30. The refrigeration cycle device 10 is configured to switch a refrigerant circuit to execute the air conditioning of the vehicle cabin and cooling of the battery 30.

In the refrigeration cycle device 10, an HFO refrigerant (specifically, R1234yf) is used as the refrigerant. The refrigeration cycle device 10 constitutes a vapor compression type subcritical refrigeration cycle in which the pressure of the high-pressure refrigerant discharged from a compressor 11 does not exceed a critical pressure of the refrigerant. A refrigerating machine oil (specifically, PAG oil) for lubricating the compressor 11 is mixed in the refrigerant. A portion of the refrigerating machine oil is circulated along with the refrigerant.

In the refrigeration cycle device 10, the compressor 11 suctions and compresses the refrigerant and thereafter discharges the compressed refrigerant. The compressor 11 is placed in a drive device chamber located on a front side of the vehicle cabin. The drive device chamber forms a space which receives at least a portion of a drive device (e.g., an electric motor) that outputs a drive force for driving the vehicle.

The compressor 11 is an electric compressor that uses an electric motor to drive a fixed-capacity compression mechanism which has a fixed discharge capacity. A rotational speed (i.e., a refrigerant discharge pressure) of the compressor 11 is controlled by a control signal outputted from a control device 50 described later.

A discharge outlet of the compressor 11 is connected to a refrigerant inlet of an internal condenser 12. The internal condenser 12 is received in a casing 41 of a cabin air conditioning unit 40 described later. The internal condenser 12 is a heat releasing device that releases heat from the high-pressure refrigerant discharged from the compressor 11 through heat exchange between the high-pressure refrigerant and the blown air. In other words, the internal condenser 12 is a heating device that heats the blown air by using the high-pressure refrigerant discharged from the compressor 11 as a heat source.

A refrigerant outlet of the internal condenser 12 is connected to an inflow opening of a first three-way joint 13a that has three inflow/outflow openings which are communicated with each other. As such a three-way joint, a joint formed by joining a plurality of pipes or a joint formed by providing a plurality of refrigerant passages in a metal block or a resin block may be used.

Furthermore, the refrigeration cycle device 10 includes second to eighth three-way joints 13b-13h as described later. A basic structure of each of the second to eighth three-way joints 13b-13h is the same as that of the first three-way joint 13a.

In a case where the three inflow/outflow openings of any one of the first to eighth three-way joints 13a-13h are used as one inflow opening and two outflow openings, such a three-way joint 13a-13h can be used as a branching portion where a refrigerant flow, which is inputted into the inflow opening, is branched into two refrigerant flows. Furthermore, in another case where the three inflow/outflow openings of the three-way joint 13a-13h are used as two inflow openings and one outflow opening, such a three-way joint 13a-13h can be used as a merging portion where two refrigerant flows, which are respectively inputted into the two inflow openings, are merged into one refrigerant flow.

In the present embodiment, each of the first three-way joint 13a, the third three-way joint 13c, the sixth three-way joint 13f and the seventh three-way joint 13g is connected to function as the branching portion. Furthermore, each of the second three-way joint 13b, the fourth three-way joint 13d, the fifth three-way joint 13e and the eighth three-way joint 13h is connected to function as the merging portion.

One of the outflow openings of the first three-way joint 13a is connected to an inlet of a receiver 15 through a first on-off valve 14a and the fifth three-way joint 13e. The other one of the outflow openings of the first three-way joint 13a is connected to an inlet of a heating expansion valve 16a through a second on-off valve 14b and the second three-way joint 13b.

The first on-off valve 14a is a solenoid valve that opens and closes an inlet side passage 21a which extends from the one of the outflow openings of the first three-way joint 13a to the inlet of the receiver 15. An opening/closing operation of the first on-off valve 14a is controlled by a control voltage outputted from the control device 50. Furthermore, the refrigeration cycle device 10 includes a third on-off valve 14c as described later. A basic structure of each of the second on-off valve 14b and the third on-off valve 14c is the same as that of the first on-off valve 14a.

One of the inflow openings of the fifth three-way joint 13e is connected to an outlet of the first on-off valve 14a in the inlet side passage 21a. Furthermore, the outflow opening of the fifth three-way joint 13e is connected to the inlet of the receiver 15 in the inlet side passage 21a.

The receiver 15 is a liquid storage that has a gas/liquid separating function. Specifically, the receiver 15 separates the refrigerant discharged from a heat exchange device (serving as a condenser for condensing the refrigerant) of the refrigeration cycle device 10 into gas-phase refrigerant and liquid-phase refrigerant. A portion of the separated liquid-phase refrigerant is outputted from the receiver 15 toward the downstream side, and the remaining liquid-phase refrigerant is stored in the receiver 15 as surplus refrigerant that is surplus in the cycle.

The second on-off valve 14b is a solenoid valve that opens and closes an outside-air side passage 21c which extends from the other one of the outflow openings of the first three-way joint 13a to one of the inflow openings of the second three-way joint 13b. The other one of the inflow openings of the second three-way joint 13b is connected to the outlet of the receiver 15. The sixth three-way joint 13f and a first check valve 17a are installed in an outlet side passage 21b, which connects between the outlet of the receiver 15 and the other one of the inflow openings of the second three-way joint 13b.

The inflow opening of the sixth three-way joint 13f is connected to the outlet of the receiver 15 in the outlet side passage 21b. The one of the outflow openings of the sixth three-way joint 13f is connected to an inlet of the first check valve 17a in the outlet side passage 21b. The other one of the outflow openings of the sixth three-way joint 13f is connected to the inflow opening of the seventh three-way joint 13g.

The outflow opening of the second three-way joint 13b is connected to a refrigerant inlet of an external heat exchanger 18 through the heating expansion valve 16a. Therefore, the first check valve 17a, which is installed in the outlet side passage 21b, enables the refrigerant to flow from the outlet of the receiver 15 to the heating expansion valve 16a side and disables the refrigerant to flow from the heating expansion valve 16a to the outlet of the receiver 15.

The heating expansion valve 16a is a first depressurizing device that is configured to depressurize the refrigerant outputted from the receiver 15 and adjust a flow rate of the refrigerant flowing toward the downstream side thereof at least in a state where the operation is switched to a refrigerant circuit for implementing an outside air heating mode described later.

The heating expansion valve 16a is an electric variable throttle mechanism that includes a valve element, which is configured to change a throttle opening degree, and an electric actuator (specifically, a stepping motor), which is configured to displace the valve element. An operation of the heating expansion valve 16a is controlled by a control signal (specifically, a control pulse) outputted from the control device 50.

The heating expansion valve 16a has a fully opening function and a fully closing function. At the time of executing the fully opening function, a valve opening degree of the heating expansion valve 16a is set to a full opening degree, so that the heating expansion valve 16a merely functions as a refrigerant passage without exerting a flow rate adjusting action and a refrigerant depressurizing action. At the time of executing the fully closing function, the valve opening degree of the heating expansion valve 16a is set to a full closing degree, so that the heating expansion valve 16a closes the refrigerant passage.

The refrigeration cycle device 10 further includes a cooling expansion valve 16b and a cool down expansion valve 16c described later. A basic structure of each of the cooling expansion valve 16b and the cool down expansion valve 16c is the same as that of the heating expansion valve 16a. Here, it should be noted that the heating expansion valve 16a and the like may be formed by combining a variable throttle mechanism, which has no fully closing function, and an on-off valve.

The external heat exchanger 18 is a heat exchanger that executes heat exchange between the refrigerant, which is outputted from the heating expansion valve 16a, and the outside air, which is blown by an outside-air fan (not shown). The external heat exchanger 18 is placed at a front side in the drive device chamber. Therefore, the traveling wind can be applied to the external heat exchanger 18 when the vehicle is traveling.

The refrigerant outlet of the external heat exchanger 18 is connected to the inflow opening of the third three-way joint 13c. One of the outflow openings of the third three-way joint 13c is connected to one of the inflow openings of the fourth three-way joint 13d through the third on-off valve 14c. The other one of the outflow openings of the third three-way joint 13c is connected to the other one of the inflow openings of the fifth three-way joint 13e through a second check valve 17b.

The third on-off valve 14c is a solenoid valve that opens and closes a suction side passage 21d which extends from the one of the outflow openings of the third three-way joint 13c to the one of the inflow openings of the fourth three-way joint 13d. The outflow opening of the fourth three-way joint 13d is connected to the suction inlet of the compressor 11. The second check valve 17b enables the refrigerant to flow from the refrigerant outlet of the external heat exchanger 18 to the inlet of the receiver 15 and disables the refrigerant to flow from the inlet of the receiver 15 to the refrigerant outlet of the external heat exchanger 18.

As described above, the other one of the outflow openings of the sixth three-way joint 13f placed in the outlet side passage 21b is connected to the inflow opening of the seventh three-way joint 13g. One of the outflow openings of the seventh three-way joint 13g is connected to an inlet of the cooling expansion valve 16b. The other one of the outflow openings of the seventh three-way joint 13g is connected to an inlet of the cool down expansion valve 16c.

The cooling expansion valve 16b is a second depressurizing device that is configured to depressurize the refrigerant outputted from the receiver 15 and adjust a flow rate of the refrigerant flowing toward the downstream side thereof at least in a state where the operation is switched to a refrigerant circuit for implementing a cooling mode described later.

An outlet of the cooling expansion valve 16b is connected to a refrigerant inlet of an internal evaporator 19. The internal evaporator 19 is received in the casing 41 of the cabin air conditioning unit 40. The internal evaporator 19 is an evaporating device that is configured to evaporate the low-pressure refrigerant, which is depressurized by the cooling expansion valve 16b, through heat exchange between this low-pressure refrigerant and the blown air blown from an internal blower 42. The internal evaporator 19 is a blown-air cooling device that is configured to cool the blown air by evaporating the low-pressure refrigerant to exert an endothermic action. A refrigerant outlet of the internal evaporator 19 is connected to one of the inflow openings of the eighth three-way joint 13h.

The cool down expansion valve 16c is a second depressurizing device that is configured to depressurize the refrigerant outputted from the receiver 15 and adjust a flow rate of the refrigerant flowing toward the downstream side thereof at a time of cooling the battery 30. An outlet of the cool down expansion valve 16c is connected to an inlet of a refrigerant passage 30a of the battery 30.

The battery 30 supplies an electric power to electric in-vehicle devices, such as the electric motors. The battery 30 is an assembled battery formed by electrically connecting a plurality of battery cells in series or in parallel. Each of the battery cells is a rechargeable and dischargeable secondary battery (a lithium-ion battery in this embodiment). The battery 30 is constructed such that the battery cells are stacked and arranged so as to have a substantially rectangular parallelepiped shape and are received in a dedicated case.

In this type of battery, the chemical reaction does not easily proceed at low temperatures, and thereby the output of the battery tends to decrease. The battery generates heat during operation (that is, during charging and discharging of the battery). Further, the battery tends to deteriorate at a high temperature. Therefore, it is desirable that the temperature of the battery is maintained within an appropriate temperature range (a temperature range which is equal to or higher than 15° C. and is equal to or lower than 55° C. in this embodiment) in which the charge/discharge capacity of the battery can be fully utilized.

The refrigerant passage 30a of the battery 30 is formed in the dedicated case of the battery 30. The refrigerant passage 30a is an evaporating device that is configured to evaporate the low-pressure refrigerant, which is depressurized by the cool down expansion valve 16c, through heat exchange between this low-pressure refrigerant and the battery 30. That is, the refrigerant passage 30a is a battery cooling device of a direct cooling type that is configured to cool the battery 30 by transferring the heat of the battery 30 (i.e., the waste heat of the battery 30) to the low-pressure refrigerant.

Here, the refrigerant passage 30a is configured such that a plurality of passages is connected in parallel inside the dedicated case. As a result, the refrigerant passage 30a is formed such that the refrigerant passage 30a uniformly absorbs the waste heat of the battery 30 from the entire area of the battery 30. In other words, the refrigerant passage 30a is formed such that refrigerant passage 30a uniformly absorbs the heat of all the battery cells to uniformly cool the battery cells.

An outlet of the refrigerant passage 30a of the battery 30 is connected to the other one of the inflow openings of the eighth three-way joint 13h. The outflow opening of the eighth three-way joint 13h is connected to the suction inlet of the compressor 11 through the fourth three-way joint 13d.

As is clear from the above description, in the refrigeration cycle device 10, each of the first on-off valve 14a, the second on-off valve 14b, and the third on-off valve 14c is configured to open or close the corresponding one of the refrigerant passages to switch the refrigerant circuit. Therefore, the first on-off valve 14a, the second on-off valve 14b and the third on-off valve 14c are included in the refrigerant circuit switching device.

Furthermore, the first on-off valve 14a, the second on-off valve 14b and the first three-way joint 13a form a first switching device 22a of the refrigerant circuit switching device. The first switching device 22a is configured to guide the refrigerant, which is outputted from the compressor 11, toward one of the receiver 15 and the external heat exchanger 18. More specifically, the first switching device 22a of the present embodiment is configured to guide the refrigerant, which is outputted from the internal condenser 12, toward one of the receiver 15 and the second three-way joint 13b.

Furthermore, the second three-way joint 13b forms a joint of the refrigerant circuit switching device that is configured to guide one of the refrigerant, which is outputted from the first three-way joint 13a, and the refrigerant, which is outputted from the receiver 15, to the external heat exchanger 18. More specifically, the joint of the present embodiment is configured to guide one of the refrigerant, which is outputted from the first three-way joint 13a, and the refrigerant, which is outputted from the receiver 15, toward the heating expansion valve 16a.

Furthermore, the third on-off valve 14c and the third three-way joint 13c form a second switching device 22b of the refrigerant circuit switching device. The second switching device 22b is configured to guide the refrigerant, which is outputted from the external heat exchanger 18, toward one of the suction inlet of the compressor 11 and the receiver 15.

Next, the cabin air conditioning unit 40 will be described with reference to FIG. 2. The cabin air conditioning unit 40 is a unit of a vehicle air conditioning apparatus that discharges the appropriately temperature-controlled blown air to an appropriate location in the vehicle cabin. The cabin air conditioning unit 40 is arranged inside a meter cluster panel (i.e., an instrument panel) at the frontmost part of the vehicle cabin.

The cabin air conditioning unit 40 includes the casing 41 that forms an air passage of the blown air. The internal blower 42, the internal evaporator 19 and the internal condenser 12 are arranged in the air passage formed in the casing 41. The casing 41 is made of resin (e.g., polypropylene) that has a certain degree of resiliency and excellent strength.

An inside/outside air switching device 43 is arranged at a location that is on the most upstream side in the flow direction of the blown air in the casing 41. The inside/outside air switching device 43 switches between the inside air (the air at the inside of the vehicle cabin) and the outside air (the air at the outside of the vehicle cabin) and introduces it into the casing 41. An operation of an electric actuator, which drives the inside/outside air switching device 43, is controlled by a control signal outputted from the control device 50.

The internal blower 42 is located on the downstream side of the inside/outside air switching device 43 in the flow direction of the blown air. The internal blower 42 blows the air, which is suctioned through the inside/outside air switching device 43, toward the vehicle cabin. The internal blower 42 is an electric blower that uses an electric motor to drive a centrifugal multi-blade fan. A rotational speed (i.e., an air-blowing capacity) of the internal blower 42 is controlled by a control voltage outputted from the control device 50.

The internal evaporator 19 and the internal condenser 12 are located on the downstream side of the internal blower 42 in the flow direction of the blown air. Specifically, the internal evaporator 19 is located on the upstream side of the internal condenser 12 in the flow direction of the blown air. A cold-air bypass passage 45 is formed in the casing 41. The cold-air bypass passage 45 conducts the blown air, which has passed through the internal evaporator 19, toward the downstream side while bypassing the internal condenser 12.

An air mix door 44 is placed at a location that is on the downstream side of the internal evaporator 19 in the flow direction of the blown air and is on the upstream side of the internal condenser 12 in the flow direction of the blown air. The air mix door 44 adjusts a ratio between the amount of air flow to be passed through the internal condenser 12 and the amount of air flow to be passed through the cold-air bypass passage 45 among the blown air which has passed through the internal evaporator 19. An operation of an electric actuator, which drives the air mix door 44, is controlled by a control signal outputted from the control device 50.

A mixing space 46 is located on the downstream side of the internal condenser 12 in the flow direction of the blown air. The mixing space 46 is a space for mixing the blown air, which is heated by the internal condenser 12, and the blown air, which is passed through the cold-air bypass passage 45 and is not heated by the internal condenser 12. Opening holes (not shown) for discharging the blown air (the conditioning air) mixed in the mixing space 46 into the vehicle cabin are located at a location that is on the most downstream side in the flow direction of the blown air at the casing 41.

Therefore, the temperature of the conditioning air, which is mixed in the mixing space 46, can be adjusted by the air mix door 44 that adjusts the ratio between the amount of air flow passed through the internal condenser 12 and the amount of air flow passed through the cold-air bypass passage 45. Thereby, the temperature of the blown air, which is discharged from the respective opening holes into the vehicle cabin, can be adjusted.

Face opening holes, foot opening holes and defroster opening holes (not shown) are formed as the opening holes. The face opening holes are opening holes for discharging the conditioning air toward an upper body of an occupant in the vehicle cabin. The foot opening holes are opening holes for discharging the conditioning air toward feet of the occupant. The defroster opening holes are opening holes for discharging the conditioning air toward an inner surface of a front window glass of the vehicle.

A blowout mode switching door (not shown) is placed on the upstream side of these opening holes. The blowout mode switching door opens or closes the respective opening holes to switch the opening holes from which the conditioning air is discharged. An operation of an electric actuator, which drives the blowout mode switching door, is controlled by a control signal outputted from the control device 50.

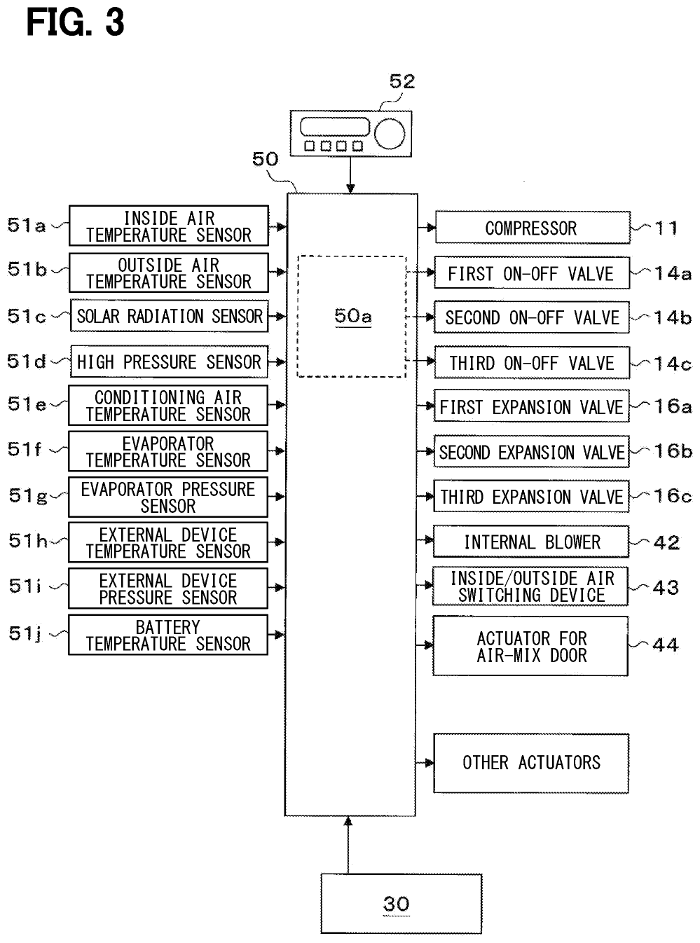

Next, the outline of an electrical control unit of the vehicle air conditioning apparatus will be described with reference to FIG. 3. The control device 50 includes a known microcomputer and its peripheral circuit. The microcomputer has a CPU, a ROM, a RAM, and the like. The control device 50 performs various calculations and processes based on an air conditioning control program stored in the ROM to control the various control-subject devices 11, 14a-14c, 16a-16c, 31, 42, 43, 44 connected to the output side of the control device 50.

As shown in FIG. 3, various control sensors are connected to an input side of the control device 50. The control sensors include an inside air temperature sensor 51a, an outside air temperature sensor 51b and a solar radiation amount sensor 51c. Furthermore, the control sensors include a high-pressure sensor 51d, a conditioning air temperature sensor 51e, an evaporator temperature sensor 51f, an evaporator pressure sensor 51g, an external device temperature sensor 51h, an external device pressure sensor 51i and a battery temperature sensor 51j.

The inside air temperature sensor 51a is an inside-air temperature sensing device that senses an inside-air temperature Tr which is the temperature of the air at the inside of the vehicle cabin. The outside air temperature sensor 51b is an outside-air temperature sensing device that senses an outside-air temperature Tam which is the temperature of the air at the outside of the vehicle cabin. The solar radiation amount sensor 51c is a solar radiation amount sensing device that senses a solar radiation amount As which is the amount of solar radiation irradiated into the vehicle cabin.

The high-pressure sensor 51d is a high-pressure sensing device that senses a high pressure Pd which is a pressure of the high-pressure refrigerant outputted from the compressor 11. The conditioning air temperature sensor 51e is a conditioning air temperature sensing device that senses a supply-air temperature TAV which is the temperature of the air discharged from the mixing space 46 into the vehicle cabin.

The evaporator temperature sensor 51f is an evaporator temperature sensing device that senses a refrigerant evaporation temperature (evaporator temperature) Te at the internal evaporator 19. Specifically, the evaporator temperature sensor 51f of the present embodiment senses the temperature of the refrigerant at the outlet of the internal evaporator 19.

The evaporator pressure sensor 51g is an evaporator pressure sensing device that senses a refrigerant evaporation pressure Pe at the internal evaporator 19. Specifically, the evaporator pressure sensor 51g of the present embodiment senses the pressure of the refrigerant at the outlet of the internal evaporator 19.

The external device temperature sensor 51h is an external device temperature sensing device that senses an external device refrigerant temperature T1 which is the temperature of the refrigerant passing through the external heat exchanger 18. Specifically, the external device temperature sensor 51h of the present embodiment senses the temperature of the refrigerant at the outlet of the external heat exchanger 18.

The external device pressure sensor 51i is an external device pressure sensing device that senses an external device refrigerant pressure P1 which is the pressure of the refrigerant passing through the external heat exchanger 18. Specifically, the external device pressure sensor 51i of the present embodiment senses the pressure of the refrigerant at the outlet of the external heat exchanger 18.

The battery temperature sensor 51j is a battery temperature sensing device that senses a battery temperature TB which is the temperature of the battery 30. The battery temperature sensor 51j includes a plurality of temperature sensing devices to measure the temperature at a plurality of locations of the battery 30. Therefore, the control device 50 can sense a temperature difference at the corresponding parts of the battery 30. Furthermore, an average of sensed values of the temperature sensing devices is used as the battery temperature TB.

Furthermore, an operation panel 52, which is placed adjacent to the meter cluster panel located at the front side in the vehicle cabin, is connected to the input side of the control device 50. Operation signals, which are outputted from various operation switches provided to the operation panel 52, are inputted to the control device 50.

The operation switches, which are provided to the operation panel 52, include an auto switch, an air conditioning switch, an air flow amount setting switch, a temperature setting switch and the like.

The auto switch is an operation switch for setting or canceling an automatic control operation of the refrigeration cycle device 10. The air conditioning switch is an operation switch for commanding a cooling operation of the blown air at the internal evaporator 19. The air flow amount setting switch is an operation switch for manually setting the amount of air flow at the internal blower 42. The temperature setting switch is an operation switch for setting a target temperature Tset of the vehicle cabin.

The control device 50 of the present embodiment is formed integrally with control units that control various control-subject devices connected to the output side of the control device 50. Therefore, an arrangement (specifically, a hardware and a software), which controls the operation of a corresponding one or more of the control-subject devices, constitutes the control unit that controls the operation of the corresponding one or more of the control-subject devices.

For example, in the control device 50, an arrangement, which controls the operations of the first on-off valve 14a, the second on-off valve 14b and the third on-off valve 14c collectively serving as the refrigerant circuit switching device, constitutes a refrigerant circuit control device 50a.

Next, the operation of the vehicle air conditioning apparatus of the present embodiment having the above-described structure will be described. The refrigeration cycle device 10 is configured to switch the refrigerant circuit to execute the air conditioning of the vehicle cabin and cooling of the battery 30.

Specifically, the refrigeration cycle device 10 of the present embodiment can switch among a refrigerant circuit for an outside air heating mode, a refrigerant circuit for a cooling mode and a refrigerant circuit for an outside air parallel dehumidifying and heating mode to air conditioning the vehicle cabin. The outside air heating mode is an operating mode for discharging the heated blown air into the vehicle cabin. The cooling mode is an operating mode for discharging the cooled blown air into the vehicle cabin. The outside air parallel dehumidifying and heating mode is an operating mode for discharging the dehumidified blown air into the vehicle cabin after reheating the dehumidified blown air that is dehumidified by cooling.

The switching among these operating modes is performed by executing the air conditioning control program stored in the control device 50 in advance. The air conditioning control program is executed when the auto switch of the operation panel 52 is turned on. The air conditioning control program executes the switching of the operating mode based on the measurement signals of the various control sensors and the operation signals of the operation panel. Hereinafter, the operation of the respective operating modes will be described.

### (a) Outside Air Heating Mode

In the outside air heating mode, the control device 50 opens the first on-off valve 14a and closes the second on-off valve 14b and opens the third on-off valve 14c. Furthermore, the control device 50 places the heating expansion valve 16a in a throttled state that exerts a refrigerant depressurizing action, and the control device 50 places the cooling expansion valve 16b in a fully closed state.

In this way, the refrigeration cycle device 10 in the outside air heating mode switches to and thereby establishes a first circuit in which the refrigerant outputted from the compressor 11 is circulated through the internal condenser 12, the receiver 15, the heating expansion valve 16a, the external heat exchanger 18 and the suction inlet of the compressor 11 in this order.

With this circuit structure, the control device 50 controls the operations of the various control-subject devices. For example, the control device 50 controls a discharge capacity of the compressor 11 such that a high pressure Pd, which is sensed by the high-pressure sensor 51d, approaches a target high pressure PDO. The target high pressure PDO is determined based on a target supply-air temperature TAO with reference to a control map for the outside air heating mode stored in the control device 50 in advance. The target supply-air temperature TAO is computed based on the measurement signals of the various control sensors and the operation signals of the operation panel.

Furthermore, the control device 50 controls the throttle opening degree of the heating expansion valve 16a such that a superheat degree SH1 of the refrigerant at the outlet of the external heat exchanger 18 approaches a predetermined target superheat degree KSH (5° C. in this embodiment). The superheat degree SH1 is computed based on the external device refrigerant temperature T1, which is sensed by the external device temperature sensor 51h, and the external device refrigerant pressure P1, which is sensed by the external device pressure sensor 51i.

Furthermore, the control device 50 controls the opening degree of the air mix door 44 such that the supply-air temperature TAV, which is sensed by the conditioning air temperature sensor 51e, approaches the target supply-air temperature TAO. In the outside air heating mode, the control device 50 may control the opening degree of the air mix door 44 such that the entire amount of the blown air, which has passed through the internal evaporator 19, flows into the internal condenser 12.

In the refrigeration cycle device 10, when the compressor 11 is operated, the high-pressure refrigerant, which is outputted from the compressor 11, flows into the internal condenser 12. The refrigerant, which flows into the internal condenser 12, is condensed by releasing the heat to the blown air, which has passed through the internal evaporator 19. In this way, the blown air is heated.

The refrigerant, which is outputted from the internal condenser 12, flows into the receiver 15 through the first three-way joint 13a and the inlet side passage 21a. The refrigerant, which flows into the receiver 15, is separated into the gas-phase refrigerant and the liquid-phase refrigerant in the receiver 15. A portion of the liquid-phase refrigerant, which is separated in the receiver 15, flows into the heating expansion valve 16a through the outlet side passage 21b and the second three-way joint 13b. The remaining liquid-phase refrigerant, which is separated in the receiver 15, is stored in the receiver 15 as the surplus refrigerant.

The refrigerant, which flows into the heating expansion valve 16a, is depressurized until it becomes the low-pressure refrigerant. At this time, the throttle opening degree of the heating expansion valve 16a is controlled such that the superheat degree SH1 of the refrigerant at the outlet of the external heat exchanger 18 approaches the target superheat degree KSH. In the outside air heating mode, the superheat degree of the refrigerant at the outlet of the external heat exchanger 18 is substantially controlled to approach the target superheat degree KSH.

The low-pressure refrigerant, which is depressurized by the heating expansion valve 16a, flows into the external heat exchanger 18. The refrigerant, which flows into the external heat exchanger 18, exchanges the heat with the outside air blown from the outside-air fan such that the refrigerant absorbs the heat from the outside air and evaporates. The refrigerant, which is outputted from the external heat exchanger 18, is suctioned into the compressor 11 through the third three-way joint 13c, the suction side passage 21d and the fourth three-way joint 13d and is compressed once again.

Therefore, in the outside air heating mode, the vehicle cabin can be heated by discharging the blown air, which is heated by the internal condenser 12, into the vehicle cabin.

### (b) Cooling Mode

In the cooling mode, the control device 50 closes the first on-off valve 14a and opens the second on-off valve 14b and closes the third on-off valve 14c. Furthermore, the control device 50 places the heating expansion valve 16a in a fully opened state and places the cooling expansion valve 16b in a throttled state.

In this way, the refrigeration cycle device 10 in the cooling mode switches to and establishes a second circuit in which the refrigerant outputted from the compressor 11 is circulated through (the internal condenser 12, the heating expansion valve 16a), the external heat exchanger 18, the receiver 15, the cooling expansion valve 16b, the internal evaporator 19 and the suction inlet of the compressor 11 in this order.

With this circuit structure, the control device 50 controls the operations of the various control-subject devices. For example, the control device 50 controls the discharge capacity of the compressor 11 such that the evaporator temperature Te, which is sensed by the evaporator temperature sensor 51f, approaches a target evaporator temperature TEO. The target evaporator temperature TEO is determined based on the target supply-air temperature TAO with reference to a control map for the cooling mode stored in the control device 50 in advance.

The control map for the cooling mode is set such that the target evaporator temperature TEO increases when the target supply-air temperature TAO increases. Further, the target evaporator temperature TEO is determined to be a value within a range (e.g., a range that is equal to or higher than 1° C.) in which frost formation of the internal evaporator 19 can be limited.

Furthermore, the control device 50 controls the throttle opening degree of the cooling expansion valve 16b such that a superheat degree SH2 of the refrigerant at the outlet of the internal evaporator 19 approaches the target superheat degree KSH. The superheat degree SH2 is computed based on the evaporator temperature Te and the refrigerant evaporation pressure Pe sensed by the evaporator pressure sensor 51g. Furthermore, the control device 50 controls the opening degree of the air mix door 44 such that the entire amount of the blown air, which has passed through the internal evaporator 19, flows into the cold-air bypass passage 45.

In the refrigeration cycle device 10, when the compressor 11 is operated, the high-pressure refrigerant, which is outputted from the compressor 11, flows into the internal condenser 12. In the cooling mode, the entire amount of the blown air, which has passed through the internal evaporator 19, flows into the cold-air bypass passage 45. Therefore, the refrigerant, which flows into the internal condenser 12, outflows from the internal condenser 12 without exchanging the heat with the blown air.

The refrigerant, which is outputted from the internal condenser 12, flows into the heating expansion valve 16a through the first three-way joint 13a and the outside-air side passage 21c. In the cooling mode, the heating expansion valve 16a is placed in a fully opened state. Therefore, the refrigerant, which flows into the heating expansion valve 16a, flows out from the heating expansion valve 16a without being depressurized. Specifically, in the cooling mode, each of the internal condenser 12 and the heating expansion valve 16a merely functions as a refrigerant passage.

The refrigerant, which is outputted from the heating expansion valve 16a, flows into the external heat exchanger 18. The refrigerant, which flows into the external heat exchanger 18, exchanges the heat with the outside air blown from the outside-air fan such that the refrigerant releases the heat to the outside air and condenses.

The refrigerant, which is outputted from the external heat exchanger 18, flows into the receiver 15 through the third three-way joint 13c, the fifth three-way joint 13e and the inlet side passage 21a. The refrigerant, which flows into the receiver 15, is separated into the gas-phase refrigerant and the liquid-phase refrigerant in the receiver 15. A portion of the liquid-phase refrigerant, which is separated in the receiver 15, flows into the cooling expansion valve 16b through the outlet side passage 21b and the sixth three-way joint 13f. The remaining liquid-phase refrigerant, which is separated in the receiver 15, is stored in the receiver 15 as the surplus refrigerant.

The refrigerant, which flows into the cooling expansion valve 16b, is depressurized until it becomes the low-pressure refrigerant. At this time, the throttle opening degree of the cooling expansion valve 16b is controlled such that the superheat degree SH2 of the refrigerant approaches the target superheat degree KSH. In the cooling mode, the superheat degree of the refrigerant at the outlet of the internal evaporator 19 is substantially controlled to approach the target superheat degree KSH.

The low-pressure refrigerant, which is depressurized by the cooling expansion valve 16b, flows into the internal evaporator 19. The refrigerant, which flows into the internal evaporator 19, exchanges the heat with the blown air blown from the internal blower 42 such that the refrigerant absorbs the heat from the blown air and evaporates. In this way, the blown air is cooled. The refrigerant, which is outputted from the internal evaporator 19, is suctioned into the compressor 11 once again through the eighth three-way joint 13h and the fourth three-way joint 13d.

Therefore, in the cooling mode, the vehicle cabin can be cooled by discharging the blown air, which is cooled by the internal evaporator 19, into the vehicle cabin.

### (c) Outside Air Parallel Dehumidifying and Heating Mode

In the outside air parallel dehumidifying and heating mode, the control device 50 opens the first on-off valve 14a and closes the second on-off valve 14b and opens the third on-off valve 14c. Furthermore, the control device 50 places the heating expansion valve 16a in the throttled state and places the cooling expansion valve 16b in the throttled state.

In this way, in the refrigeration cycle device 10 in the outside air parallel dehumidifying and heating mode, the refrigerant, which is outputted from the compressor 11, flows through the internal condenser 12 and the receiver 15 in this order. Furthermore, there is established a third circuit in which the refrigerant is circulated through the receiver 15, the heating expansion valve 16a, the external heat exchanger 18 and the suction inlet of the compressor 11 in this order, and the refrigerant is also circulated through the receiver 15, the cooling expansion valve 16b, the internal evaporator 19 and the suction inlet of the compressor 11 in this order.

Specifically, the refrigeration cycle device 10 in the outside air parallel dehumidifying and heating mode switches to and thereby establishes the circuit in which the external heat exchanger 18 and the internal evaporator 19 are connected in parallel relative to the flow of the refrigerant outputted from the receiver 15.

With this circuit structure, the control device 50 controls the operations of the various control-subject devices. For example, the control device 50 controls the discharge capacity of the compressor 11 in the same manner as in the cooling mode. Furthermore, the control device 50 controls throttle opening degree of the heating expansion valve 16a in the same manner as in the outside air heating mode. Furthermore, the control device 50 controls the throttle opening degree of the cooling expansion valve 16b in the same manner as in the cooling mode. Furthermore, the control device 50 controls the opening degree of the air mix door 44 such that the supply-air temperature TAV, which is sensed by the conditioning air temperature sensor 51e, approaches the target supply-air temperature TAO.

In the refrigeration cycle device 10, when the compressor 11 is operated, the high-pressure refrigerant, which is outputted from the compressor 11, flows into the internal condenser 12. The refrigerant, which flows into the internal condenser 12, is condensed by releasing the heat to the blown air, which has passed through the internal evaporator 19. In this way, the blown air, which has been cooled at the time of passing through the internal evaporator 19, is heated.

The refrigerant, which is outputted from the internal condenser 12, flows into the receiver 15 through the first three-way joint 13a and the inlet side passage 21a. The refrigerant, which flows into the receiver 15, is separated into the gas-phase refrigerant and the liquid-phase refrigerant in the receiver 15.

A portion of the liquid-phase refrigerant, which is separated in the receiver 15, flows into the heating expansion valve 16a through the outlet side passage 21b and the second three-way joint 13b. Another portion of the liquid-phase refrigerant, which is separated in the receiver 15, flows into the cooling expansion valve 16b through the outlet side passage 21b and the sixth three-way joint 13f. The remaining liquid-phase refrigerant, which is separated in the receiver 15, is stored in the receiver 15 as the surplus refrigerant.

The refrigerant, which flows from the receiver 15 into the heating expansion valve 16a, is depressurized until it becomes the low-pressure refrigerant. At this time, the throttle opening degree of the heating expansion valve 16a is controlled such that the external device refrigerant temperature T1 becomes lower than the outside-air temperature Tam.

The low-pressure refrigerant, which is depressurized by the heating expansion valve 16a, flows into the external heat exchanger 18. The refrigerant, which flows into the external heat exchanger 18, exchanges the heat with the outside air blown from the outside-air fan such that the refrigerant absorbs the heat from the outside air and evaporates. The refrigerant, which is outputted from the external heat exchanger 18, flows into the fourth three-way joint 13d through the third three-way joint 13c and the suction side passage 21d.

The refrigerant, which flows from the receiver 15 into the cooling expansion valve 16b, is depressurized until it becomes the low-pressure refrigerant. At this time, the throttle opening degree of the cooling expansion valve 16b is controlled such that the superheat degree SH2 of the refrigerant approaches the target superheat degree KS H.

The low-pressure refrigerant, which is depressurized by the cooling expansion valve 16b, flows into the internal evaporator 19. The refrigerant, which flows into the internal evaporator 19, exchanges the heat with the blown air blown from the internal blower 42 such that the refrigerant absorbs the heat from the blown air and evaporates. In this way, the blown air is cooled. The refrigerant, which is outputted from the internal evaporator 19, flows into the fourth three-way joint 13d through the eighth three-way joint 13h.

The flow of the refrigerant, which is outputted from the external heat exchanger 18, and the flow of the refrigerant, which is outputted from the internal evaporator 19, are merged together in the fourth three-way joint 13d. The refrigerant, which is outputted from the fourth three-way joint 13d, is suctioned into the compressor 11 and is compressed once again.

Therefore, in the outside air parallel dehumidifying and heating mode, the vehicle cabin can be dehumidified and heated by discharging the blown air, which has been dehumidified by cooling of the blown air at the internal evaporator 19 and then heated once again by the internal condenser 12, into the vehicle cabin.

As described above, in the vehicle air conditioning apparatus of the present embodiment, refrigeration cycle device 10 switches the refrigerant circuit according to each corresponding operating mode and thereby realizes comfortable air conditioning in the vehicle cabin.

In each of (a) the outside air heating mode, (b) the cooling mode and (c) the outside air parallel dehumidifying and heating mode, the battery 30 is not cooled. However, the vehicle air conditioning apparatus of the present embodiment can execute the operating mode for cooling the battery 30.

The operating mode for cooling the battery 30 can be executed without being affected by whether or not any one of the operating modes of the air conditioning is executed as long as the refrigeration cycle device 10 is operating. That is, the operating mode for cooling the battery 30 can be executed in parallel with any one of the operating modes of the air conditioning or can be executed solely.

Specifically, in the vehicle air conditioning apparatus of the present embodiment, it is possible to execute a battery-only mode in which only the battery 30 is cooled without air conditioning the vehicle cabin. Furthermore, it is possible to execute various operating modes in which the battery 30 is cooled simultaneously with the execution of the air conditioning of the vehicle cabin.

The operating mode for cooling the battery 30 is executed when the battery temperature TB sensed by the battery temperature sensor 51j becomes equal to or higher than a predetermined reference battery temperature KTB. Hereinafter, the operating modes for cooling the battery 30 will be described.

### (d) Battery-Only Mode

In the battery-only mode, the control device 50 closes the first on-off valve 14a and opens the second on-off valve 14b and closes the third on-off valve 14c. Furthermore, the control device 50 places the heating expansion valve 16a in the fully opened state and places the cooling expansion valve 16b in the fully closed state and places the cool down expansion valve 16c in the throttled state.

In this way, the refrigeration cycle device 10 in the battery-only mode switches to and thereby establishes the second circuit in which the refrigerant outputted from the compressor 11 is circulated through (the internal condenser 12, the heating expansion valve 16a), the external heat exchanger 18, the receiver 15, the cool down expansion valve 16c, the refrigerant passage 30a of the battery 30 and the suction inlet of the compressor 11 in this order.

With this circuit structure, the control device 50 controls the operations of the various control-subject devices. For example, the control device 50 controls the discharge capacity of the compressor 11 such that the battery temperature TB approaches a target battery temperature KTB2. The target battery temperature KTB2 is determined based on the battery temperature TB with reference to a control map for the battery-only mode stored in the control device 50 in advance.

Furthermore, the control device 50 controls the throttle opening degree of the cool down expansion valve 16c such that a superheat degree SH3 of the refrigerant at the outlet of the refrigerant passage 30a of the battery 30 approaches the target superheat degree KSH. Furthermore, the control device 50 stops the internal blower 42.

In the refrigeration cycle device 10, when the compressor 11 is operated, the high-pressure refrigerant, which is outputted from the compressor 11, flows into the internal condenser 12. In the battery-only mode, the internal blower 42 is stopped. Therefore, the refrigerant, which flows into the internal condenser 12, flows out from the internal condenser 12 without exchanging the heat with the blown air.

The refrigerant, which is outputted from the internal condenser 12, flows into the external heat exchanger 18 like in the cooling mode. The refrigerant, which flows into the external heat exchanger 18, exchanges the heat with the outside air blown from the outside-air fan such that the refrigerant releases the heat to the outside air and condenses. The refrigerant, which is outputted from the external heat exchanger 18, flows into the receiver 15 through the third three-way joint 13c, the fifth three-way joint 13e and the inlet side passage 21a like in the cooling mode.

A portion of the liquid-phase refrigerant, which is separated in the receiver 15, flows into the cool down expansion valve 16c through the outlet side passage 21b, the sixth three-way joint 13f and the seventh three-way joint 13g. The remaining liquid-phase refrigerant, which is separated in the receiver 15, is stored in the receiver 15 as the surplus refrigerant. The refrigerant, which flows into the cool down expansion valve 16c, is depressurized until it becomes the low-pressure refrigerant. At this time, the throttle opening degree of the cool down expansion valve 16c is controlled such that the superheat degree SH3 of the refrigerant approaches the target superheat degree KSH.

The low-pressure refrigerant, which is depressurized by the cool down expansion valve 16c, flows into the refrigerant passage 30a of the battery 30. The refrigerant, which flows into the refrigerant passage 30a, absorbs the heat of the battery 30 (i.e., the waste heat of the battery 30) and evaporates. In this way, the battery 30 is cooled. The refrigerant, which is outputted from the refrigerant passage 30a of the battery 30, is suctioned into the compressor 11 through the eighth three-way joint 13h and the fourth three-way joint 13d.

Therefore, in the battery-only mode, only the battery 30 can be cooled without air conditioning the vehicle cabin.

In (d) the battery-only mode described above, there is described the example where the internal blower 42 is stopped in the premise that the vehicle cabin is not air-conditioned. However, the internal blower 42 may be operated at the time of operating in (d) the battery-only mode. In such a case, at the same time as cooling the battery 30, it is possible to operate in the air-blow mode in which the blown air is blown into the vehicle cabin without adjusting the temperature of the blown air.

Furthermore, in the operating mode for cooling the battery 30 simultaneously with the air conditioning of the vehicle cabin, the control device 50 places the cool down expansion valve 16c in the throttled state in addition to the controlling of the control-subject devices in the same manner as in each corresponding operating mode for the air conditioning.

Therefore, in the refrigeration cycle device 10, regardless of the operating mode for the air conditioning, there is added the circuit for cooling the battery in which the refrigerant outputted from the receiver 15 flows through the cool down expansion valve 16c, the refrigerant passage 30a of the battery 30 and the suction inlet of the compressor 11 in this order.

Specifically, when the outside air heating mode and the cooling of the battery 30 are executed in parallel, the refrigeration cycle device 10 switches to and thereby establishes the circuit in which the external heat exchanger 18 and the refrigerant passage 30a of the battery 30 are connected in parallel relative to the flow of the refrigerant outputted from the receiver 15. In the following description, the operating mode, in which the outside air heating mode and the cooling of the battery 30 are executed in parallel, will be referred to as (e) an outside air waste heat heating mode.

Furthermore, when the cooling mode and the cooling of the battery 30 are executed in parallel, the refrigeration cycle device 10 switches to and thereby establishes the circuit in which the internal evaporator 19 and the refrigerant passage 30a of the battery 30 are connected in parallel relative to the flow of the refrigerant outputted from the receiver 15. In the following description, the operating mode, in which the cooling mode and the cooling of the battery 30 are executed in parallel, will be referred to as (f) a cooling battery mode.

Furthermore, when the outside air parallel dehumidifying and heating mode and the cooling of the battery 30 are executed in parallel, the refrigeration cycle device 10 switches to and thereby establishes the circuit in which the external heat exchanger 18, the internal evaporator 19 and the refrigerant passage 30a of the battery 30 are connected in parallel relative to the flow of the refrigerant outputted from the receiver 15. In the following description, the operating mode, in which the outside air parallel dehumidifying and heating mode and the cooling of the battery 30 are executed in parallel, will be referred to as (g) an outside air waste heat parallel dehumidifying and heating mode.

With this circuit structure, the control device 50 controls the operations of the various control-subject devices. For example, like in the battery-only mode, the control device 50 controls the throttle opening degree of the cool down expansion valve 16c such that the superheat degree SH3 of the refrigerant at the outlet of the refrigerant passage 30a of the battery 30 approaches the target superheat degree KSH.

In the refrigeration cycle device 10, the refrigerant, which is outputted from the receiver 15, flows into the cool down expansion valve 16c through the sixth three-way joint 13f and the seventh three-way joint 13g. The refrigerant, which flows from the receiver 15 into the cool down expansion valve 16c, is depressurized until it becomes the low-pressure refrigerant.

The low-pressure refrigerant, which is depressurized by the cool down expansion valve 16c, flows into the refrigerant passage 30a of the battery 30. The refrigerant, which flows into the refrigerant passage 30a, absorbs the heat of the battery 30 (i.e., the waste heat of the battery 30) and evaporates. In this way, the battery 30 is cooled. The refrigerant, which is outputted from the refrigerant passage 30a of the battery 30, is suctioned into the compressor 11 through the eighth three-way joint 13h and the fourth three-way joint 13d.

As described above, in the vehicle air conditioning apparatus of the present embodiment, the battery 30 can be cooled simultaneously with the air conditioning of the vehicle cabin by executing (e) the outside air waste heat heating mode, (f) the cooling battery mode or (g) the outside air waste heat parallel dehumidifying and heating mode. Furthermore, in (e) the outside air waste heat heating mode and (g) the outside air waste heat parallel dehumidifying and heating mode, the waste heat of the battery 30 can be used as the heat source for heating the blown air.

Furthermore, as described with respect to (a) the outside air heating mode, when the refrigeration cycle device 10 of the present embodiment switches to and thereby establishes the first circuit, the refrigerant, which is depressurized by the heating expansion valve 16a, can be evaporated at the external heat exchanger 18. At this time, the liquid-phase refrigerant, which is condensed at the internal condenser 12 and has the high pressure, can be stored in the receiver 15 as the surplus refrigerant. Therefore, the refrigerant at the outlet of the external heat exchanger 18 can have the superheat degree.

Accordingly, the amount of heat absorption of the refrigerant at the external heat exchanger 18, which is the heat exchange device that evaporates the refrigerant, can be increased in comparison to a refrigeration cycle device (hereinafter, referred to as a refrigeration cycle device of a comparative example) that includes an accumulator that is a low-pressure side liquid storage serving as a liquid storage. Therefore, the amount of heat release of the refrigerant at the internal condenser 12 can be increased, and thereby the heating performance of the internal condenser 12 for heating the blown air can be improved.

Thus, in the refrigeration cycle device 10 in (a) the outside air heating mode, the coefficient of performance of the cycle can be improved in comparison to the refrigeration cycle device of the comparative example.

Here, the accumulator is the low-pressure side liquid storage that stores the surplus refrigerant in the cycle as the liquid-phase refrigerant and is placed in the refrigerant flow passage extending from the refrigerant outlet of the heat exchange device, which evaporates the refrigerant, to the suction inlet of the compressor. The amount of heat absorption of the refrigerant at the heat exchange device, which evaporates the refrigerant, is defined by an enthalpy difference, and this enthalpy difference is obtained by subtracting the enthalpy of the refrigerant at the inlet of the heat exchange device, which evaporates the refrigerant, from the enthalpy of the refrigerant at the outlet of the heat exchange device.

Furthermore, as described with respect to (b) the cooling mode, when the refrigeration cycle device 10 of the present embodiment switches to and thereby establishes the second circuit, the refrigerant, which is depressurized by the cooling expansion valve 16b, can be evaporated at the internal evaporator 19. At this time, the liquid-phase refrigerant, which is condensed at the external heat exchanger 18 and has the high pressure, can be stored in the receiver 15 as the surplus refrigerant. Therefore, the refrigerant at the outlet of the internal evaporator 19 can have the superheat degree.

Accordingly, the amount of heat absorption of the refrigerant at the internal evaporator 19, which is the heat exchange device that evaporates the refrigerant, can be increased in comparison to the refrigeration cycle device of the comparative example. Therefore, the cooling performance of the internal evaporator 19 for cooling the blown air can be improved.

Thus, in the refrigeration cycle device 10 in the cooling mode, the coefficient of performance of the cycle can be improved in comparison to the refrigeration cycle device of the comparative example.

Furthermore, as described with respect to (c) the outside air parallel dehumidifying and heating mode, when the refrigeration cycle device 10 of the present embodiment switches to and thereby establishes the third circuit, the refrigerant, which is depressurized by the cooling expansion valve 16b, can be evaporated at the internal evaporator 19. Furthermore, the refrigerant, which is depressurized by the cooling expansion valve 16b, can be evaporated at the internal evaporator 19.

At this time, the liquid-phase refrigerant, which is condensed at the internal condenser 12 and has the high pressure, can be stored in the receiver 15 as the surplus refrigerant. Therefore, the refrigerant at the outlet of the external heat exchanger 18 and the refrigerant at the outlet of the internal evaporator 19 can both have the superheat degree.

Accordingly, the amount of heat absorption of the refrigerant at the external heat exchanger 18, which is the heat exchange device that evaporates the refrigerant, can be increased in comparison to the refrigeration cycle device of the comparative example. Therefore, the amount of heat release of the refrigerant at the internal condenser 12 can be increased, and thereby the heating performance of the internal condenser 12 for heating the blown air can be improved.

Furthermore, the amount of heat absorption of the refrigerant at the internal evaporator 19, which is the heat exchange device that evaporates the refrigerant, can be increased in comparison to the refrigeration cycle device of the comparative example. Therefore, the cooling performance of the internal evaporator 19 for cooling the blown air can be improved.

Thus, in the refrigeration cycle device 10 in (c) the outside air parallel dehumidifying and heating mode, the coefficient of performance of the cycle can be improved in comparison to the refrigeration cycle device of the comparative example. Specifically, the refrigeration cycle device 10 of the present embodiment can improve the coefficient of performance even though the refrigeration cycle device 10 can switch the refrigerant circuit.

Furthermore, in the present embodiment, the first on-off valve 14a, the second on-off valve 14b and the first three-way joint 13a form the first switching device 22a. The first switching device 22a of the present embodiment is configured to guide the refrigerant, which is outputted from the internal condenser 12, toward one of the receiver 15 and the second three-way joint 13b.

Furthermore, the second three-way joint 13b, which serves as the joint of the present embodiment, is configured to guide one of the refrigerant, which is outputted from the first three-way joint 13a, and the refrigerant, which is outputted from the receiver 15, toward the heating expansion valve 16a.

Furthermore, the third on-off valve 14c, the third three-way joint 13c and the second check valve 17b form the second switching device 22b. The second switching device 22b of the present embodiment is configured to guide the refrigerant, which is outputted from the external heat exchanger 18, toward one of the suction inlet of the compressor 11 and the receiver 15.

Therefore, it is possible to easily realize the refrigeration cycle device in which the flow direction of the refrigerant in the receiver 15 does not change even when the refrigerant circuit is switched. Therefore, the gas-liquid separation performance of the receiver 15 is unlikely to change even when the refrigerant circuit is switched. Furthermore, it is possible to easily realize the refrigeration cycle device that stores the surplus refrigerant of the cycle in the common receiver 15 even when the refrigerant circuit is switched. Therefore, it is possible to limit an increase in a size of the entire refrigeration cycle device 10.

Furthermore, the operating modes of the refrigeration cycle device 10 should not be limited to the above-described operating modes. For example, (h) an evaporator-only dehumidifying and heating mode, (i) a waste heat heating mode and (j) a waste heat parallel dehumidifying and heating mode described later may be executed. Here, it should be noted that (h) the evaporator-only dehumidifying and heating mode, (i) the waste heat heating mode and (j) the waste heat parallel dehumidifying and heating mode are operating modes in each of which the refrigerant is not conducted through the external heat exchanger 18.

### (h) Evaporator-Only Dehumidifying and Heating Mode

In the evaporator-only dehumidifying and heating mode, the control device 50 opens the first on-off valve 14a and closes the second on-off valve 14b. Furthermore, the control device 50 places the heating expansion valve 16a in the fully closed state and places the cooling expansion valve 16b in the throttled state and places the cool down expansion valve 16c in the fully closed state.

In this way, the refrigeration cycle device 10 in the evaporator-only dehumidifying and heating mode switches to and establishes a refrigerant circuit in which the refrigerant outputted from the compressor 11 is circulated through the internal condenser 12, the receiver 15, the cooling expansion valve 16b, the internal evaporator 19 and the suction inlet of the compressor 11 in this order.

With this circuit structure, the control device 50 controls the operations of the various control-subject devices. For example, the control device 50 controls the compressor 11 and the cooling expansion valve 16b in the same manner as in the cooling mode.

Thus, the refrigeration cycle device 10 in the evaporator-only dehumidifying and heating mode forms a vapor compression refrigeration cycle in which the internal condenser 12 functions as the condenser, and the internal evaporator 19 functions as the evaporator.

Therefore, in the evaporator-only dehumidifying and heating mode, the vehicle cabin can be dehumidified and heated by discharging the blown air, which has been dehumidified by cooling of the blown air at the internal evaporator 19 and then heated once again by the internal condenser 12, into the vehicle cabin.

### (i) Waste Heat Heating Mode

In the waste heat heating mode, the control device 50 opens the first on-off valve 14a and closes the second on-off valve 14b. Furthermore, the control device 50 places the heating expansion valve 16a in the fully closed state and places the cooling expansion valve 16b in the fully closed state and places the cool down expansion valve 16c in the throttled state.

In this way, the refrigeration cycle device 10 in the waste heat heating mode switches to and thereby establishes a refrigerant circuit in which the refrigerant outputted from the compressor 11 is circulated through the internal condenser 12, the receiver 15, the cool down expansion valve 16c, the refrigerant passage 30a of the battery 30 and the suction inlet of the compressor 11 in this order.

With this circuit structure, the control device 50 controls the operations of the various control-subject devices. For example, the control device 50 controls the compressor 11 in the same manner as in the outside air heating mode. At this time, when the cooling of the battery 30 is prioritized over the heating of the vehicle cabin, the operation of the compressor 11 may be controlled in the same manner as in the battery-only mode. Furthermore, the control device 50 controls the cool down expansion valve 16c in the same manner as in the battery-only mode.

Thus, the refrigeration cycle device 10 in the waste heat heating mode forms a vapor compression refrigeration cycle in which the internal condenser 12 functions as the condenser, and the refrigerant passage 30a of the battery 30 functions as the evaporator.

Therefore, in the waste heat heating mode, the vehicle cabin can be heated by discharging the blown air, which is heated by the internal condenser 12, into the vehicle cabin. Further, the refrigerant flowing through the refrigerant passage 30a of the battery 30 absorbs heat from the battery 30, so that the battery 30 can be cooled. The absorbed heat of the refrigerant, which is absorbed from the battery 30, can be used as the heat source of the blown air.

### (j) Waste Heat Parallel Dehumidifying and Heating Mode

In the waste heat parallel dehumidifying and heating mode, the control device 50 opens the first on-off valve 14a and closes the second on-off valve 14b. Furthermore, the control device 50 places the heating expansion valve 16a in the fully closed state and places the cooling expansion valve 16b in the throttled state and places the cool down expansion valve 16c in the throttled state.

In this way, in the refrigeration cycle device 10 in the waste heat parallel dehumidifying and heating mode, the refrigerant, which is outputted from the compressor 11, flows through the internal condenser 12 and the receiver 15 in this order. Furthermore, there is established a refrigerant circuit in which the refrigerant is circuited through the receiver 15, the cooling expansion valve 16b, the internal evaporator 19 and the suction inlet of the compressor 11 in this order, and the refrigerant is also circulated through the receiver 15, the cool down expansion valve 16c, the refrigerant passage 30a of the battery 30 and the suction inlet of the compressor 11 in this order.

Specifically, the refrigeration cycle device 10 in the waste heat parallel dehumidifying and heating mode switches to and thereby establishes the circuit in which the internal evaporator 19 and the refrigerant passage 30a of the battery 30 are connected in parallel relative to the flow of the refrigerant outputted from the receiver 15. That is, the waste heat parallel dehumidifying and heating mode is the operating mode in which the evaporator-only dehumidifying and heating mode and the cooling of the battery 30 are executed in parallel.

With this circuit structure, the control device 50 controls the operations of the various control-subject devices. For example, the control device 50 controls the compressor 11 and the cooling expansion valve 16b in the same manner as in the cooling mode. Furthermore, the control device 50 controls the cool down expansion valve 16c in the same manner as in the battery-only mode.

Thus, the refrigeration cycle device 10 in the waste heat parallel dehumidifying and heating mode forms a vapor compression refrigeration cycle in which the internal condenser 12 functions as the condenser, and the internal evaporator 19 and the refrigerant passage 30a of the battery 30 respectively function as the evaporators.

Therefore, in the waste heat parallel dehumidifying and heating mode, the vehicle cabin can be dehumidified and heated by discharging the blown air, which has been dehumidified by cooling of the blown air at the internal evaporator 19 and then heated once again by the internal condenser 12, into the vehicle cabin. Further, the refrigerant flowing through the refrigerant passage 30a of the battery 30 absorbs heat from the battery 30, so that the battery 30 can be cooled. The absorbed heat of the refrigerant, which is absorbed from the battery 30, can be used as the heat source of the blown air.

Furthermore, for example, (k) a series evaporator-only dehumidifying and heating mode, (m) a series waste heat heating mode and (n) a series waste heat parallel dehumidifying and heating mode described later may be executed as the operating modes of the refrigeration cycle device 10. Here, it should be noted that (k) the series evaporator-only dehumidifying and heating mode, (m) the series waste heat heating mode and (n) the series waste heat parallel dehumidifying and heating mode are operating modes in each of which the internal condenser 12 and the external heat exchanger 18 are connected in series through the heating expansion valve 16a.

### (k) Series Evaporator-Only Dehumidifying and Heating Mode

In the series evaporator-only dehumidifying and heating mode, the control device 50 closes the first on-off valve 14a and opens the second on-off valve 14b and closes the third on-off valve 14c. Furthermore, the control device 50 places the heating expansion valve 16a in the throttled state and places the cooling expansion valve 16b in the throttled state and places the cool down expansion valve 16c in the fully closed state.

In this way, the refrigeration cycle device 10 in the series evaporator-only dehumidifying and heating mode switches to and establishes a refrigerant circuit in which the refrigerant outputted from the compressor 11 is circulated through the internal condenser 12, the heating expansion valve 16a, the external heat exchanger 18, the receiver 15, the cooling expansion valve 16b, the internal evaporator 19 and the suction inlet of the compressor 11 in this order.

With this circuit structure, the control device 50 controls the operations of the various control-subject devices. For example, the control device 50 controls the compressor 11 and the cooling expansion valve 16b in the same manner as in the cooling mode.

The control device 50 adjusts the throttle opening degree of the heating expansion valve 16a such that the temperature of the high-pressure refrigerant outputted from the internal condenser 12 becomes a reference temperature. Specifically, the throttle opening degree of the heating expansion valve 16a is adjusted such that the high pressure Pd, which is sensed by the high-pressure sensor 51d, becomes a reference high pressure KPd. Furthermore, the throttle opening degree of the heating expansion valve 16a is adjusted within a range in which the temperature of the refrigerant flowing into the external heat exchanger 18 becomes higher than the outside-air temperature.

Thus, the refrigeration cycle device 10 in the series evaporator-only dehumidifying and heating mode forms a vapor compression refrigeration cycle in which the internal condenser 12 and the external heat exchanger 18 respectively function as the condensers, and the internal evaporator 19 functions as the evaporator.

Therefore, in the series evaporator-only dehumidifying and heating mode, the vehicle cabin can be dehumidified and heated by discharging the blown air, which has been dehumidified by cooling of the blown air at the internal evaporator 19 and then heated once again by the internal condenser 12, into the vehicle cabin.

In addition, in the series evaporator-only dehumidifying and heating mode, the amount of heat release of the refrigerant at the internal condenser 12 can be adjusted by adjusting the throttle opening degree of the heating expansion valve 16a. Therefore, the heating performance of the internal condenser 12 for heating the blown air can be appropriately adjusted.

### (m) Series Waste Heat Heating Mode

In the series waste heat heating mode, the control device 50 closes the first on-off valve 14a and opens the second on-off valve 14b and closes the third on-off valve 14c. Furthermore, the control device 50 places the heating expansion valve 16a in the throttled state and places the cooling expansion valve 16b in the fully closed state and places the cool down expansion valve 16c in the throttled state.

In this way, the refrigeration cycle device 10 in the series waste heat heating mode switches to and thereby establishes a refrigerant circuit in which the refrigerant outputted from the compressor 11 is circulated through the internal condenser 12, the heating expansion valve 16a, the external heat exchanger 18, the receiver 15, the cool down expansion valve 16c, the refrigerant passage 30a of the battery 30 and the suction inlet of the compressor 11 in this order.

With this circuit structure, the control device 50 controls the operations of the various control-subject devices. For example, the control device 50 controls the compressor 11 in the same manner as in the outside air heating mode. At this time, when the cooling of the battery 30 is prioritized over the heating of the vehicle cabin, the operation of the compressor 11 may be controlled in the same manner as in the battery-only mode. Furthermore, the control device 50 controls the heating expansion valve 16a in the same manner as in the series evaporator-only dehumidifying and heating mode. Furthermore, the control device 50 controls the cool down expansion valve 16c in the same manner as in the battery-only mode.

Thus, the refrigeration cycle device 10 in the series waste heat heating mode forms a vapor compression refrigeration cycle in which the internal condenser 12 and the external heat exchanger 18 respectively function as the condensers, and the refrigerant passage 30a of the battery 30 functions as the evaporator.

Therefore, in the series waste heat heating mode, the vehicle cabin can be heated by discharging the blown air, which is heated by the internal condenser 12, into the vehicle cabin. Further, the refrigerant flowing through the refrigerant passage 30a of the battery 30 absorbs heat from the battery 30, so that the battery 30 can be cooled. The absorbed heat of the refrigerant, which is absorbed from the battery 30, can be used as the heat source of the blown air.

In addition, in the series waste heat heating mode, the amount of heat release of the refrigerant at the internal condenser 12 can be adjusted by adjusting the throttle opening degree of the heating expansion valve 16a. Therefore, the heating performance of the internal condenser 12 for heating the blown air can be appropriately adjusted.

### (n) Series Waste Heat Parallel Dehumidifying and Heating Mode

In the series waste heat parallel dehumidifying and heating mode, the control device 50 closes the first on-off valve 14a and opens the second on-off valve 14b and closes the third on-off valve 14c. Furthermore, the control device 50 places the heating expansion valve 16a in the throttled state and places the cooling expansion valve 16b in the throttled state and places the cool down expansion valve 16c in the throttled state.

In this way, in the refrigeration cycle device 10 in the series waste heat parallel dehumidifying and heating mode, the refrigerant, which is outputted from the compressor 11, flows through the internal condenser 12, the heating expansion valve 16a, the external heat exchanger 18 and the receiver 15 in this order. Furthermore, there is established a refrigerant circuit in which the refrigerant is circuited through the receiver 15, the cooling expansion valve 16b, the internal evaporator 19 and the suction inlet of the compressor 11 in this order, and the refrigerant is also circulated through the receiver 15, the cool down expansion valve 16c, the refrigerant passage 30a of the battery 30 and the suction inlet of the compressor 11 in this order.

Specifically, the refrigeration cycle device 10 in the series waste heat parallel dehumidifying and heating mode switches to and thereby establishes the circuit in which the internal evaporator 19 and the refrigerant passage 30a of the battery 30 are connected in parallel relative to the flow of the refrigerant outputted from the receiver 15.

With this circuit structure, the control device 50 controls the operations of the various control-subject devices. For example, the control device 50 controls the compressor 11 and the cooling expansion valve 16b in the same manner as in the cooling mode. Furthermore, the control device 50 controls the cool down expansion valve 16c in the same manner as in the battery-only mode. The control device 50 controls the heating expansion valve 16a in the same manner as in the series evaporator-only dehumidifying and heating mode.

Thus, the refrigeration cycle device 10 in the series waste heat parallel dehumidifying and heating mode forms a vapor compression refrigeration cycle in which the internal condenser 12 and the external heat exchanger 18 respectively function as the condensers, and the internal evaporator 19 and the refrigerant passage 30a of the battery 30 respectively function as the evaporators.

Therefore, in the series waste heat parallel dehumidifying and heating mode, the vehicle cabin can be dehumidified and heated by discharging the blown air, which has been dehumidified by cooling of the blown air at the internal evaporator 19 and then heated once again by the internal condenser 12, into the vehicle cabin. Further, the refrigerant flowing through the refrigerant passage 30a of the battery 30 absorbs heat from the battery 30, so that the battery 30 can be cooled. The absorbed heat of the refrigerant, which is absorbed from the battery 30, can be used as the heat source of the blown air.

In addition, in the series waste heat parallel dehumidifying and heating mode, the amount of heat release of the refrigerant at the internal condenser 12 can be adjusted by adjusting the throttle opening degree of the heating expansion valve 16a. Therefore, the heating performance of the internal condenser 12 for heating the blown air can be appropriately adjusted.

In (a) the outside air heating mode, (c) the outside air parallel dehumidifying and heating mode, (e) the outside air waste heat heating mode and (g) the outside air waste heat parallel dehumidifying and heating mode, the refrigerant evaporation temperature at the external heat exchanger 18 becomes equal to or lower than the outside-air temperature. Therefore, when these operating modes are executed in the state where the outside-air temperature is low, frost may occur on the external heat exchanger 18.

In view of this, when a frosting condition, which suggests generation of the frost on the external heat exchanger 18, is satisfied, the external heat exchanger 18 may be defrosted by switching to the (b) the cooling mode, (d) the battery-only mode or (f) the cooling battery mode for a predetermined time period. In this way, the high temperature refrigerant, which is outputted from the compressor 11, flows into the external heat exchanger 18 to defrost the external heat exchanger 18.

Furthermore, in the case where the operation is switched to (b) the cooling mode, (d) the battery-only mode or (f) the cooling battery mode to defrost the external heat exchanger 18, the control device 50 may control the operation of the compressor 11 such that the compressor 11 implements a predetermined defrosting performance. Furthermore, for example, the frosting condition may be as follows. That is, the frosting condition is satisfied when a time period, during which the external device refrigerant temperature T1 is kept equal to or lower than a reference frosting temperature (e.g., −5° C.), is equal to or longer than a reference frosting time period (e.g., 5 minutes).

Furthermore, in a case where the frosting condition is satisfied in the middle of executing (c) the outside air parallel dehumidifying and heating mode, the operation may be switched to (b) the cooling mode to defrost the external heat exchanger 18. According to this, since it is not necessary to change the control mode of the cooling expansion valve 16b and the cool down expansion valve 16c, the external heat exchanger 18 can be quickly defrosted.

Similarly, in a case where the frosting condition is satisfied in the middle of executing (e) the outside air waste heat heating mode, the operation may be switched to (d) the battery-only mode to execute the defrosting of the external heat exchanger 18. Also, similarly, in a case where the frosting condition is satisfied in the middle of executing (g) the outside air waste heat parallel dehumidifying and heating mode, the operation may be switched to (f) the cooling battery mode to execute the defrosting of the external heat exchanger 18.

### Second Embodiment

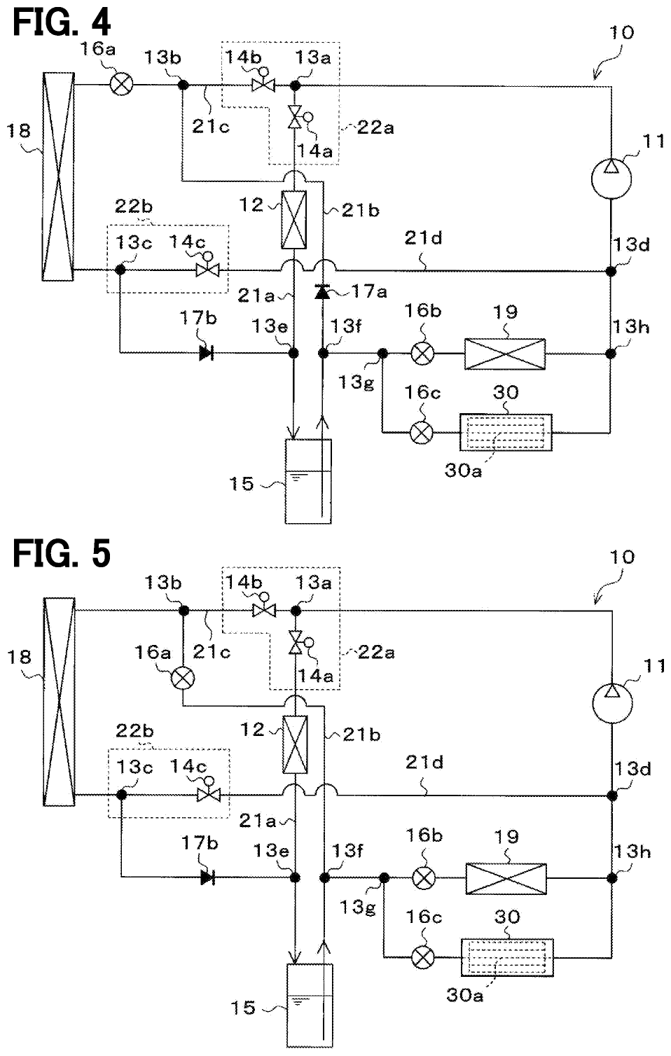

In the present embodiment, there will be described an example where the cycle structure of the refrigeration cycle device 10 is changed relative to the first embodiment as indicated in an overall structure diagram shown in FIG. 4.

In the refrigeration cycle device 10 of the present embodiment, the internal condenser 12 is placed in the inlet side passage 21a. The refrigerant inlet of the internal condenser 12 is connected to the outlet of the first on-off valve 14a in the inlet side passage 21a. Furthermore, the refrigerant outlet of the internal condenser 12 is connected to the one of the inflow openings of the fifth three-way joint 13e in the inlet side passage 21a.

Therefore, the first switching device 22a of the refrigerant circuit switching device of the present embodiment is configured to guide the refrigerant, which is outputted from the compressor 11, toward one of the internal condenser 12 and the second three-way joint 13b. Furthermore, the second three-way joint 13b, which serves as the joint of the present embodiment, is configured to guide one of the refrigerant, which is outputted from the first three-way joint 13a, and the refrigerant, which is outputted from the receiver 15, toward the heating expansion valve 16a. The rest of the structure and the rest of the operation are the same as those of the first embodiment.

Therefore, the refrigeration cycle device 10 of the present embodiment can be operated in a manner similar to the first embodiment and can achieve the advantages which are similar to those of the first embodiment. Specifically, even when the operation is switched to any one of the operating modes, the liquid-phase refrigerant, which has the high pressure, can be stored in the receiver 15 as the surplus refrigerant. Therefore, the coefficient of performance can be improved.

Furthermore, even when the first switching device 22a and the joint are connected as in the present embodiment, it is possible to achieve the advantages which are similar to those of the first embodiment. Specifically, even when the refrigerant circuit is switched, the flow direction of the refrigerant in the receiver 15 does not change, and it is possible to easily realize the refrigeration cycle device that stores the surplus refrigerant of the cycle in the common receiver 15.

In addition, in the refrigeration cycle device 10 of the present embodiment, the refrigerant does not flow into the internal condenser 12 at the time of operating in the cooling mode. Therefore, at the time of operating in the cooling mode, the pressure loss, which occurs at the time of flowing the refrigerant through the internal condenser 12, does not occur. In this way, at the time of operating in the cooling mode, the power consumption of the compressor 11 can be reduced, and the coefficient of performance can be further improved.

### Third Embodiment

In the present embodiment, there will be described an example where the cycle structure of the refrigeration cycle device 10 is changed relative to the second embodiment as indicated in an overall structure diagram shown in FIG. 5.

In the refrigeration cycle device 10 of the present embodiment, the heating expansion valve 16a is placed in the outlet side passage 21b. The inlet of the heating expansion valve 16a is connected to the one of the outflow openings of the sixth three-way joint 13f in the outlet side passage 21b. Furthermore, the outlet of the heating expansion valve 16a is connected to the other one of the inflow openings of the second three-way joint 13b in the outlet side passage 21b. Furthermore, the first check valve 17a is eliminated.

Therefore, the first switching device 22a of the refrigerant circuit switching device of the present embodiment is configured to guide the refrigerant, which is outputted from the compressor 11, toward one of the internal condenser 12 and the second three-way joint 13b. Furthermore, the second three-way joint 13b, which serves as the joint of the present embodiment, is configured to guide one of the refrigerant, which is outputted from the first three-way joint 13a, and the refrigerant, which is outputted from the heating expansion valve 16a, toward the external heat exchanger 18. The rest of the structure and the rest of the operation are the same as those of the second embodiment.

Therefore, the refrigeration cycle device 10 of the present embodiment can be operated in a manner similar to that of the second embodiment and can achieve advantages which are similar to those of the second embodiment. Specifically, even when the operation is switched to any one of the operating modes, the liquid-phase refrigerant, which has the high pressure, can be stored in the receiver 15 as the surplus refrigerant. Therefore, the coefficient of performance can be improved.

Furthermore, even when the first switching device 22a and the joint are connected as in the present embodiment, it is possible to achieve the advantages which are similar to those of the second embodiment. Specifically, even when the refrigerant circuit is switched, the flow direction of the refrigerant in the receiver 15 does not change, and it is possible to easily realize the refrigeration cycle device that stores the surplus refrigerant of the cycle in the common receiver 15.

In addition, in the refrigeration cycle device 10 of the present embodiment, the refrigerant does not flow into the internal condenser 12 at the time of operating in the cooling mode. Thus, like in the second embodiment, at the time of operating in the cooling mode, the coefficient of performance can be further improved. Furthermore, since the first check valve 17a can be eliminated, the cycle structure can be simplified.

### Fourth Embodiment

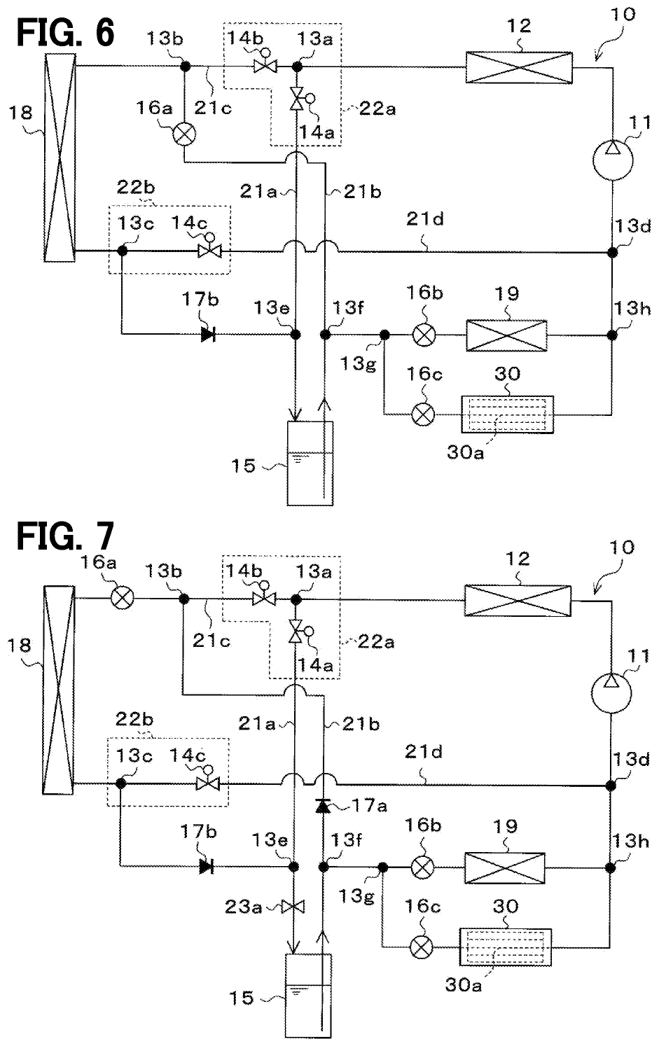

In the present embodiment, there will be described an example where the cycle structure of the refrigeration cycle device 10 is changed relative to the first embodiment as indicated in an overall structure diagram shown in FIG. 6.

In the refrigeration cycle device 10 of the present embodiment, like in the third embodiment, the heating expansion valve 16a is placed in the outlet side passage 21b. Furthermore, the first check valve 17a is eliminated.

The first switching device 22a of the refrigerant circuit switching device of the present embodiment is configured to guide the refrigerant, which is outputted from the internal condenser 12, toward one of the receiver 15 and the second three-way joint 13b. Furthermore, the second three-way joint 13b, which serves as the joint of the present embodiment, is configured to guide one of the refrigerant, which is outputted from the first three-way joint 13a, and the refrigerant, which is outputted from the heating expansion valve 16a, toward the external heat exchanger 18. The rest of the structure and the rest of the operation are the same as those of the first embodiment.

Therefore, the refrigeration cycle device 10 of the present embodiment can be operated in a manner similar to the first embodiment and can achieve the advantages which are similar to those of the first embodiment. Specifically, even when the operation is switched to any one of the operating modes, the liquid-phase refrigerant, which has the high pressure, can be stored in the receiver 15 as the surplus refrigerant. Therefore, the coefficient of performance can be improved.

Furthermore, even when the first switching device 22a and the joint are connected as in the present embodiment, it is possible to achieve the advantages which are similar to those of the first embodiment. Specifically, even when the refrigerant circuit is switched, the flow direction of the refrigerant in the receiver 15 does not change, and it is possible to easily realize the refrigeration cycle device that stores the surplus refrigerant of the cycle in the common receiver 15.

In addition, in the refrigeration cycle device 10 of the present embodiment, like in the third embodiment, since the first check valve 17a can be eliminated, the cycle structure can be simplified.

### Fifth Embodiment

In the present embodiment, there will be described an example where the cycle structure of the refrigeration cycle device 10 is changed relative to the first embodiment as indicated in an overall structure diagram shown in FIG. 7.

In the refrigeration cycle device 10 of the present embodiment, a fixed flow restrictor 23a is placed in the inlet side passage 21a. The fixed flow restrictor 23a is a liquid-storage side depressurizing device that is configured to depressurize the refrigerant which is to be inputted into the receiver 15. The fixed flow restrictor 23a is placed in a region which extends from the outflow opening of the fifth three-way joint 13e to the inlet of the receiver 15 in the inlet side passage 21a. An orifice, a capillary tube or the like may be used as the fixed flow restrictor 23a. The rest of the structure and the rest of the operation are the same as those of the first embodiment.

Therefore, the refrigeration cycle device 10 of the present embodiment can be operated in a manner similar to the first embodiment and can achieve the advantages which are similar to those of the first embodiment. Specifically, even when the operation is switched to any one of the operating modes, the liquid-phase refrigerant, which has the high pressure, can be stored in the receiver 15 as the surplus refrigerant. Therefore, the coefficient of performance can be improved.

Since the refrigeration cycle device 10 of the present embodiment includes the fixed flow restrictor 23a, the coefficient of performance can be further improved.

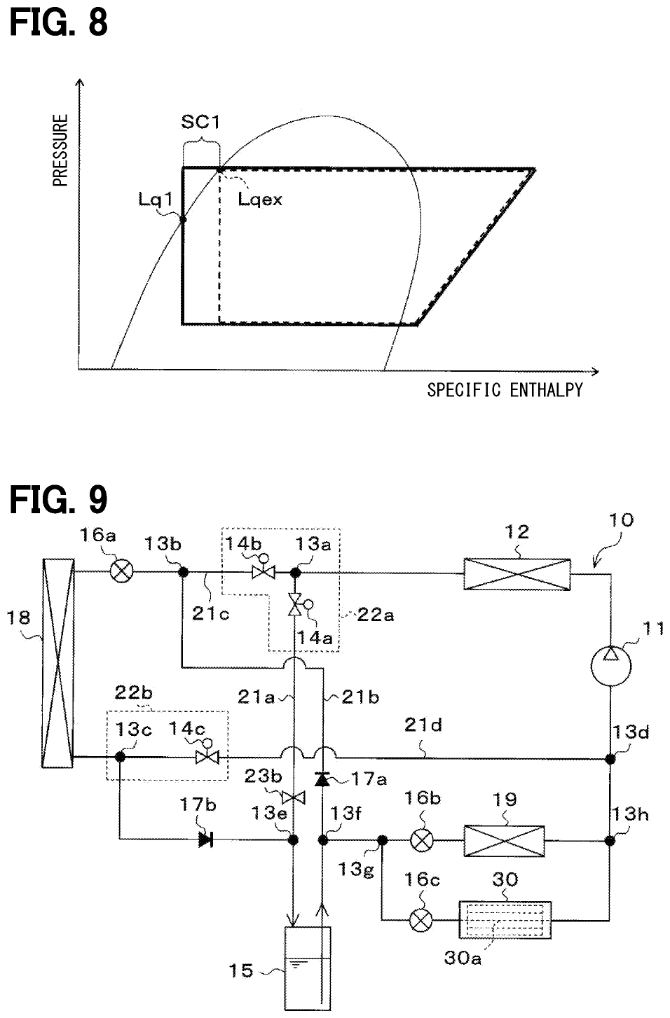

This point will be described with reference to FIG. 8. FIG. 8 is a Mollier diagram showing a state of the refrigerant in the refrigeration cycle device 10 at the time of operating in the outside air heating mode. At the time of operating in the outside air heating mode, the internal condenser 12 functions as the heat exchange device that condenses the refrigerant. Furthermore, the external heat exchanger 18 functions as the heat exchange device that evaporates the refrigerant.

Furthermore, in FIG. 8, a change in the state of the refrigerant in the refrigeration cycle device 10 of the present embodiment, which has the fixed flow restrictor 23a, is indicated by a bold solid line. Also, a change in the state of the refrigerant in a refrigeration cycle device of a comparative example, which does not have the fixed flow restrictor 23a, is indicated by a thin broken line.

Furthermore, in FIG. 8, a state of the refrigerant in the receiver 15 of the refrigeration cycle device 10 of the present embodiment is indicated by a dot Lq1. Also, in FIG. 8, a state of the refrigerant in the receiver 15 of the refrigeration cycle device of the comparative example is indicated by a dot Lqex.

In the refrigeration cycle device 10 of the present embodiment, due to the provision of the fixed flow restrictor 23a, the pressure of the refrigerant in the receiver 15 becomes lower than the pressure of the high-pressure refrigerant in the heat exchange device. Therefore, as indicated in FIG. 8, the pressure of the refrigerant at the dot Lq1 in the refrigeration cycle device 10 of the present embodiment becomes lower than the pressure of the refrigerant at the dot Lqex in the refrigeration cycle device of the comparative example.

Furthermore, the enthalpy of the refrigerant at the dot Lq1 in the refrigeration cycle device 10 of the present embodiment is lower than the enthalpy of the refrigerant at the dot Lqex in the refrigeration cycle device of the comparative example along the slope of the saturated liquid line of the Mollier diagram. Therefore, in the refrigeration cycle device 10 of the present embodiment, the refrigerant at the outlet of the heat exchange device, which condenses the refrigerant, becomes the supercooled liquid-phase refrigerant SC1.

Thus, the refrigeration cycle device 10 of the present embodiment can reduce the enthalpy of the refrigerant, which is to be inputted into the heat exchange device for evaporating the refrigerant, in comparison to the refrigeration cycle device of the comparative example. Therefore, the amount of heat absorption of the refrigerant in the heat exchange device for evaporating the refrigerant can be increased to improve the coefficient of performance. This advantage can be achieved even in the other operating modes.

Here, there is described the example where the fixed flow restrictor 23a is used as the liquid-storage side depressurizing device in the refrigeration cycle device 10 of the present embodiment. However, the liquid-storage side depressurizing device should not be limited to this configuration.

For example, as shown in FIG. 9, a fixed flow restrictor 23b may be placed in a region which extends from the outlet of the first on-off valve 14a to the one of the inflow openings of the fifth three-way joint 13e in the inlet side passage 21a. The fixed flow restrictor 23b serves as a first liquid-storage side depressurizing device that is configured to depressurize the refrigerant, which is to be inputted into the receiver 15, in a state where the refrigerant circuit switching device switches to and thereby establishes the first circuit or the third circuit. In this way, at the time of operating in the cooling mode and the time of operating in the outside air parallel dehumidifying and heating mode, the coefficient of performance can be improved.

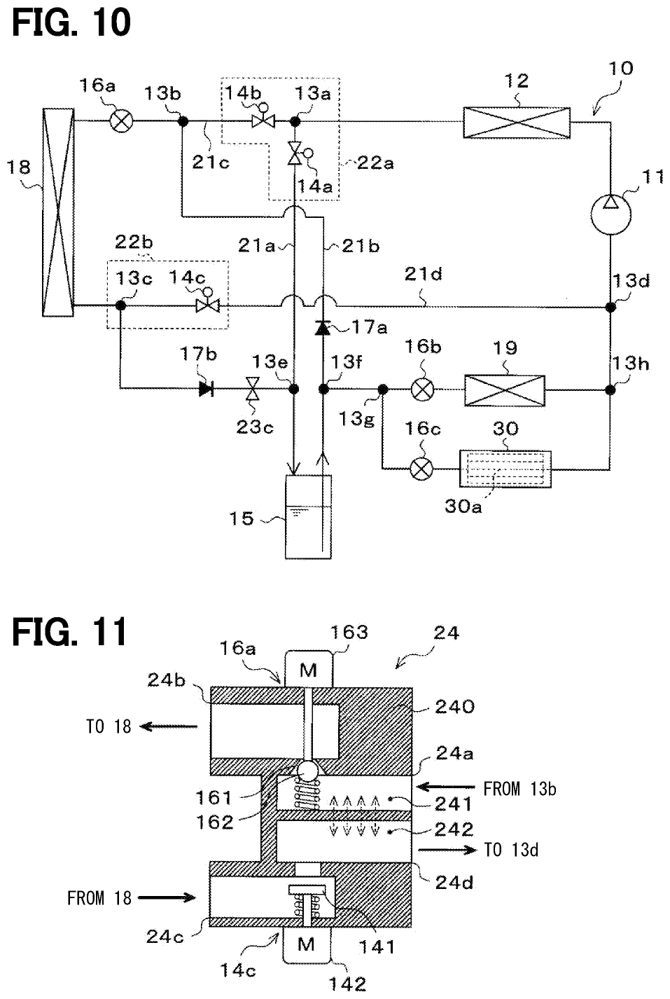

For example, as shown in FIG. 10, a fixed flow restrictor 23c may be placed in a region which extends from the other one of the outflow openings of the third three-way joint 13c to the other one of the inflow openings of the fifth three-way joint 13e. The fixed flow restrictor 23c serves as a second liquid-storage side depressurizing device that is configured to depressurize the refrigerant, which is to be inputted into the receiver 15, in a state where the refrigerant circuit switching device switches to and thereby establishes the second circuit. In this way, at the time of operating in the cooling mode, the coefficient of performance can be improved.

Here, it should be understood that the fixed flow restrictor 23b, which serves as the first liquid-storage side depressurizing device, and the fixed flow restrictor 23c, which serves as the second liquid-storage side depressurizing device, may be both used in the refrigeration cycle device 10. Here, there is described the example where the fixed flow restrictor is used as the liquid-storage side depressurizing device in the refrigeration cycle device 10 of the present embodiment. However, the liquid-storage side depressurizing device should not be limited to the fixed flow restrictor. Alternatively, a variable throttle mechanism may be used as the liquid-storage side depressurizing device.

### Sixth Embodiment

As a modification of the first embodiment, in the refrigeration cycle device 10 of the present embodiment, as shown in FIG. 11, the third on-off valve 14c, which is the portion of the second switching device 22b, and the heating expansion valve 16a are integrated in one-piece as an integrated valve 24. FIG. 11 indicates a flow of the refrigerant in the integrated valve 24 at the time of operating in the outside air heating mode and the time of operating in the outside air parallel dehumidifying and heating mode.

The integrated valve 24 includes a body 240. The body 240 is made of metal having excellent heat transfer properties (aluminum in the present embodiment). The body 240 has a first inlet 24a, a first outlet 24b, a second inlet 24c and a second outlet 24d.

The first inlet 24a is a refrigerant inlet connected to the outflow opening of the second three-way joint 13b. The first outlet 24b is a refrigerant outlet connected to the refrigerant inlet of the external heat exchanger 18. The first inlet 24a and the first outlet 24b are communicated with each other in the body 240.

A flow-restricting passage 161 is formed in a refrigerant passage which extends from the first inlet 24a to the first outlet 24b in the body 240. Furthermore, a valve element 162, which changes a flow-restricting passage cross-sectional area of the flow-restricting passage 161 is installed in the refrigerant passage which extends from the first inlet 24a to the first outlet 24b. The valve element 162 is connected to a stepping motor 163 through a shaft. The stepping motor 163 displaces the valve element 162 to change the flow-restricting passage cross-sectional area.

Specifically, in the integrated valve 24, the heating expansion valve 16a is formed by the flow-restricting passage 161, the valve element 162, the stepping motor 163 and the like.

The second inlet 24c is a refrigerant inlet connected to the refrigerant outlet of the external heat exchanger 18. The second outlet 24d is a refrigerant outlet connected to the one of the inflow openings of the fourth three-way joint 13d. The second inlet 24c and the second outlet 24d are communicated with each other in the body 240.

A valve element 141 is installed in a refrigerant passage, which extends from the second inlet 24c to the second outlet 24d in the body 240, to open and close this refrigerant passage. The valve element 141 is connected to a solenoid actuator 142 through a shaft. The solenoid actuator 142 displaces the valve element 141 to open and close the refrigerant passage which extends from the second inlet 24c to the second outlet 24d.

Specifically, in the integrated valve 24, the third on-off valve 14c is formed by the valve element 141, the solenoid actuator 142 and the like.

Furthermore, the upstream side passage 241 and the downstream side passage 242 are placed adjacent to each other in the body 240. The upstream side passage 241 is located on the upstream side of the flow-restricting passage 161 in the flow direction of the refrigerant in the refrigerant passage which extends from the first inlet 24a to the first outlet 24b. The downstream side passage 242 is located on the downstream side of the valve element 141 in the flow direction of the refrigerant in the refrigerant passage which extends from the second inlet 24c to the second outlet 24d.

In other words, the refrigerant, which flows through the upstream side passage 241, is the refrigerant is to be inputted into the heating expansion valve 16a. Furthermore, the refrigerant, which flows through the downstream side passage 242, is the refrigerant guided from the second switching device toward the suction inlet of the compressor 11 through the fourth three-way joint 13d.

Therefore, in the integrated valve 24, as indicated by thin broken line arrows in FIG. 11, the heat can be transferred between the refrigerant, which flows in the upstream side passage 241, and the refrigerant, which flows in the downstream side passage 242, through the body 240. In other words, in the integrated valve 24, the heat can be exchanged between the refrigerant to be inputted into the heating expansion valve 16a and the refrigerant to be guided from the second switching device toward the suction inlet of the compressor 11. The rest of the structure and the rest of the operation are the same as those of the first embodiment.

Therefore, the refrigeration cycle device 10 of the present embodiment can be operated in a manner similar to the first embodiment and can achieve the advantages which are similar to those of the first embodiment. Specifically, even when the refrigerant circuit is switched to any one of the refrigerant circuits for implementing the corresponding operating mode, the liquid-phase refrigerant, which has the high pressure, can be stored in the receiver 15 as the surplus refrigerant. Therefore, the coefficient of performance can be improved.

Furthermore, since the refrigeration cycle device 10 of the present embodiment includes the integrated valve 24, the coefficient of performance can be further improved at the time of operating in the outside air heating mode and the time of operating in the outside air parallel dehumidifying and heating mode.

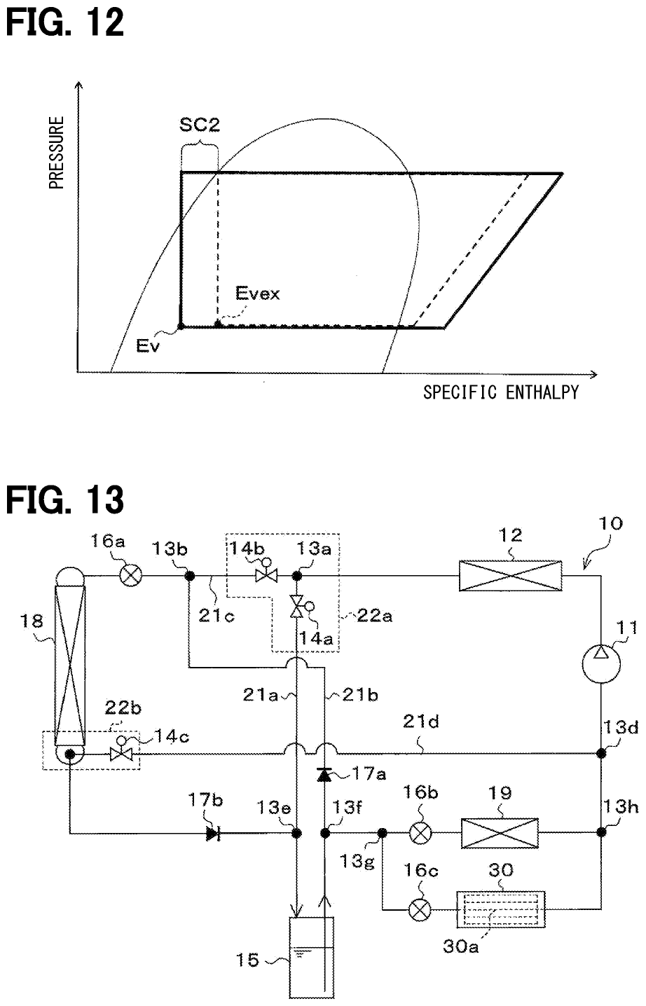

This point will be described with reference to FIG. 12. FIG. 12 is a Mollier diagram showing a state of the refrigerant in the refrigeration cycle device 10 at the time of operating in the outside air heating mode. Furthermore, in FIG. 12, a change in the state of the refrigerant in the refrigeration cycle device 10 of the present embodiment, which has the integrated valve 24, is indicated by a bold solid line. Also, a change in the state of the refrigerant in a refrigeration cycle device of a comparative example, which does not have the integrated valve 24, is indicated by a thin broken line.

Furthermore, in FIG. 12, a state of the refrigerant at the inlet of the external heat exchanger 18 of the refrigeration cycle device 10 of the present embodiment is indicated by a dot Ev. Furthermore, in FIG. 12, a state of the refrigerant at the inlet of the external heat exchanger of the refrigeration cycle device of the comparative example is indicated by a dot Evex.

In the integrated valve 24, the heat can be exchanged between the refrigerant, which flows in the upstream side passage 241, and the refrigerant, which flows in the downstream side passage 242. Therefore, as indicated in FIG. 12, the enthalpy of the refrigerant at the dot Ev in the refrigeration cycle device 10 of the present embodiment becomes lower than the enthalpy of the refrigerant at the dot Evex in the refrigeration cycle device of the comparative example. Therefore, in the refrigeration cycle device 10 of the present embodiment, the refrigerant at the outlet of the heat exchange device, which condenses the refrigerant, becomes the supercooled liquid-phase refrigerant SC2.

Thus, the refrigeration cycle device 10 of the present embodiment can reduce the enthalpy of the refrigerant, which is to be inputted into the heat exchange device for evaporating the refrigerant, in comparison to the refrigeration cycle device of the comparative example. Therefore, the amount of heat absorption of the refrigerant in the heat exchange device for evaporating the refrigerant can be increased to improve the coefficient of performance. The above advantage can be achieved even in the outside air parallel dehumidifying and heating mode.

Here, at the time of operating in the cooling mode, the third on-off valve 14c is closed. Specifically, the valve element 141 closes the refrigerant passage which extends from the second inlet 24c to the second outlet 24d. Therefore, the refrigerant does not flow through the downstream side passage 242. Specifically, in the cooling mode, there is no heat exchange between the refrigerant, which flows in the upstream side passage 241, and the refrigerant, which flows in the downstream side passage 242.

### Seventh Embodiment

As a modification of the first embodiment, in the refrigeration cycle device 10 of the present embodiment, as shown in FIG. 13, a structure, which corresponds to the third three-way joint 13c of the second switching device 22b, is formed integrally at the external heat exchanger 18.

Specifically, in the present embodiment, a tank-and-tube type heat exchanger, which includes a plurality of tubes and a pair of tanks respectively connected to two opposite ends of the respective tubes, is used as the external heat exchanger 18. Furthermore, one of the tanks forms a collecting space, into which the refrigerant outputted from the tubes after the heat exchange with the outside air is collected, and two refrigerant outlets are formed at this one of the tanks. Therefore, the flow of the refrigerant is branched through the two refrigerant outlets like in the third three-way joint 13c.

The rest of the structure and the rest of the operation are the same as those of the first embodiment. Therefore, the refrigeration cycle device 10 of the present embodiment can achieve the advantages which are similar to those of the first embodiment. Specifically, even when the operation is switched to any one of the operating modes, the liquid-phase refrigerant, which has the high pressure, can be stored in the receiver 15 as the surplus refrigerant. Therefore, the coefficient of performance can be improved.

Furthermore, the third on-off valve 14c may be received in the tank of the external heat exchanger 18 of the present embodiment to integrate the external heat exchanger 18 and the second switching device 22b together. Furthermore, the integrated valve described in the sixth embodiment may be received in the tank of the external heat exchanger 18 of the present embodiment to integrate the external heat exchanger 18 and the integrated valve 24 together.

### Eighth Embodiment

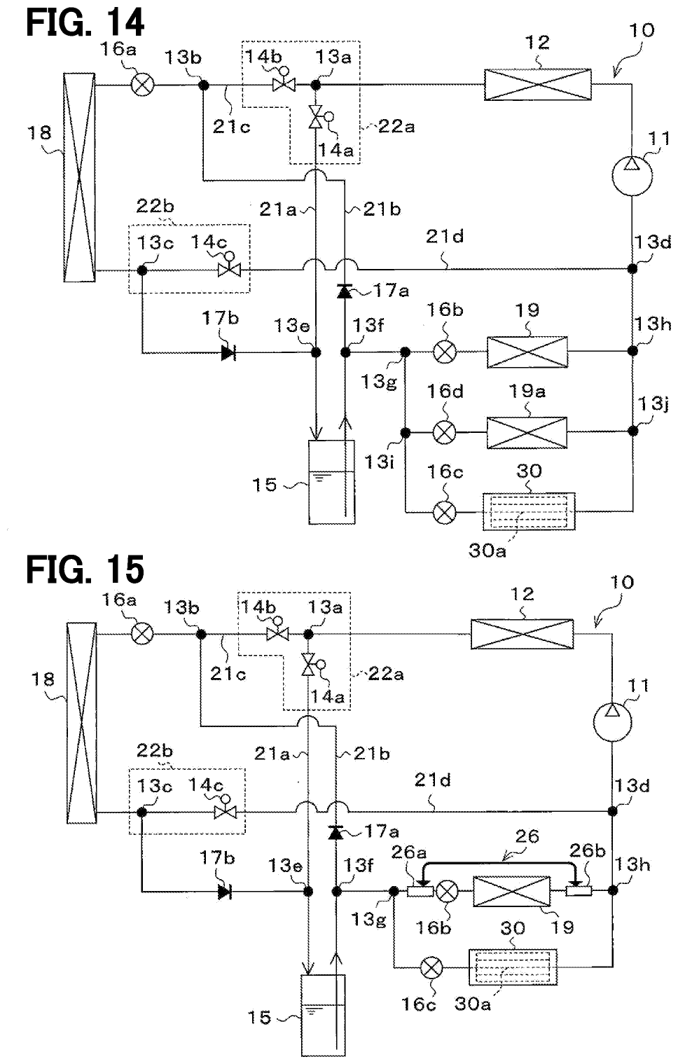

In the present embodiment, there will be described an example where the cycle structure of the refrigeration cycle device 10 is changed relative to the first embodiment as indicated in an overall structure diagram shown in FIG. 14. In the refrigeration cycle device 10 of the present embodiment, a ninth three-way joint 13i, a tenth three-way joint 13j, a rear cooling expansion valve 16d and a rear internal evaporator 19a are added.

A basic structure of each of the ninth three-way joint 13i and the tenth three-way joint 13j is the same as that of the first three-way joint 13a. The inflow opening of the ninth three-way joint 13i is connected to the other one of the outflow openings of the seventh three-way joint 13g. One of the outflow openings of the ninth three-way joint 13i is connected to the inlet of the rear cooling expansion valve 16d. The other one of the outflow openings of the ninth three-way joint 13i is connected to the inlet of the cool down expansion valve 16c.

The rear cooling expansion valve 16d is a second depressurizing device that is configured to depressurize the refrigerant outputted from the one of the outflow openings of the ninth three-way joint 13i and adjust a flow rate of the refrigerant flowing toward the downstream side thereof. A basic structure of the rear cooling expansion valve 16d is the same as that of the heating expansion valve 16a.

An outlet of the rear cooling expansion valve 16d is connected to a refrigerant inlet of the rear internal evaporator 19a. The rear internal evaporator 19a is an evaporating device that is configured to evaporate the low-pressure refrigerant, which is depressurized by the rear cooling expansion valve 16d, through heat exchange between this low-pressure refrigerant and the blown air to be blown toward a rear seat side. The rear internal evaporator 19a is a rear-seat side blown air cooling device that is configured to cool the blown air, which is to be blown toward the rear seat side. Therefore, in the present embodiment, the internal evaporator 19 is used as a front-seat side blown air cooling device.

A refrigerant outlet of the rear internal evaporator 19a is connected to one of the inflow openings of the tenth three-way joint 13j. The other one of the inflow openings of the tenth three-way joint 13j is connected to the outlet of the refrigerant passage 30a of the battery 30. The outflow opening of the tenth three-way joint 13j is connected to the other one of the inflow openings of the eighth three-way joint 13h.

Specifically, in the refrigeration cycle device 10 of the present embodiment, the internal evaporator 19, the rear internal evaporator 19a and the refrigerant passage 30a of the battery 30 are connected in parallel relative to the flow of the refrigerant. The rest of the structure of the refrigeration cycle device 10 is the same as that of the first embodiment.

Next, the operation of the refrigeration cycle device 10 of the present embodiment having the above-described structure will be described. A basic operation of the refrigeration cycle device 10 of the present embodiment is the same as that of the first embodiment. Furthermore, in the refrigeration cycle device 10 of the present embodiment, the rear cooling expansion valve 16d is placed in a throttled state in (b) the cooling mode, (f) the cooling battery mode and the like, so that it is possible to cool not only the blown air to be blown toward the front seat side but also the blown air to be blown toward the rear seat side.

At the time of operating in these operating modes, when the blown air to be blown toward the rear seat side is cooled, the control device 50 controls the throttle opening degree of the rear cooling expansion valve 16d such that a superheat degree SH4 of the refrigerant at the outlet of the rear internal evaporator 19a approaches the target superheat degree KSH. Furthermore, even at the time of operating in these operating modes, if the occupant(s) is present only on the rear seat(s) in, for example, a state where the vehicle is stopped, the control device 50 places the cooling expansion valve 16b in the fully closed state to cool only the blown air to be blown toward the rear seat side.

The rest of the operation is the same as that of the first embodiment. Therefore, the refrigeration cycle device 10 of the present embodiment can achieve the advantages which are similar to those of the first embodiment. Specifically, even when the operation is switched to any one of the operating modes, the liquid-phase refrigerant, which has the high pressure, can be stored in the receiver 15 as the surplus refrigerant. Therefore, the coefficient of performance can be improved.

In the present embodiment, there is described the example where the electric variable throttle mechanism, which is operated by supplying the electric power to the electric variable throttle mechanism, is used as each of the cooling expansion valve 16b, the rear cooling expansion valve 16d and the cool down expansion valve 16c. However, the cooling expansion valve 16b, the rear cooling expansion valve 16d and the cool down expansion valve 16c should not be limited to the electric variable throttle mechanism.

For example, the cooling expansion valve 16b may be a thermal expansion valve that changes a throttle opening degree thereof such that the superheat degree SH2 of the refrigerant at the outlet of the internal evaporator 19 approaches the target superheat degree KSH. Furthermore, in addition to the thermal expansion valve, in order to limit the flow of the refrigerant into the internal evaporator 19, there may be provided an on-off valve that is configured to open and close the refrigerant flow passage.

The thermal expansion valve is a mechanical variable throttle mechanism that includes a temperature-sensitive portion and a valve element. The temperature-sensitive portion includes a deformable member (specifically, a diaphragm) that is configured to change its shape according to the temperature and the pressure of the refrigerant at the outlet of the internal evaporator 19. The valve element is configured to move in response to a change in the shape of the deformable member to change a throttle opening degree of the mechanical variable throttle mechanism.

Similarly, the rear cooling expansion valve 16d may be a thermal expansion valve that changes a throttle opening degree thereof such that the superheat degree SH4 of the refrigerant at the outlet of the rear internal evaporator 19a approaches the target superheat degree KSH. In addition to this, in order to limit the flow of the refrigerant into the rear internal evaporator 19a, there may be provided an on-off valve that is configured to open and close the refrigerant flow passage.

Similarly, the cool down expansion valve 16c may be a thermal expansion valve that changes a throttle opening degree thereof such that the superheat degree SH3 of the refrigerant at the outlet of the refrigerant passage 30a of the battery 30 approaches the target superheat degree KSH. In addition to this, in order to limit the flow of the refrigerant into the refrigerant passage 30a, there may be provided an on-off valve that is configured to open and close the refrigerant flow passage.

### Ninth Embodiment

As a modification of the first embodiment, in the refrigeration cycle device 10 of the present embodiment, as shown in FIG. 15, an internal heat exchanger 26 is added. The internal heat exchanger 26 exchanges the heat between the high-pressure refrigerant, which is outputted from the receiver 15, and the low-pressure refrigerant, which is to be suctioned into the compressor 11. Therefore, in the internal heat exchanger 26, the high-pressure refrigerant is cooled to reduce the enthalpy thereof, and the low-pressure refrigerant is heated to increase the enthalpy thereof.

The internal heat exchanger 26 includes a high-pressure refrigerant passage 26a and a low-pressure refrigerant passage 26b. The high-pressure refrigerant passage 26a conducts the high-pressure refrigerant outputted from the receiver 15. The low-pressure refrigerant passage 26b conducts the low-pressure refrigerant to be suctioned into the compressor 11. The high-pressure refrigerant passage 26a is placed in the refrigerant passage which extends from the one of the outflow openings of the seventh three-way joint 13g to the inlet of the cooling expansion valve 16b. The low-pressure refrigerant passage 26b is placed in the refrigerant passage which extends from the refrigerant outlet of the internal evaporator 19 to the one of the inflow openings of the eighth three-way joint 13h.

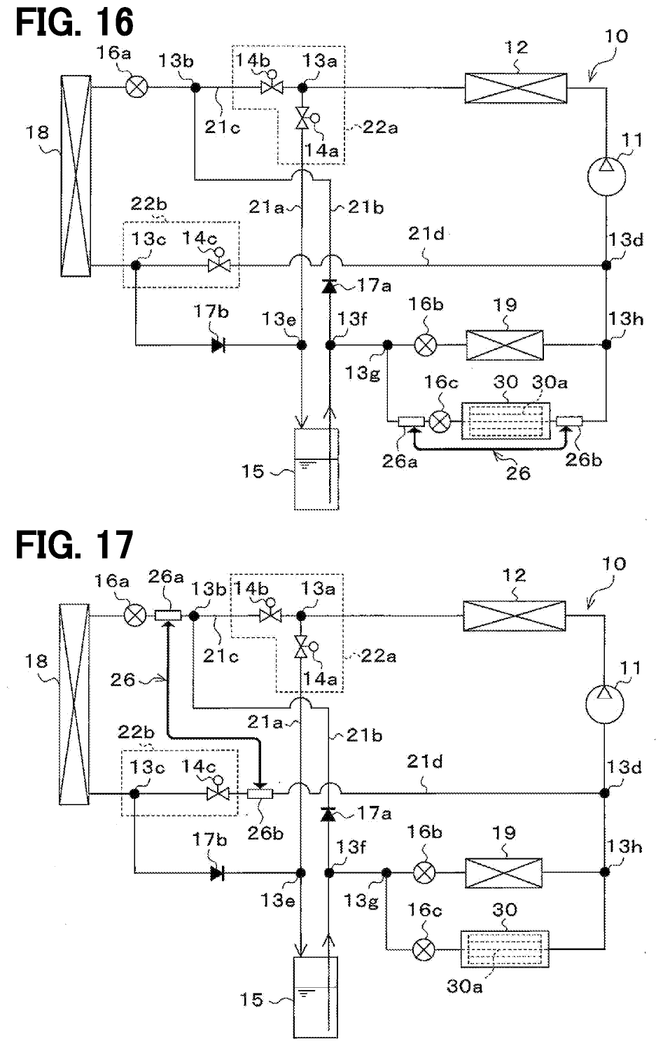

Here, in FIG. 15, the internal heat exchanger 26 is schematically shown for the sake of clarity. Specifically, FIG. 15 schematically shows the arrangement of the high-pressure refrigerant passage 26a and the low-pressure refrigerant passage 26b in the refrigeration cycle device 10. The heat exchange between the high-pressure refrigerant flowing in the high-pressure refrigerant passage 26a and the low-pressure refrigerant flowing in the low-pressure refrigerant passage 26b is indicated by a bold line arrow. This also applies to FIGS. 16 and 17, which will be described later.

The rest of the structure and the rest of the operation are the same as those of the first embodiment. Therefore, the refrigeration cycle device 10 of the present embodiment can achieve the advantages which are similar to those of the first embodiment. Specifically, even when the operation is switched to any one of the operating modes, the liquid-phase refrigerant, which has the high pressure, can be stored in the receiver 15 as the surplus refrigerant. Therefore, the coefficient of performance can be improved.

Furthermore, according to the refrigeration cycle device 10 of the present embodiment, the coefficient of performance can be further improved at the time of operating in (b) the cooling mode, (c) the outside air parallel dehumidifying and heating mode, (f) the cooling battery mode and (g) the outside air waste heat parallel dehumidifying and heating mode. In other words, the coefficient of performance can be further improved at the time of operating in the operating mode in which the refrigerant depressurized by the cooling expansion valve 16b is evaporated at the internal evaporator 19.

More specifically, in these operating modes, the internal heat exchanger 26 can supercool the high-pressure refrigerant outputted from the receiver 15. Accordingly, the enthalpy of the refrigerant, which is to be inputted into the internal evaporator 19, can be reduced, and thereby the amount of heat absorption of the refrigerant at the internal evaporator 19 can be increased. Therefore, the coefficient of performance can be improved in these operating modes.

In the present embodiment, there is described the example where the internal heat exchanger 26 is arranged to improve the coefficient of performance at the time of operating in the operating mode in which the refrigerant depressurized by the cooling expansion valve 16b is evaporated at the internal evaporator 19. However, the arrangement of the internal heat exchanger 26 should not be limited to this.

For example, the arrangement of the internal heat exchanger 26 may be changed as in a modification shown in FIG. 16. Specifically, the high-pressure refrigerant passage 26a may be placed in the refrigerant passage which extends from the other one of the outflow openings of the seventh three-way joint 13g to the inlet of the refrigerant passage 30a of the battery 30. Furthermore, the low-pressure refrigerant passage 26b may be placed in the refrigerant passage which extends from the outlet of the refrigerant passage 30a of the battery 30 to the other one of the inflow openings of the eighth three-way joint 13h.

According to this, in addition to the advantages, which are similar to those of the first embodiment, the coefficient of performance can be further improved at least at the time of operating in (d) the battery-only mode, (e) the outside air waste heat heating mode, (f) the cooling battery mode and (g) the outside air waste heat parallel dehumidifying and heating mode. In other words, the coefficient of performance can be further improved at the time of operating in the operating mode in which the refrigerant depressurized by the cool down expansion valve 16c is evaporated at the refrigerant passage 30a of the battery 30.

Furthermore, the arrangement of the internal heat exchanger 26 may be changed as in a modification shown in FIG. 17. Specifically, the high-pressure refrigerant passage 26a may be arranged in the refrigerant passage which extends from the outflow opening of the second three-way joint 13b to the inlet of the heating expansion valve 16a. Furthermore, the low-pressure refrigerant passage 26b may be arranged in the refrigerant passage which extends from the outlet of the third on-off valve 14c to the one of the inflow openings of the fourth three-way joint 13d in the suction side passage 21d.

In this way, in addition to the advantages, which are similar to those of the first embodiment, the coefficient of performance can be further improved at least at the time of operating in (a) the outside air heating mode, (c) the outside air parallel dehumidifying and heating mode, (e) the outside air waste heat heating mode and (g) the outside air waste heat parallel dehumidifying and heating mode. In other words, the coefficient of performance can be further improved at the time of operating in the operating mode in which the refrigerant depressurized by the heating expansion valve 16a is evaporated at the external heat exchanger 18.

### Tenth Embodiment

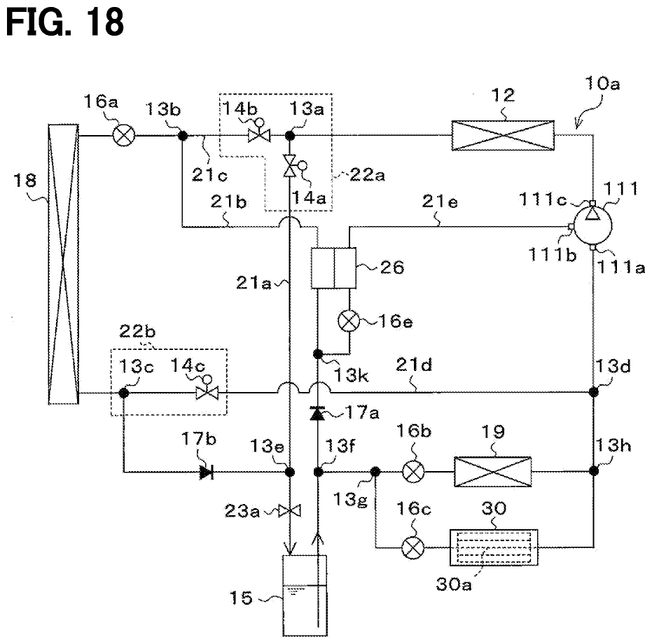

In the present embodiment, there will be described a refrigeration cycle device 10a in which the cycle structure is changed relative to the refrigeration cycle device 10 of the fifth embodiment as indicated in an overall structure diagram shown in FIG. 18. The refrigeration cycle device 10a forms a gas injection cycle when the refrigeration cycle device 10a switches to and establish the refrigerant circuit for implementing a predetermined operating mode.

Therefore, in the refrigeration cycle device 10a, a two-stage compressor 111 is used as the compressor. The compressor 111 is a two-stage electric compressor where a low-stage side compression mechanism and a high-stage side compression mechanism, each of which have a fixed discharge capacity, are rotated by a common electric motor. A rotational speed (i.e., a refrigerant discharge pressure) of the compressor 111 is controlled by a control signal outputted from the control device 50.

Furthermore, the compressor 111 includes a housing that receives the low-stage side compression mechanism, the high-stage side compression mechanism and the electric motor. The housing forms an outer shell of the compressor 111. The housing has a suction inlet 111a, an intermediate-pressure suction inlet 111b and a discharge outlet 111c.

The suction inlet 111a is an opening hole through which the low-pressure refrigerant is suctioned from the outside of the housing into the low-stage side compression mechanism. The intermediate-pressure suction inlet 111b is an opening hole through which the intermediate-pressure refrigerant flows from the outside to the inside of the housing and merges to the refrigerant that is under a compression process for compressing from the low pressure to the high pressure. The intermediate-pressure suction inlet 111b is connected to a discharge outlet of the low-stage side compression mechanism and a suction inlet of the high-stage side compression mechanism at the inside of the housing. The discharge outlet 111c is an opening hole through which the high-pressure refrigerant discharged from the high-stage side compression mechanism is discharged to the outside of the housing. The discharge outlet 111c is connected to the refrigerant inlet of the internal condenser 12.

Furthermore, the refrigeration cycle device 10a includes an eleventh three-way joint 13k, an intermediate-pressure expansion valve 16e and an internal heat exchanger 26.

The eleventh three-way joint 13k is placed in the refrigerant passage which extends from the outlet of the first check valve 17a to the other one of the inflow openings of the second three-way joint 13b in the outlet side passage 21b. One of the outflow openings of the eleventh three-way joint 13k is connected to an injection passage 21e that guides the flow of the refrigerant branched at the eleventh three-way joint 13k to the intermediate-pressure suction inlet 111b of the compressor 111.

The intermediate-pressure expansion valve 16e is placed in the injection passage 21e. The intermediate-pressure expansion valve 16e is a third depressurizing device that is configured to depressurize a portion of the refrigerant outputted from the receiver 15 at the time of switching to and establishing a predetermined operating mode (the outside air heating mode in the present embodiment). A basic structure of the intermediate-pressure expansion valve 16e is the same as that of the heating expansion valve 16a.

The internal heat exchanger 26 exchanges the heat between the high-pressure refrigerant, which is outputted from the other one of the outflow openings of the eleventh three-way joint 13k, and the intermediate-pressure refrigerant, which is depressurized by the intermediate-pressure expansion valve 16e. At the internal heat exchanger 26, the high-pressure refrigerant is cooled to reduce the enthalpy thereof, and the intermediate-pressure refrigerant is heated to increase the enthalpy thereof.

The high-pressure refrigerant passage of the internal heat exchanger 26 of the present embodiment is placed in the refrigerant passage which extends from the other one of the outflow openings of the eleventh three-way joint 13k to the other one of the inflow openings of the second three-way joint 13b in the outlet side passage 21b. The intermediate-pressure refrigerant passage of the internal heat exchanger 26 is placed in the refrigerant passage which extends from the outlet of the intermediate-pressure expansion valve 16e to the intermediate-pressure suction inlet 111b of the compressor 111 in the injection passage 21e.

Furthermore, an intermediate-temperature sensor and an intermediate-pressure sensor (both not shown) are connected to the input side of the control device 50 of the refrigeration cycle device 10a.

The intermediate-temperature sensor is an intermediate-pressure refrigerant temperature sensing device that is configured to sense the temperature of the refrigerant which is outputted from the intermediate-pressure refrigerant passage of the internal heat exchanger 26 and is to be inputted into the intermediate-pressure suction inlet 111b of the compressor 111. The intermediate-pressure sensor is an intermediate-pressure refrigerant pressure sensing device that is configured to sense the pressure of the refrigerant which is outputted from the intermediate-pressure refrigerant passage of the internal heat exchanger 26 and is to be inputted into the intermediate-pressure suction inlet 111b of the compressor 111.

The rest of the structure of the refrigeration cycle device 10a is the same as that of the refrigeration cycle device 10 discussed in the fifth embodiment.

Next, the operation of the refrigeration cycle device 10a having the above-described structure will be described. Even in the refrigeration cycle device 10a of the present embodiment, the operating mode is switched like in the first embodiment. Hereinafter, the operation of the respective operating modes will be described.

### (a) Outside Air Heating Mode

In the outside air heating mode, the control device 50 opens the first on-off valve 14a and closes the second on-off valve 14b and opens the third on-off valve 14c. Furthermore, the control device 50 places the heating expansion valve 16a in the throttled state and places the cooling expansion valve 16b in the fully closed state and places the intermediate-pressure expansion valve 16e in the throttled state.

In this way, the refrigeration cycle device 10a in the outside air heating mode switches to and thereby establishes the first circuit in which the refrigerant outputted from the discharge outlet 111c of the compressor 111 is circulated through the internal condenser 12, the fixed flow restrictor 23a, the receiver 15, the high-pressure refrigerant passage of the internal heat exchanger 26, the heating expansion valve 16a, the external heat exchanger 18 and the suction inlet 111a of the compressor 111 in this order. Furthermore, a portion of the refrigerant, which is outputted from the receiver 15, flows through the intermediate-pressure expansion valve 16e, the intermediate-pressure refrigerant passage of the internal heat exchanger 26 and the intermediate-pressure suction inlet 111b of the compressor 111 in this order.

With this circuit structure, the control device 50 controls the operations of the various control-subject devices. For example, the control device 50 controls the throttle opening degree of the intermediate-pressure expansion valve 16e such that a superheat degree SH5 of the refrigerant to be suctioned into the intermediate-pressure suction inlet 111b of the compressor 111 approaches a predetermined target superheat degree KSH5 for the intermediate-pressure refrigerant. The superheat degree SH5 is computed based on the measurement signal of the intermediate-temperature sensor and the measurement signal of the intermediate-pressure sensor. The other control operations of the control device 50 are the same as those of the outside air heating mode of the fifth embodiment.

In the refrigeration cycle device 10a, when the compressor 111 is operated, the high-pressure refrigerant, which is outputted from the discharge outlet 111c of the compressor 111, flows into the internal condenser 12. The refrigerant, which flows into the internal condenser 12, is condensed by releasing the heat to the blown air, which has passed through the internal evaporator 19. In this way, the blown air is heated.

Like in the outside air heating mode of the fifth embodiment, the refrigerant, which is outputted from the internal condenser 12, is depressurized by the fixed flow restrictor 23a and flows into the receiver 15. The refrigerant, which flows into the receiver 15, is separated into the gas-phase refrigerant and the liquid-phase refrigerant in the receiver 15. A portion of the flow of the liquid-phase refrigerant, which is separated in the receiver 15, is branched at the eleventh three-way joint 13k placed in the outlet side passage 21b.

One of the branched flows of the refrigerant, which are branched at the eleventh three-way joint 13k, flows into the intermediate-pressure expansion valve 16e placed in the injection passage 21e. The refrigerant, which flows into the intermediate-pressure expansion valve 16e, is depressurized until it becomes the intermediate-pressure refrigerant. The intermediate-pressure refrigerant, which is depressurized by the intermediate-pressure expansion valve 16e, flows into the intermediate-pressure refrigerant passage in the internal heat exchanger 26.

The other one of the branched flows of the refrigerant, which are branched at the eleventh three-way joint 13k, flows into the high-pressure refrigerant passage of the internal heat exchanger 26. Therefore, at the internal heat exchanger 26, the enthalpy of the high-pressure refrigerant, which flows in the high-pressure refrigerant passage, is decreased, and the enthalpy of the intermediate-pressure refrigerant, which flows in the intermediate-pressure refrigerant passage, is increased.

The refrigerant, which is outputted from the intermediate-pressure refrigerant passage of the internal heat exchanger 26, is suctioned into the intermediate-pressure suction inlet 111b of the compressor 111. The refrigerant, which is outputted from the high-pressure refrigerant passage of the internal heat exchanger 26, flows into the heating expansion valve 16a through the outlet side passage 21b and the second three-way joint 13b. Like in the outside air heating mode of the fifth embodiment, the refrigerant, which flows into the heating expansion valve 16a, is depressurized until it becomes the low-pressure refrigerant.

The low-pressure refrigerant, which is depressurized by the heating expansion valve 16a, flows into the external heat exchanger 18. The refrigerant, which flows into the external heat exchanger 18, is evaporated by absorbing the heat from the outside air. The refrigerant, which is outputted from the external heat exchanger 18, is suctioned into the suction inlet 111a of the compressor 111 through the third three-way joint 13c, the suction side passage 21d and the fourth three-way joint 13d and is compressed once again.

Specifically, in the refrigeration cycle device 10a in the outside air heating mode, there is formed the gas injection cycle of the internal heat exchange type, in which the internal condenser 12 functions as the condenser, and the external heat exchanger 18 functions as the evaporator. Therefore, in the outside air heating mode, the vehicle cabin can be heated by discharging the blown air, which is heated by the internal condenser 12, into the vehicle cabin.

### (b) Cooling Mode

In the cooling mode, the control device 50 closes the first on-off valve 14a and opens the second on-off valve 14b and closes the third on-off valve 14c. Furthermore, the control device 50 places the heating expansion valve 16a in the fully opened state and places the cooling expansion valve 16b in the throttled state and places the intermediate-pressure expansion valve 16e in the fully closed state.

Here, when the intermediate-pressure expansion valve 16e is placed in the fully closed state, the refrigerant does not flow into the injection passage 21e. Therefore, in the compressor 111, the intermediate-pressure refrigerant cannot be suctioned from the intermediate-pressure suction inlet 111b. Thus, the compressor 111 functions as a single-stage compressor. Furthermore, the intermediate-pressure refrigerant does not flow in the intermediate-pressure refrigerant passage of the internal heat exchanger 26. Therefore, the heat exchange between the high-pressure refrigerant and the intermediate-pressure refrigerant does not occur in the internal heat exchanger 26.

Thus, like in the cooling mode of the fifth embodiment, the refrigeration cycle device 10a in the cooling mode switches to and thereby establishes the second circuit in which the refrigerant is circulated in the same way as in the cooling mode of the fifth embodiment. Furthermore, in the cooling mode, the control device 50 controls the operations of the various control-subject devices like in the fifth embodiment. Therefore, in the cooling mode, like in the fifth embodiment, the vehicle cabin can be cooled by discharging the blown air, which is cooled by the internal evaporator 19, into the vehicle cabin.

Furthermore, in the refrigeration cycle device 10a of the present embodiment, the control device 50 places the intermediate-pressure expansion valve 16e in the fully closed state in the other operating modes, so that the refrigeration cycle device 10a operates in the same way as the refrigeration cycle device 10 of the fifth embodiment. Therefore, the refrigeration cycle device 10a of the present embodiment can achieve the advantages which are similar to those of the fifth embodiment.

Furthermore, in the refrigeration cycle device 10a of the present embodiment, it is possible to form the gas injection cycle at the time of operating in (a) the outside air heating mode. In the gas injection cycle, the compression efficiency of the compressor 111 can be improved by merging the intermediate-pressure refrigerant to the refrigerant in the step-up process in the compressor 111. Thus, at the time of operating in (a) the outside air heating mode, the coefficient of performance can be further improved.

### Eleventh Embodiment

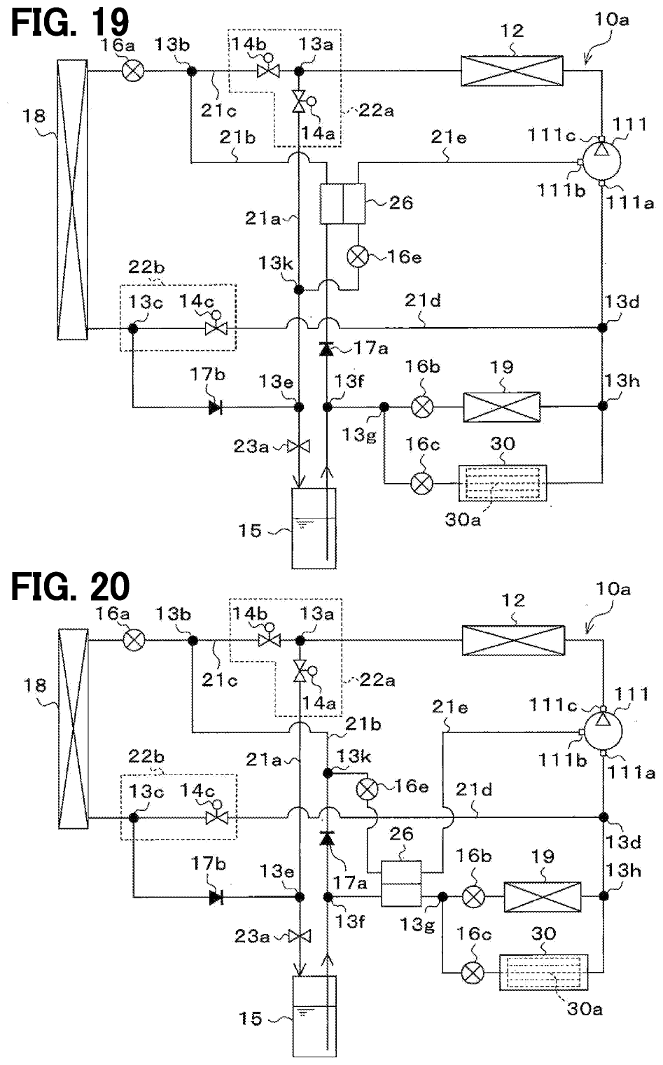

In the present embodiment, there will be described the refrigeration cycle device 10a in which the location of the eleventh three-way joint 13k is changed relative to the tenth embodiment as indicated in an overall structure diagram shown in FIG. 19.

The eleventh three-way joint 13k of the present embodiment is placed in the refrigerant passage which extends from the outlet of the first on-off valve 14a to the one of the inflow openings of the fifth three-way joint 13e in the inlet side passage 21a. The intermediate-pressure expansion valve 16e of the present embodiment is the third depressurizing device that is configured to depressurize a portion of the refrigerant, which is present on the upstream side of the receiver 15, at the time of switching to and establishing a predetermined operating mode (the outside air heating mode in the present embodiment). The rest of the structure and the rest of the operation of the refrigeration cycle device 10a are the same as those of the tenth embodiment.

Therefore, the refrigeration cycle device 10a of the present embodiment in the outside air heating mode switches to and thereby establishes the first circuit in which the refrigerant outputted from the discharge outlet 111c of the compressor 111 is circulated through the internal condenser 12, the fixed flow restrictor 23a, the receiver 15, the high-pressure refrigerant passage of the internal heat exchanger 26, the heating expansion valve 16a, the external heat exchanger 18 and the suction inlet 111a of the compressor 111 in this order. Furthermore, a portion of the refrigerant, which is present on the upstream side of the receiver 15, flows through the intermediate-pressure expansion valve 16e, the intermediate-pressure refrigerant passage of the internal heat exchanger 26 and the intermediate-pressure suction inlet 111b of the compressor 111 in this order.

Specifically, in the refrigeration cycle device 10a of the present embodiment in the outside air heating mode, like in the tenth embodiment, there is formed the gas injection cycle of the internal heat exchange type, in which the internal condenser 12 functions as the condenser, and the external heat exchanger 18 functions as the evaporator. Therefore, the refrigeration cycle device 10a of the present embodiment can achieve the advantages which are similar to those of the tenth embodiment.

### Twelfth Embodiment

In the present embodiment, there will be described the refrigeration cycle device 10a in which the location of the internal heat exchanger 26 is changed relative to the tenth embodiment as indicated in an overall structure diagram shown in FIG. 20. The high-pressure refrigerant passage of the internal heat exchanger 26 of the present embodiment is placed in the refrigerant passage which extends from the other one of the outflow openings of the sixth three-way joint 13f to the inflow opening of the seventh three-way joint 13g. The rest of the structure is the same as that of the tenth embodiment.

Next, the operation of the refrigeration cycle device 10a having the above-described structure will be described. Even in the refrigeration cycle device 10a of the present embodiment, the operating mode is switched like in the first embodiment. Hereinafter, the operation of the respective operating modes will be described.

### (a) Outside Air Heating Mode

In the outside air heating mode, the control device 50 opens the first on-off valve 14a and closes the second on-off valve 14b and opens the third on-off valve 14c. Furthermore, the control device 50 places the heating expansion valve 16a in the throttled state and places the cooling expansion valve 16b in the fully closed state and places the intermediate-pressure expansion valve 16e in the fully closed state.

Thus, like in the outside air heating mode of the fifth embodiment, the refrigeration cycle device 10a in the outside air heating mode switches to and thereby establishes the first circuit in which the refrigerant is circulated in the same way as in the outside air heating mode of the fifth embodiment. Furthermore, in the outside air heating mode, the control device 50 controls the operations of the various control-subject devices like in the fifth embodiment. Therefore, like in the fifth embodiment, in the outside air heating mode, the vehicle cabin can be heated by discharging the blown air, which is heated by the internal condenser 12, into the vehicle cabin.

### (b) Cooling Mode

In the cooling mode, the control device 50 closes the first on-off valve 14a and opens the second on-off valve 14b and closes the third on-off valve 14c. Furthermore, the control device 50 places the heating expansion valve 16a in the fully opened state and places the cooling expansion valve 16b in the throttled state and places the intermediate-pressure expansion valve 16e in the throttled state.

In this way, the refrigeration cycle device 10a in the cooling mode switches to and thereby establishes the second circuit in which the refrigerant outputted from the discharge outlet 111c of the compressor 111 is circulated through (the internal condenser 12, the heating expansion valve 16a), the external heat exchanger 18, the fixed flow restrictor 23a, the receiver 15, the high-pressure refrigerant passage of the internal heat exchanger 26, the cooling expansion valve 16b, the internal evaporator 19 and the suction inlet 111a of the compressor 111 in this order. Furthermore, a portion of the refrigerant, which is outputted from the receiver 15, flows through the intermediate-pressure expansion valve 16e, the intermediate-pressure refrigerant passage of the internal heat exchanger 26 and the intermediate-pressure suction inlet 111b of the compressor 111 in this order.

With this circuit structure, the control device 50 controls the operations of the various control-subject devices. For example, the control device 50 controls the throttle opening degree of the intermediate-pressure expansion valve 16e such that the superheat degree SH5 of the refrigerant to be suctioned into the intermediate-pressure suction inlet 111b of the compressor 111 approaches the target superheat degree KSH5. The other control operations of the control device 50 are the same as those of the cooling mode of the fifth embodiment.

Specifically, in the refrigeration cycle device 10a in the cooling mode, there is formed the gas injection cycle of the internal heat exchange type, in which the external heat exchanger 18 functions as the condenser, and the internal evaporator 19 functions as the evaporator. Therefore, in the cooling mode, the vehicle cabin can be cooled by discharging the blown air, which is cooled by the internal evaporator 19, into the vehicle cabin.

Furthermore, in the refrigeration cycle device 10a of the present embodiment, the control device 50 places the intermediate-pressure expansion valve 16e in the fully closed state in the other operating modes, so that the refrigeration cycle device 10a operates in the same way as the refrigeration cycle device 10 of the fifth embodiment. Therefore, the refrigeration cycle device 10a of the present embodiment can achieve the advantages which are similar to those of the fifth embodiment.

Furthermore, in the refrigeration cycle device 10a of the present embodiment, it is possible to form the gas injection cycle at the time of operating in (b) the cooling mode. Thus, at the time of operating in (b) the cooling mode, the coefficient of performance can be further improved.

### Thirteenth Embodiment

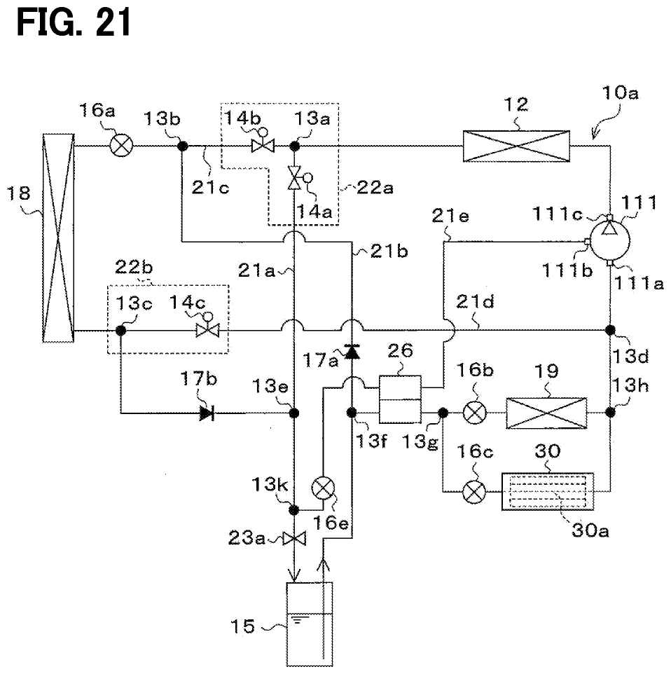

In the present embodiment, there will be described the refrigeration cycle device 10a in which the locations of the eleventh three-way joint 13k and the internal heat exchanger 26 are changed relative to the tenth embodiment as indicated in an overall structure diagram shown in FIG. 21.

The eleventh three-way joint 13k of the present embodiment is placed in the refrigerant passage which extends from the outflow opening of the fifth three-way joint 13e to the inlet of the fixed flow restrictor 23a in the inlet side passage 21a. Therefore, the intermediate-pressure expansion valve 16e of the present embodiment is the third depressurizing device that is configured to depressurize a portion of the refrigerant, which is present on the upstream side of the receiver 15, at the time of switching to and establishing a predetermined operating mode (the cooling mode in the present embodiment).

Like in the twelfth embodiment, the high-pressure refrigerant passage of the internal heat exchanger 26 of the present embodiment is placed in the refrigerant passage which extends from the other one of the outflow openings of the sixth three-way joint 13f to the inflow opening of the seventh three-way joint 13g. The rest of the structure is the same as those of the tenth embodiment.

Next, the operation of the refrigeration cycle device 10a having the above-described structure will be described. Even in the refrigeration cycle device 10a of the present embodiment, the operating mode is switched like in the first embodiment. Hereinafter, the operation of the respective operating modes will be described.

### (a) Outside Air Heating Mode

In the outside air heating mode, the control device 50 opens the first on-off valve 14a and closes the second on-off valve 14b and opens the third on-off valve 14c. Furthermore, the control device 50 places the heating expansion valve 16a in the throttled state and places the cooling expansion valve 16b in the fully closed state and places the intermediate-pressure expansion valve 16e in the fully closed state.

Thus, like in the outside air heating mode of the fifth embodiment, the refrigeration cycle device 10a in the outside air heating mode switches to and thereby establishes the first circuit in which the refrigerant is circulated in the same way as in the outside air heating mode of the fifth embodiment. Furthermore, in the outside air heating mode, the control device 50 controls the operations of the various control-subject devices like in the fifth embodiment. Therefore, like in the fifth embodiment, in the outside air heating mode, the vehicle cabin can be heated by discharging the blown air, which is heated by the internal condenser 12, into the vehicle cabin.

### (b) Cooling Mode

In the cooling mode, the control device 50 closes the first on-off valve 14a and opens the second on-off valve 14b and closes the third on-off valve 14c. Furthermore, the control device 50 places the heating expansion valve 16a in the fully opened state and places the cooling expansion valve 16b in the throttled state and places the intermediate-pressure expansion valve 16e in the throttled state.

In this way, the refrigeration cycle device 10a in the cooling mode switches to and thereby establishes the second circuit in which the refrigerant outputted from the discharge outlet 111c of the compressor 111 is circulated through (the internal condenser 12, the heating expansion valve 16a), the external heat exchanger 18, the fixed flow restrictor 23a, the receiver 15, the high-pressure refrigerant passage of the internal heat exchanger 26, the cooling expansion valve 16b, the internal evaporator 19 and the suction inlet 111a of the compressor 111 in this order. Furthermore, a portion of the refrigerant, which is present on the upstream side of the receiver 15, flows through the intermediate-pressure expansion valve 16e, the intermediate-pressure refrigerant passage of the internal heat exchanger 26 and the intermediate-pressure suction inlet 111b of the compressor 111 in this order.

With this circuit structure, like in the cooling mode of the twelfth embodiment, the control device 50 controls the operations of the various control-subject devices.

Specifically, in the refrigeration cycle device 10a in the cooling mode, there is formed the gas injection cycle of the internal heat exchange type, in which the external heat exchanger 18 functions as the condenser, and the internal evaporator 19 functions as the evaporator. Therefore, in the cooling mode, the vehicle cabin can be cooled by discharging the blown air, which is cooled by the internal evaporator 19, into the vehicle cabin.

Furthermore, in the refrigeration cycle device 10a of the present embodiment, the control device 50 places the intermediate-pressure expansion valve 16e in the fully closed state in the other operating modes, so that the refrigeration cycle device 10a operates in the same way as the refrigeration cycle device 10 of the fifth embodiment. Therefore, the refrigeration cycle device 10a of the present embodiment can achieve the advantages which are similar to those of the fifth embodiment.

Furthermore, in the refrigeration cycle device 10a of the present embodiment, it is possible to form the gas injection cycle at the time of operating in (b) the cooling mode. Thus, at the time of operating in (b) the cooling mode, the coefficient of performance can be further improved.

### Fourteenth Embodiment

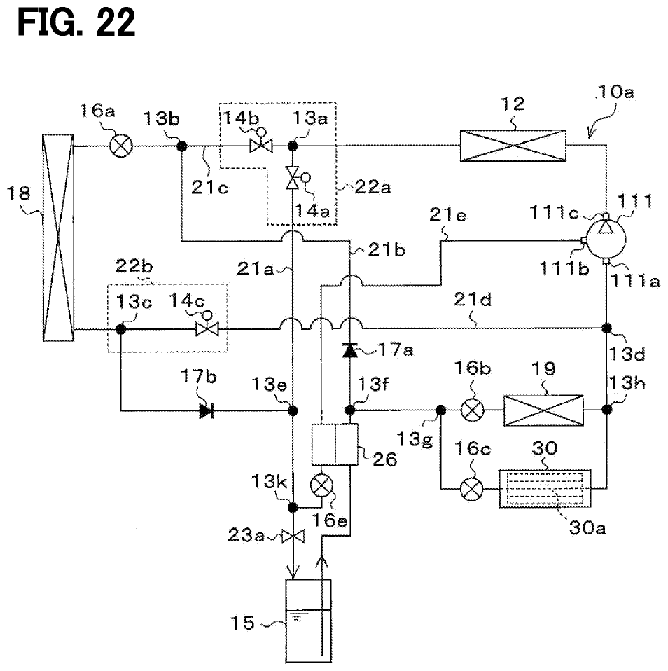

In the present embodiment, there will be described the refrigeration cycle device 10a in which the locations of the eleventh three-way joint 13k and the internal heat exchanger 26 are changed relative to the tenth embodiment as indicated in an overall structure diagram shown in FIG. 22.

The eleventh three-way joint 13k of the present embodiment is placed in the refrigerant passage which extends from the outflow opening of the fifth three-way joint 13e to the inlet of the fixed flow restrictor 23a in the inlet side passage 21a. Therefore, the intermediate-pressure expansion valve 16e of the present embodiment is the third depressurizing device that is configured to depressurize a portion of the refrigerant, which is present on the upstream side of the receiver 15, at the time of switching to and establishing a predetermined operating mode (the outside air heating mode and the cooling mode in the present embodiment).

The high-pressure refrigerant passage of the internal heat exchanger 26 of the present embodiment is placed in the refrigerant passage which extends from the outlet of the receiver 15 to the inflow opening of the sixth three-way joint 13f in the outlet side passage 21b. The rest of the structure is the same as those of the tenth embodiment.

Next, the operation of the refrigeration cycle device 10a having the above-described structure will be described. Even in the refrigeration cycle device 10a of the present embodiment, the operating mode is switched like in the first embodiment. Hereinafter, the operation of the respective operating modes will be described.

### (a) Outside Air Heating Mode

In the outside air heating mode, the control device 50 opens the first on-off valve 14a and closes the second on-off valve 14b and opens the third on-off valve 14c. Furthermore, the control device 50 places the heating expansion valve 16a in the throttled state and places the cooling expansion valve 16b in the fully closed state and places the intermediate-pressure expansion valve 16e in the throttled state.

In this way, the refrigeration cycle device 10a in the outside air heating mode switches to and thereby establishes the first circuit in which the refrigerant outputted from the discharge outlet 111c of the compressor 111 is circulated through the internal condenser 12, the fixed flow restrictor 23a, the receiver 15, the high-pressure refrigerant passage of the internal heat exchanger 26, the heating expansion valve 16a, the external heat exchanger 18 and the suction inlet 111a of the compressor 111 in this order. Furthermore, a portion of the refrigerant, which is present on the upstream side of the receiver 15, flows through the intermediate-pressure expansion valve 16e, the intermediate-pressure refrigerant passage of the internal heat exchanger 26 and the intermediate-pressure suction inlet 111b of the compressor 111 in this order.

With this circuit structure, like in the outside air heating mode of the tenth embodiment, the control device 50 controls the operations of the various control-subject devices.

Specifically, in the refrigeration cycle device 10a in the outside air heating mode, there is formed the gas injection cycle of the internal heat exchange type, in which the internal condenser 12 functions as the condenser, and the external heat exchanger 18 functions as the evaporator. Therefore, in the outside air heating mode, the vehicle cabin can be heated by discharging the blown air, which is heated by the internal condenser 12, into the vehicle cabin.

### (b) Cooling Mode

In the cooling mode, the control device 50 closes the first on-off valve 14a and opens the second on-off valve 14b and closes the third on-off valve 14c. Furthermore, the control device 50 places the heating expansion valve 16a in the fully opened state and places the cooling expansion valve 16b in the throttled state and places the intermediate-pressure expansion valve 16e in the throttled state.

In this way, the refrigeration cycle device 10a in the cooling mode switches to and thereby establishes the second circuit in which the refrigerant outputted from the discharge outlet 111c of the compressor 111 is circulated through (the internal condenser 12, the heating expansion valve 16a), the external heat exchanger 18, the fixed flow restrictor 23a, the receiver 15, the high-pressure refrigerant passage of the internal heat exchanger 26, the cooling expansion valve 16b, the internal evaporator 19 and the suction inlet 111a of the compressor 111 in this order. Furthermore, a portion of the refrigerant, which is present on the upstream side of the receiver 15, flows through the intermediate-pressure expansion valve 16e, the intermediate-pressure refrigerant passage of the internal heat exchanger 26 and the intermediate-pressure suction inlet 111b of the compressor 111 in this order.

With this circuit structure, like in the cooling mode of the twelfth embodiment, the control device 50 controls the operations of the various control-subject devices.

Specifically, in the refrigeration cycle device 10a in the cooling mode, there is formed the gas injection cycle of the internal heat exchange type, in which the external heat exchanger 18 functions as the condenser, and the internal evaporator 19 functions as the evaporator. Therefore, in the cooling mode, the vehicle cabin can be cooled by discharging the blown air, which is cooled by the internal evaporator 19, into the vehicle cabin.

Furthermore, in the refrigeration cycle device 10a of the present embodiment, the control device 50 places the intermediate-pressure expansion valve 16e in the fully closed state in the other operating modes, so that the refrigeration cycle device 10a operates in the same way as the refrigeration cycle device 10 of the fifth embodiment. Therefore, the refrigeration cycle device 10a of the present embodiment can achieve the advantages which are similar to those of the fifth embodiment.

Furthermore, in the refrigeration cycle device 10a, it is possible to form the gas injection cycle at the time of operating in (a) the outside air heating mode and (b) the cooling mode. Thus, at the time of operating in (a) the outside air heating mode and (b) the cooling mode, the coefficient of performance can be further improved.

### Fifteenth Embodiment

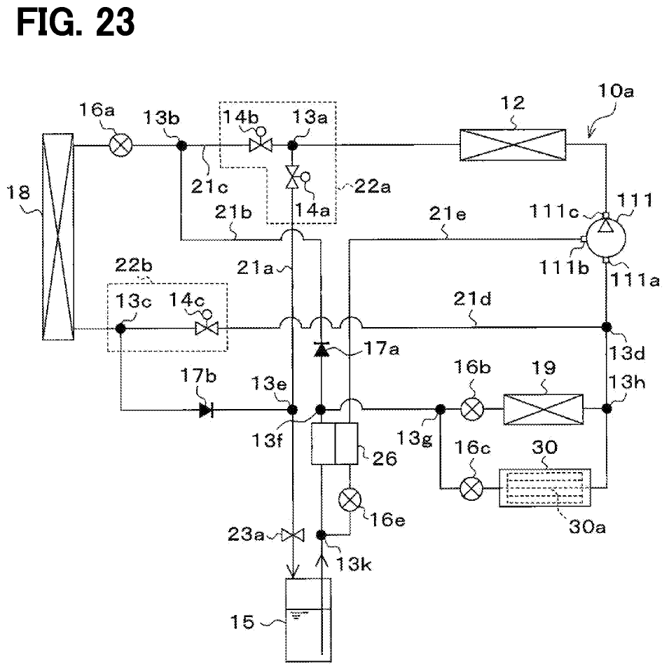

In the present embodiment, there will be described the refrigeration cycle device 10a in which the locations of the eleventh three-way joint 13k and the internal heat exchanger 26 are changed relative to the thirteenth embodiment as indicated in an overall structure diagram shown in FIG. 23.

The eleventh three-way joint 13k of the present embodiment is placed in the refrigerant passage which extends from the outlet of the receiver 15 to the inflow opening of the sixth three-way joint 13f in the outlet side passage 21b. Therefore, the intermediate-pressure expansion valve 16e of the present embodiment is the third depressurizing device that is configured to depressurize a portion of the refrigerant, which is outputted from the receiver 15, at the time of switching to and establishing a predetermined operating mode (the outside air heating mode and the cooling mode in the present embodiment).

Furthermore, the high-pressure refrigerant passage of the internal heat exchanger 26 of the present embodiment is placed in the refrigerant passage which extends from the other one of the outflow openings of the eleventh three-way joint 13k to the inflow opening of the sixth three-way joint 13f in the outlet side passage 21b. The rest of the structure is the same as those of the tenth embodiment.

Next, the operation of the refrigeration cycle device 10a having the above-described structure will be described. Even in the refrigeration cycle device 10a of the present embodiment, the operating mode is switched like in the first embodiment. Hereinafter, the operation of the respective operating modes will be described.

### (a) Outside Air Heating Mode

In the outside air heating mode, the control device 50 opens the first on-off valve 14a and closes the second on-off valve 14b and opens the third on-off valve 14c. Furthermore, the control device 50 places the heating expansion valve 16a in the throttled state and places the cooling expansion valve 16b in the fully closed state and places the intermediate-pressure expansion valve 16e in the throttled state.

In this way, the refrigeration cycle device 10a in the outside air heating mode switches to and thereby establishes the first circuit in which the refrigerant outputted from the discharge outlet 111c of the compressor 111 is circulated through the internal condenser 12, the fixed flow restrictor 23a, the receiver 15, the high-pressure refrigerant passage of the internal heat exchanger 26, the heating expansion valve 16a, the external heat exchanger 18 and the suction inlet 111a of the compressor 111 in this order. Furthermore, a portion of the refrigerant, which is outputted from the receiver 15, flows through the intermediate-pressure expansion valve 16e, the intermediate-pressure refrigerant passage of the internal heat exchanger 26 and the intermediate-pressure suction inlet 111b of the compressor 111 in this order.

With this circuit structure, like in the outside air heating mode of the tenth embodiment, the control device 50 controls the operations of the various control-subject devices.

Specifically, in the refrigeration cycle device 10a in the outside air heating mode, there is formed the gas injection cycle of the internal heat exchange type, in which the internal condenser 12 functions as the condenser, and the external heat exchanger 18 functions as the evaporator. Therefore, in the outside air heating mode, the vehicle cabin can be heated by discharging the blown air, which is heated by the internal condenser 12, into the vehicle cabin.

### (b) Cooling Mode

In the cooling mode, the control device 50 closes the first on-off valve 14a and opens the second on-off valve 14b and closes the third on-off valve 14c. Furthermore, the control device 50 places the heating expansion valve 16a in the fully opened state and places the cooling expansion valve 16b in the throttled state and places the intermediate-pressure expansion valve 16e in the throttled state.

In this way, the refrigeration cycle device 10a in the cooling mode switches to and thereby establishes the second circuit in which the refrigerant outputted from the discharge outlet 111c of the compressor 111 is circulated through (the internal condenser 12, the heating expansion valve 16a), the external heat exchanger 18, the fixed flow restrictor 23a, the receiver 15, the high-pressure refrigerant passage of the internal heat exchanger 26, the cooling expansion valve 16b, the internal evaporator 19 and the suction inlet 111a of the compressor 111 in this order. Furthermore, a portion of the refrigerant, which is outputted from the receiver 15, flows through the intermediate-pressure expansion valve 16e, the intermediate-pressure refrigerant passage of the internal heat exchanger 26 and the intermediate-pressure suction inlet 111b of the compressor 111 in this order.

With this circuit structure, like in the cooling mode of the twelfth embodiment, the control device 50 controls the operations of the various control-subject devices.

Specifically, in the refrigeration cycle device 10a in the cooling mode, there is formed the gas injection cycle of the internal heat exchange type, in which the external heat exchanger 18 functions as the condenser, and the internal evaporator 19 functions as the evaporator. Therefore, in the cooling mode, the vehicle cabin can be cooled by discharging the blown air, which is cooled by the internal evaporator 19, into the vehicle cabin.

Furthermore, in the refrigeration cycle device 10a of the present embodiment, the control device 50 places the intermediate-pressure expansion valve 16e in the fully closed state in the other operating modes, so that the refrigeration cycle device 10a operates in the same way as the refrigeration cycle device 10 of the fifth embodiment. Therefore, the refrigeration cycle device 10a of the present embodiment can achieve the advantages which are similar to those of the fifth embodiment.

Furthermore, in the refrigeration cycle device 10a, it is possible to form the gas injection cycle at the time of operating in (a) the outside air heating mode and (b) the cooling mode. Thus, at the time of operating in (a) the outside air heating mode and (b) the cooling mode, the coefficient of performance can be further improved.

### Sixteenth Embodiment

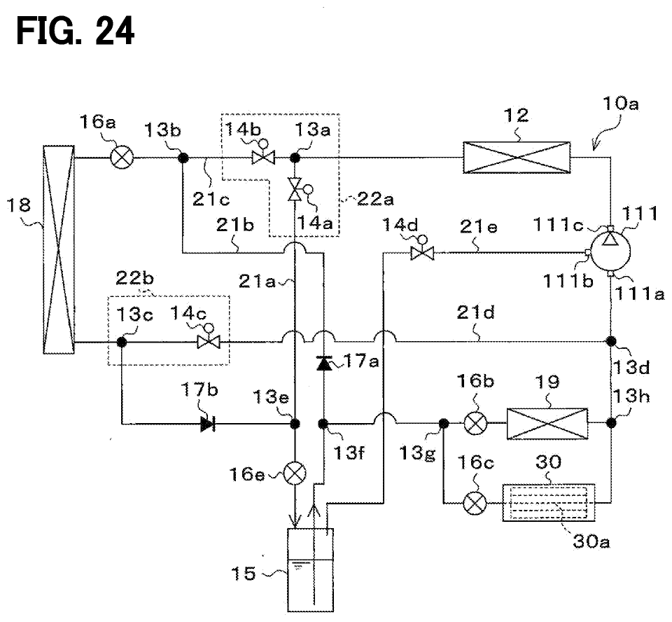

In the present embodiment, there will be described an example where the cycle structure of the refrigeration cycle device 10a is changed relative to the tenth embodiment as indicated in an overall structure diagram shown in FIG. 24. In the refrigeration cycle device 10a of the present embodiment, a fourth on-off valve 14d is added, and the fixed flow restrictor 23a, the eleventh three-way joint 13k and the internal heat exchanger 26 are eliminated. Furthermore, in the refrigeration cycle device 10a of the present embodiment, the location of the intermediate-pressure expansion valve 16e is changed.

The fourth on-off valve 14d is a solenoid valve that opens and closes the injection passage 21e. A basic structure of the fourth on-off valve 14d is the same as that of the first on-off valve 14a. The intermediate-pressure expansion valve 16e of the present embodiment is placed in the refrigerant passage which extends from the outflow opening of the fifth three-way joint 13e to the inlet of the receiver 15 in the inlet side passage 21a.

Furthermore, the receiver 15 of the present embodiment has a gas-phase refrigerant outflow opening from which the separated gas-phase refrigerant flows out. The gas-phase refrigerant outflow opening of the present embodiment is connected to the inlet of the injection passage 21e. Therefore, the intermediate-pressure expansion valve 16e of the present embodiment is the third depressurizing device that is configured to depressurize the refrigerant, which is to be inputted into the receiver 15, at the time of switching to and establishing a predetermined operating mode (the outside air heating mode and the cooling mode in the present embodiment).

Furthermore, the intermediate-temperature sensor of the present embodiment is arranged to sense the temperature of the refrigerant to be entered into the intermediate-pressure expansion valve 16e. The pressure sensor of the present embodiment is arranged to sense the pressure of the refrigerant to be entered into the intermediate-pressure expansion valve 16e. The rest of the structure of the refrigeration cycle device 10a is the same as that of the tenth embodiment.

Next, the operation of the refrigeration cycle device 10a having the above-described structure will be described. Even in the refrigeration cycle device 10a of the present embodiment, the operating mode is switched like in the first embodiment. Hereinafter, the operation of the respective operating modes will be described.

### (a) Outside Air Heating Mode

In the outside air heating mode, the control device 50 opens the first on-off valve 14a and closes the second on-off valve 14b and opens the third on-off valve 14c and opens the fourth on-off valve 14d. Furthermore, the control device 50 places the heating expansion valve 16a in the throttled state and places the cooling expansion valve 16b in the fully closed state and places the intermediate-pressure expansion valve 16e in the throttled state.

In this way, the refrigeration cycle device 10a in the outside air heating mode switches to and thereby establishes the first circuit in which the refrigerant outputted from the discharge outlet 111c of the compressor 111 is circulated through the internal condenser 12, the intermediate-pressure expansion valve 16e and the receiver 15 in this order, and the refrigerant outputted from the liquid-phase refrigerant outlet of the receiver 15 is circuited through the external heat exchanger 18 and the suction inlet 111a of the compressor 111 in this order. Furthermore, the refrigerant, which is outputted from the gas-phase refrigerant outlet of the receiver 15 is suctioned into the intermediate-pressure suction inlet 111b of the compressor 111 through the injection passage 21e.

With this circuit structure, the control device 50 controls the operations of the various control-subject devices. For example, the control device 50 controls the throttle opening degree of the intermediate-pressure expansion valve 16e such that the supercooling degree SC of the refrigerant to be inputted into the intermediate-pressure expansion valve 16e approaches a predetermined target supercooling degree KSC. The supercooling degree SC is computed based on the measurement signal of the intermediate-temperature sensor and the measurement signal of the intermediate-pressure sensor. The other control operations of the control device 50 are the same as those of the outside air heating mode of the tenth embodiment.

In the refrigeration cycle device 10a, when the compressor 111 is operated, the high-pressure refrigerant, which is outputted from the discharge outlet 111c of the compressor 111, flows into the internal condenser 12. The refrigerant, which flows into the internal condenser 12, is condensed by releasing the heat to the blown air, which has passed through the internal evaporator 19. In this way, the blown air is heated. The refrigerant, which is outputted from the internal condenser 12, flows into the intermediate-pressure expansion valve 16e and is depressurized until it becomes the intermediate-pressure refrigerant.

The intermediate-pressure refrigerant, which is depressurized by the intermediate-pressure expansion valve 16e, flows into the receiver 15. The refrigerant, which flows into the receiver 15, is separated into the gas-phase refrigerant and the liquid-phase refrigerant in the receiver 15. Furthermore, a portion of the gas-phase refrigerant, which is separated in the receiver 15, is suctioned into the intermediate-pressure suction inlet 111b of the compressor 111 through the injection passage 21e.

A portion of the liquid-phase refrigerant, which is separated in the receiver 15, flows into the heating expansion valve 16a through the outlet side passage 21b and the second three-way joint 13b. The refrigerant, which flows into the heating expansion valve 16a, is depressurized until it becomes the low-pressure refrigerant.

The low-pressure refrigerant, which is depressurized by the heating expansion valve 16a, flows into the external heat exchanger 18. The refrigerant, which flows into the external heat exchanger 18, is evaporated by absorbing the heat from the outside air. The refrigerant, which is outputted from the external heat exchanger 18, is suctioned into the suction inlet 111a of the compressor 111 through the third three-way joint 13c, the suction side passage 21d and the fourth three-way joint 13d and is compressed once again.

Specifically, in the refrigeration cycle device 10a in the outside air heating mode, there is formed the gas injection cycle of the gas-liquid separation type, in which the internal condenser 12 functions as the condenser, and the external heat exchanger 18 functions as the evaporator. Therefore, in the outside air heating mode, the vehicle cabin can be heated by discharging the blown air, which is heated by the internal condenser 12, into the vehicle cabin.

### (b) Cooling Mode

In the cooling mode, the control device 50 closes the first on-off valve 14a and opens the second on-off valve 14b and closes the third on-off valve 14c and opens the fourth on-off valve 14d. Furthermore, the control device 50 places the heating expansion valve 16a in the fully opened state and places the cooling expansion valve 16b in the throttled state and places the intermediate-pressure expansion valve 16e in the throttled state.

In this way, the refrigeration cycle device 10a in the cooling mode switches to and thereby establishes the second circuit in which the refrigerant outputted from the compressor 111 is circulated through (the internal condenser 12, the heating expansion valve 16a), the external heat exchanger 18, the intermediate-pressure expansion valve 16e and the receiver 15 in this order, and the refrigerant outputted from the liquid-phase refrigerant outlet of the receiver 15 is circulated through the cooling expansion valve 16b, the internal evaporator 19 and the suction inlet 111a of the compressor 111 in this order. Furthermore, the refrigerant, which is outputted from the gas-phase refrigerant outlet of the receiver 15 is suctioned into the intermediate-pressure suction inlet 111b of the compressor 111 through the injection passage 21e.

With this circuit structure, the control device 50 controls the operations of the various control-subject devices. For example, like in the outside air heating mode, the control device 50 controls the throttle opening degree of the intermediate-pressure expansion valve 16e such that the supercooling degree SC of the refrigerant to be inputted into the intermediate-pressure expansion valve 16e approaches the target supercooling degree KSC. The other control operations of the control device 50 are the same as those of the cooling mode of the twelfth embodiment.

Specifically, in the refrigeration cycle device 10a in the cooling mode, there is formed the gas injection cycle of the gas-liquid separation type, in which the external heat exchanger 18 functions as the condenser, and the internal evaporator 19 functions as the evaporator. Therefore, in the cooling mode, the vehicle cabin can be cooled by discharging the blown air, which is cooled by the internal evaporator 19, into the vehicle cabin.

Furthermore, in the refrigeration cycle device 10a of the present embodiment, the control device 50 places the fourth on-off valve 14d in the fully closed state in the other operating modes, so that the refrigeration cycle device 10a operates in the same way as the refrigeration cycle device 10 of the fifth embodiment. Therefore, the refrigeration cycle device 10a of the present embodiment can achieve the advantages which are similar to those of the fifth embodiment.

Furthermore, in the refrigeration cycle device 10a, it is possible to form the gas injection cycle at the time of operating in (a) the outside air heating mode and (b) the cooling mode. Thus, at the time of operating in (a) the outside air heating mode and (b) the cooling mode, the coefficient of performance can be further improved.

The present disclosure should not be limited to the above-described embodiments and can be variously modified as follows without departing from the scope of the present disclosure.

In the above embodiments, there is described the example where the refrigeration cycle device 10 is applied to the air conditioning apparatus having the in-vehicle device cooling function. However, the application of the refrigeration cycle device 10 should not be limited to this. The refrigeration cycle device 10 of the present disclosure may be applied to a stationary air conditioning apparatus. The refrigeration cycle device 10 of the present disclosure may be applied to, for example, an air conditioning apparatus having a server temperature adjusting function for cooling a computer used as a server and air conditioning a room where the server is received.

Furthermore, in the above embodiments, there is described the example where the battery 30 is used as the in-vehicle device. However, the present disclosure should not be limited to this. For example, there may be used another in-vehicle device, which generates heat during the operation thereof, such as a motor generator, an electric power control unit (so-called PCU), and a control device for an advanced driver assistance system (so-called ADAS).

Furthermore, the refrigeration cycle device 10 of the present disclosure may be applied to an air conditioning apparatus that does not have the cooling function for the in-vehicle device or the like. In such a case, the seventh three-way joint 13g, the cool down expansion valve 16c and the eighth three-way joint 13h may be eliminated.

The constituent devices of the refrigeration cycle device 10, 10a should not be limited to those described in the above embodiments.

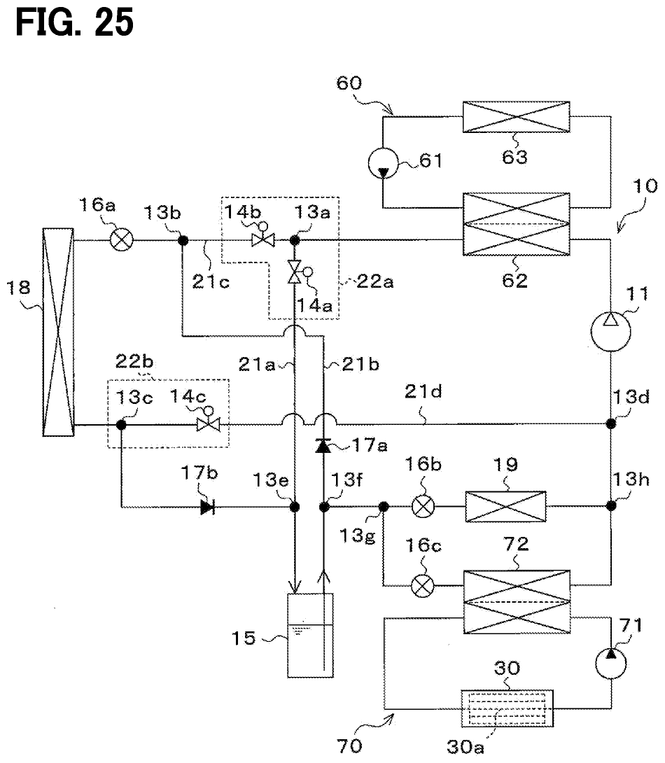

For example, in the above-described embodiments, there is described the example where the internal condenser 12 is used as the heating device that uses the high-pressure refrigerant as the heat source to heat the blown air. However, the present disclosure should not be limited to this. For example, as shown in FIG. 25, the heating device may be formed by adding a high-temperature side heat medium circuit 60, which circulates the high-temperature side heat medium, to the refrigeration cycle device 10 described in the first embodiment.

More specifically, a high-temperature side water pump 61, a heat medium-refrigerant heat exchanger 62, a heater core 63 and the like may be provided in the high-temperature side heat medium circuit 60.

The heat medium-refrigerant heat exchanger 62 is a heat releasing device that releases the heat from the high-pressure refrigerant by exchanging the heat between the high-pressure refrigerant discharged from the compressor 11 and the high-temperature side heat medium. The high-temperature side water pump 61 is an electric pump that pumps the high-temperature side heat medium, which is circulated in the high-temperature side heat medium circuit 60, to the heat medium-refrigerant heat exchanger 62. A rotational speed (i.e., a water pumping capacity) of the high-temperature side water pump 61 is controlled by a control signal outputted from the control device 50. The heater core 63 is a heat exchange device that heats the blown air by exchanging the heat between the heat medium, which is heated by the heat medium-refrigerant heat exchanger, and the blown air.

Furthermore, for example, in the above embodiments, there is described the example where the battery cooling device (in other words, the cooling device for the in-vehicle device) of the direct cooling type that exchanges the heat between the low-pressure refrigerant, which is depressurized by the cool down expansion valve 16c, and the battery 30. For example, as shown in FIG. 25, the cooling device for the in-vehicle device may be formed by adding a low-temperature side heat medium circuit 70.

More specifically, a low-temperature side water pump 71, a chiller 72, a heat medium passage of the in-vehicle device (the refrigerant passage 30a of the battery 30 in FIG. 25) and the like may be provided in the low-temperature side heat medium circuit 70.

The chiller 72 is an evaporating device that is configured to evaporate the low-pressure refrigerant, which is depressurized by the cool down expansion valve 16c, through heat exchange between this low-pressure refrigerant and the low-temperature side heat medium. The low-temperature side water pump 71 is an electric pump that pumps the low-temperature side heat medium, which is circulated in the low-temperature side heat medium circuit 70, to the heat medium passage of the in-vehicle device. A basic structure of the low-temperature side water pump 71 is the same as that of the high-temperature side water pump 61.

In the case where the low-temperature side heat medium circuit 70 is used, the control device 50 may control the throttle opening degree of the cool down expansion valve 16c such that the temperature of the low-temperature side heat medium to be outputted from the chiller 72 approaches a reference heat medium temperature at the time of operating in, for example, (d) the battery-only mode. This also applies to (e) the outside air waste heat heating mode, (f) the cooling battery mode and (g) the outside air waste heat parallel dehumidifying and heating mode.

Further, a solution containing ethylene glycol, dimethylpolysiloxane, nanofluid or the like; an antifreeze liquid; an aqueous liquid medium containing alcohol or the like; or a liquid medium containing oil or the like may be used as the high-temperature side heat medium or the low-temperature side heat medium.

Furthermore, the constituent devices of the refrigerant circuit switching device may be integrated together like in the integrated valve 24 described in the sixth embodiment.

For example, there may be used a first three-way valve in which the first on-off valve 14a, the second on-off valve 14b and the first three-way joint 13a of the first switching device 22a are integrated together. For example, there may be used a second three-way valve in which the third on-off valve 14c and the third three-way joint 13c of the second switching device 22b are integrated together.

Furthermore, like the integrated valve 24 of the sixth embodiment, the heating expansion valve 16a and the second three-way valve may be integrated together. Similarly, the heating expansion valve 16a and the above-described first three-way valve may be integrated together.

Furthermore, in the fifth embodiment described above, there is described the example where the fixed flow restrictor is used as each of the liquid-storage side depressurizing devices 23a-23b. However, the present disclosure should not be limited to this. A variable throttle mechanism may be used as each of the liquid-storage side depressurizing devices 23a-23b.

Furthermore, an evaporation pressure regulating valve may be added to the refrigeration cycle device 10 described in the above embodiments. The evaporation pressure regulating valve is a pressure regulating valve that keeps the pressure of the refrigerant, which is present on the upstream side thereof, at a reference pressure or higher. Specifically, as the evaporation pressure regulating valve, there may be used a mechanical variable throttle mechanism that increases a valve opening degree thereof in response to an increase in the pressure of the refrigerant at the outlet of the evaporating device.

For example, the evaporation pressure regulating valve may be added between the refrigerant outlet of the internal evaporator 19 and the one of the inflow openings of the eighth three-way joint 13h. Accordingly, the refrigerant evaporation temperature of the internal evaporator 19 can be maintained at the temperature (e.g., 0° C. or higher) that can limit the frost formation, and thereby the frost formation on the internal evaporator 19 can be limited.

Furthermore, in the eighth embodiment described above, there is described the refrigeration cycle device 10 that includes the internal evaporator 19, the rear internal evaporator 19a and the refrigerant passage 30a of the battery 30 which respectively function as the evaporating devices and are connected in parallel relative to the flow of the refrigerant. The way of connecting the internal evaporator 19, the rear internal evaporator 19a, and the refrigerant passage 30a of the battery 30 should not be limited to the example disclosed in the eighth embodiment.

For example, in the eighth embodiment, the one of the branched refrigerant flows, which are branched at the seventh three-way joint 13g, is inputted into the internal evaporator 19 through the cooling expansion valve 16b, and the other one of the branched refrigerant flows, which are branched at the seventh three-way joint 13g, is inputted into the ninth three-way joint 13i. Furthermore, the one of the branched refrigerant flows, which are branched at the ninth three-way joint 13i, is inputted into the refrigerant passage 30a of the battery 30 through the cool down expansion valve 16c, and the other one of the branched refrigerant flows, which are branched at the ninth three-way joint 13i, is inputted into the rear internal evaporator 19a through the rear cooling expansion valve 16d.

Alternatively, the one of the branched refrigerant flows, which are branched at the seventh three-way joint 13g, may be inputted into the refrigerant passage 30a of the battery 30 through the cool down expansion valve 16c, and the other one of the branched refrigerant flows, which are branched at the seventh three-way joint 13g, may be inputted into the ninth three-way joint 13i. Furthermore, the one of the branched refrigerant flows, which are branched at the ninth three-way joint 13i, may be inputted into the internal evaporator 19 through the cooling expansion valve 16b, and the other one of the branched refrigerant flows, which are branched at the ninth three-way joint 13i, may be inputted into the rear internal evaporator 19a through the rear cooling expansion valve 16d.

For example, in the eighth embodiment, the flow of the refrigerant, which is outputted from the refrigerant passage 30a of the battery 30, and the flow of the refrigerant, which is outputted from the rear internal evaporator 19a, are merged together in the tenth three-way joint 13j. Furthermore, the flow of the refrigerant, which is outputted from the internal evaporator 19, and the flow of the refrigerant, which is outputted from the tenth three-way joint 13j, are merged together in the eighth three-way joint 13h.

Alternatively, the flow of the refrigerant, which is outputted from the internal evaporator 19, and the flow of the refrigerant, which is outputted from the rear internal evaporator 19a, may be merged together in the tenth three-way joint 13j. Furthermore, the flow of the refrigerant, which is outputted from the refrigerant passage 30a of the battery 30, and the flow of the refrigerant, which is outputted from the tenth three-way joint 13j, may be merged together in the eighth three-way joint 13h.

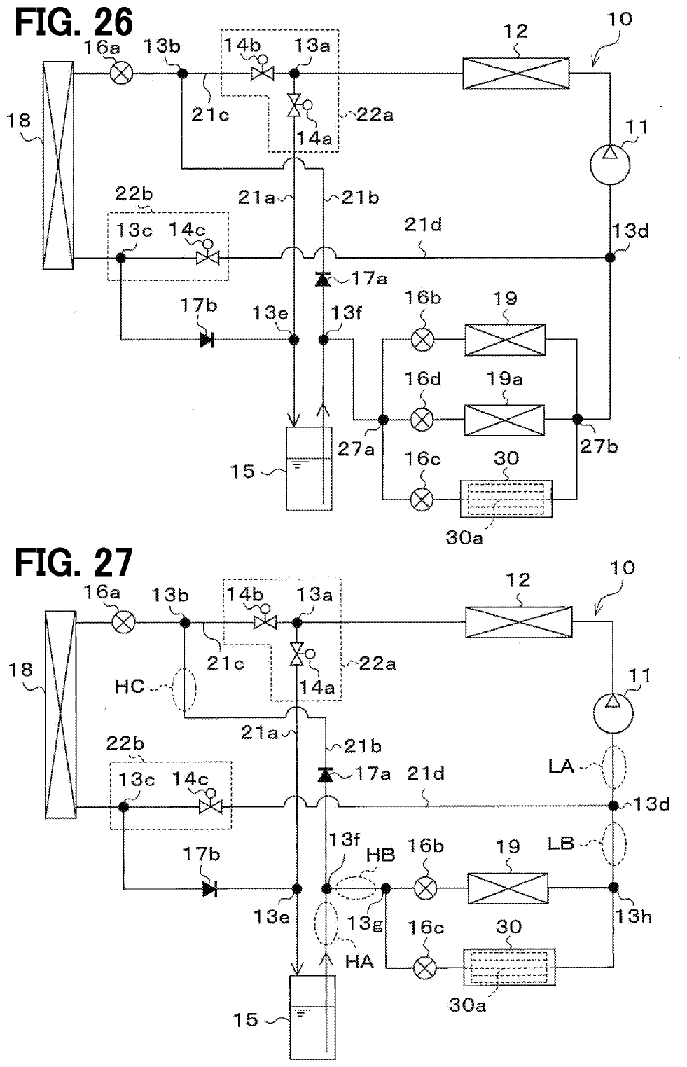

Furthermore, as shown in FIG. 26, a first four-way joint 27a may be placed on the upstream side of the internal evaporator 19, the rear internal evaporator 19a and the refrigerant passage 30a of the battery 30 in the flow direction of the refrigerant, and the flow of the refrigerant may be branched at the first four-way joint 27a. Furthermore, a second four-way joint 27b may be placed on the downstream side of the internal evaporator 19, the rear internal evaporator 19a and the refrigerant passage 30a of the battery 30 in the flow direction of the refrigerant, and the flows of the refrigerant outputted from these evaporating devices may be merged at the second four-way joint 27b.

By changing the way of connecting the downstream sides of the internal evaporator 19, the rear internal evaporator 19a and the refrigerant passage 30a of the battery 30 in this way, a degree of freedom with respect to the arrangement of the evaporation pressure regulating valve described above can be improved.

Furthermore, in the tenth to sixteenth embodiments, there is used the compressor 111, in which the two compression mechanisms are received in the one housing. However, the two-stage compressor, which can be used in the tenth to sixteenth embodiments, should not be limited to this.

For example, as long as the intermediate-pressure refrigerant, which is inputted from the intermediate-pressure suction inlet 111b, can be merged with the refrigerant, which is under the compression process from the low pressure to the high pressure, there may be used an electric compressor that includes one fixed-capacity compression mechanism and an electric motor for rotating the compression mechanism while the one fixed-capacity compression mechanism and the electric motor are received in a housing.

Furthermore, the two-stage compressor may be formed by two compressors, i.e., a low-stage side compressor and a high-stage side compressor which are connected in series. In such a case, a suction inlet of the low-stage side compressor placed on the low-stage side is used as the suction inlet 111a of the entire two-stage compressor. A discharge outlet of the high-stage side compressor placed on the high-stage side is used as the discharge outlet 111c of the entire two-stage compressor. Furthermore, the intermediate-pressure suction inlet 111b of the entire two-stage compressor may be provided to a refrigerant passage that connects between a discharge outlet of the low-stage side compressor and a suction inlet of the high-stage side compressor.

Furthermore, in the tenth to sixteenth embodiments, there is described the example where the electric variable throttle mechanism is used as the intermediate-pressure expansion valve 16e. However, the present disclosure should not be limited to this.

For example, in the tenth to fifteenth embodiments, as the intermediate-pressure expansion valve 16e, there may be used a thermal expansion valve that changes a throttle opening degree thereof such that the superheat degree SH5 of the refrigerant to be suctioned into the intermediate-pressure suction inlet 111b of the compressor 111 approaches the target superheat degree KSH. Furthermore, in addition to the thermal expansion valve, the fourth on-off valve 14d, which opens and closes the injection passage 21e, may be provided.

For example, in the sixteenth embodiment, a high-pressure control valve may be used as the intermediate-pressure expansion valve 16e. The high-pressure control valve is a mechanical variable throttle mechanism that changes a throttle opening degree thereof such that the pressure of the high-pressure refrigerant to be inputted into the intermediate-pressure expansion valve 16e becomes a target high pressure which is determined based on the temperature of the high-pressure refrigerant. Furthermore, in addition to the high-pressure control valve, the fourth on-off valve 14d, which opens and closes the injection passage 21e, may be provided.

Furthermore, in the above-described embodiments, there is described the example where the R1234yf is used as the refrigerant. However, the refrigerant should not be limited to this. For example, R134a, R600a, R410A, R404A, R32, R407C or the like may be used as the refrigerant. Alternatively, a mixed refrigerant, in which any two or more of these refrigerants are mixed, may be used.

In the ninth embodiment, there is described the exemplary arrangement of the internal heat exchanger 26 in the refrigeration cycle device 10. However, the arrangement of the internal heat exchanger 26 should not be limited to this.

For example, as shown in an overall structure diagram of FIG. 27, the high-pressure refrigerant passage 26a may be placed in the refrigerant passage (a region HA in FIG. 27) which extends from the outlet of the receiver 15 to the inflow opening of the sixth three-way joint 13f. Further alternatively, the high-pressure refrigerant passage 26a may be placed in the refrigerant passage (a region HB in FIG. 27) which extends from the other one of the outflow openings of the sixth three-way joint 13f to the inflow opening of the seventh three-way joint 13g. Further alternatively, the high-pressure refrigerant passage 26a may be placed in the outlet side passage 21b (a region HC in FIG. 27) which extends from the one of the outflow openings of the sixth three-way joint 13f to the other one of the inflow openings of the second three-way joint 13b.

The low-pressure refrigerant passage 26b may be placed in the refrigerant passage (a region LA in FIG. 27) which extends from the outflow opening of the fourth three-way joint 13d to the suction inlet of the compressor 11. Alternatively, the low-pressure refrigerant passage 26b may be placed in the refrigerant passage (a region LB in FIG. 27) which extends from the outflow opening of the eighth three-way joint 13h to the other one of the inflow openings of the fourth three-way joint 13d.

Specifically, it is only required that the internal heat exchanger 26 is arranged to enable the heat exchange between the refrigerant, which is prior to the depressurization thereof at the heating expansion valve 16a, the cooling expansion valve 16b, the cool down expansion valve 16c and the rear cooling expansion valve 16d after flowing out from the receiver 15, and the refrigerant, which is prior to the suction thereof into the compressor 11 after flowing out from the heat exchanger that functions as the evaporator.

The refrigeration cycle device 10a described in the tenth to sixteenth embodiments is configured to switch the refrigerant circuit such that the gas injection cycle is formed in (a) the outside air heating mode or (b) the cooling mode.

For example, the refrigeration cycle device 10a described in the thirteenth embodiment may form the gas injection cycle in (d) the battery-only mode while the intermediate-pressure expansion valve 16e is placed in the throttled state. In the other operating modes, the gas injection cycle may be formed within a feasible extent.

The sensors for the control operations should not be limited to the sensors described in the above embodiments.

For example, there may be used a pressure sensing device that senses the pressure of the refrigerant to be inputted into the heating expansion valve 16a after flowing out from the second three-way joint 13b. For example, there may be used a temperature sensing device that senses the temperature of the refrigerant to be inputted into the heating expansion valve 16a after flowing out from the second three-way joint 13b. The measurement signals of these sensing devices may be used to, for example, estimate the flow rate of the refrigerant that is circulated in the cycle.

Furthermore, there may be used a pressure sensing device that senses the pressure of the refrigerant to be inputted into the external heat exchanger 18 after flowing out from the heating expansion valve 16a. Furthermore, there may be used a temperature sensing device that senses the temperature of the refrigerant to be inputted into the external heat exchanger 18 after flowing out from the heating expansion valve 16a. The measurement signals of these sensing devices may be used to, for example, estimate the flow rate of the refrigerant that is circulated in the cycle.

Furthermore, there may be used a pressure sensing device that senses the pressure of the refrigerant flowing in the refrigerant passage which extends from the outlet of the third on-off valve 14c to the one of the inflow openings of the fourth three-way joint 13d in the suction side passage 21d. Furthermore, there may be used a temperature sensing device that senses the temperature of the refrigerant flowing in the refrigerant passage which extends from the outlet of the third on-off valve 14c to the one of the inflow openings of the fourth three-way joint 13d in the suction side passage 21d. The measurement signals of these sensing devices may be used to sense the state of the refrigerant at the outlet of the external heat exchanger 18.

Furthermore, there may be used a pressure sensing device that senses the pressure of the refrigerant which flows into the receiver 15 or the pressure of the refrigerant outputted from the receiver 15. The measurement signals of these sensing devices may be used to sense the pressure in the receiver 15.

There may be used a pressure sensing device that senses the pressure of the refrigerant flowing in the refrigerant passage which extends from the other one of the outflow openings of the third three-way joint 13c to the other one of the inflow openings of the fifth three-way joint 13e. There may be used a temperature sensing device that senses the temperature of the refrigerant flowing in the refrigerant passage which extends from the other one of the outflow openings of the third three-way joint 13c to the other one of the inflow openings of the fifth three-way joint 13e. The measurement signals of these sensing devices may be used to sense the state of the refrigerant outputted from the external heat exchanger 18.

Furthermore, there may be used a pressure sensing device that senses the pressure of the refrigerant flowing in the refrigerant passage which extends from the one of the outflow openings of the first three-way joint 13a to the one of the inflow openings of the fifth three-way joint 13e in the inlet side passage 21a. Furthermore, there may be used a temperature sensing device that senses the temperature of the refrigerant flowing in the refrigerant passage which extends from the one of the outflow openings of the first three-way joint 13a to the one of the inflow openings of the fifth three-way joint 13e in the inlet side passage 21a. The measurement signals of these sensing devices may be used to sense the state of the refrigerant at the outlet of the internal condenser 12.

Furthermore, there may be used a pressure sensing device that senses the pressure of the refrigerant to be inputted into the cooling expansion valve 16b after flowing out from the seventh three-way joint 13g. There may be used a temperature sensing device that senses the temperature of the refrigerant to be inputted into the cooling expansion valve 16b after flowing out from the seventh three-way joint 13g. The measurement signals of these sensing devices may be used to, for example, estimate the flow rate of the refrigerant that flows through the internal evaporator 19.

Furthermore, there may be used a pressure sensing device that senses the pressure of the refrigerant to be inputted into the internal evaporator 19 after flowing out from the cooling expansion valve 16b. Furthermore, there may be used a temperature sensing device that senses the temperature of the refrigerant to be inputted into the internal evaporator 19 after flowing out from the cooling expansion valve 16b. The measurement signals of these sensing devices may be used to, for example, estimate the flow rate of the refrigerant that flows through the internal evaporator 19.

Furthermore, there may be used a pressure sensing device that senses the pressure of the refrigerant to be inputted into the eighth three-way joint 13h after flowing out from the internal evaporator 19. Furthermore, there may be used a temperature sensing device that senses the temperature of the refrigerant to be inputted into the eighth three-way joint 13h after flowing out from the internal evaporator 19. The measurement signals of these sensing devices may be used to sense the state of the refrigerant at the outlet of the internal evaporator 19.

Furthermore, there may be used a pressure sensing device that senses the pressure of the refrigerant to be inputted into the cool down expansion valve 16c after flowing out from the seventh three-way joint 13g. There may be used a temperature sensing device that senses the temperature of the refrigerant to be inputted into the cool down expansion valve 16c after flowing out from the seventh three-way joint 13g. The measurement signals of these sensing devices may be used to, for example, estimate the flow rate of the refrigerant that flows through the refrigerant passage 30a of the battery 30 (or the refrigerant passage of the chiller 72).

Furthermore, there may be used a pressure sensing device that senses the pressure of the refrigerant to be inputted into the refrigerant passage 30a of the battery 30 (or the refrigerant passage of the chiller 72) after flowing out from the cool down expansion valve 16c. Furthermore, there may be used a temperature sensing device that senses the temperature of the refrigerant to be inputted into the refrigerant passage 30a of the battery 30 (or the refrigerant passage of the chiller 72) after flowing out from the cool down expansion valve 16c. The measurement signals of these sensing devices may be used to, for example, estimate the flow rate of the refrigerant that flows through the refrigerant passage 30a of the battery 30 (or the refrigerant passage of the chiller 72).

Furthermore, there may be used a pressure sensing device that senses the pressure of the refrigerant to be inputted into the eighth three-way joint 13h after flowing out from the refrigerant passage 30a of the battery 30 (or the refrigerant passage of the chiller 72). Furthermore, there may be used a temperature sensing device that senses the temperature of the refrigerant to be inputted into the eighth three-way joint 13h after flowing out from the refrigerant passage 30a of the battery 30 (or the refrigerant passage of the chiller 72). The measurement signals of these sensing devices may be used to sense the state of the refrigerant at the outlet of the refrigerant passage 30a of the battery 30 (or the refrigerant passage of the chiller 72).

Furthermore, there may be used a pressure sensing device that senses the pressure of the refrigerant to be inputted into the suction inlet of the compressor 11 or the suction inlet 111a of the compressor 111 after flowing out from the outlet of the fourth three-way joint 13d. Furthermore, there may be used a temperature sensing device that senses the temperature of the refrigerant to be inputted into the suction inlet of the compressor 11 or the suction inlet 111a of the compressor 111 after flowing out from the outlet of the fourth three-way joint 13d. The measurement signals of these sensing devices may be used to sense the state of the refrigerant to be suctioned into the compressor 11, 111.

The components of the respective embodiments described above may be appropriately combined within a feasible extent.

For example, the liquid-storage side depressurizing device 23a, 23b described in the fifth or sixth embodiment may be applied to the refrigeration cycle device 10 described in the second to fourth and seventh to ninth embodiments. For example, the integrated valve 24 described in the sixth embodiment may be applied to the refrigeration cycle device 10, 10a described in the second to fourth and seventh to sixteenth embodiments.

Like in the eighth embodiment, the rear cooling expansion valve 16d and the rear internal evaporator 19a may be added to the refrigeration cycle device 10a described in the tenth to sixteenth embodiments. In the refrigeration cycle device 10a described in the tenth to sixteenth embodiments, the heating device may be formed by the high-temperature side heat medium circuit 60, and the cooling device may be formed by the low-temperature side heat medium circuit 70 in the manner described with reference to FIG. 25.

Although the present disclosure has been described with reference to the embodiments, it is understood that the present disclosure should not be limited to the embodiments and the structures described above. The present disclosure also includes various modifications and modifications within an equivalent range. In addition, various combinations and forms, as well as other combinations and forms, which include only one element, or more or less elements among the elements of the various combinations and forms, may be also within the scope of the present disclosure.

What is claimed is:

1. A refrigeration cycle device comprising:
a compressor that is configured to compress and discharge refrigerant;
a heat releasing device that is configured to release heat from the refrigerant discharged from the compressor;
a liquid storage that is configured to store the refrigerant which is surplus in a cycle in the refrigeration cycle device;
a first depressurizing device that is configured to depressurize the refrigerant;
an external heat exchanger that is configured to exchange heat between the refrigerant, which is outputted from the first depressurizing device, and outside air;
a second depressurizing device that is configured to depressurize the refrigerant;
an evaporating device that is configured to evaporate the refrigerant which is depressurized by the second depressurizing device; and
a refrigerant circuit switching device that is configured to switch a refrigerant circuit, wherein:
the refrigerant circuit switching device is configured to switch among at least:
a first circuit that is configured to conduct the refrigerant, which is outputted from the heat releasing device, to the liquid storage and conduct the refrigerant, which is outputted from the liquid storage, to the first depressurizing device and conduct the refrigerant, which is depressurized by the first depressurizing device, to the external heat exchanger; and
a second circuit that is configured to conduct the refrigerant, which is outputted from the external heat exchanger, to the liquid storage and conduct the refrigerant, which is outputted from the liquid storage, to the second depressurizing device and conduct the refrigerant, which is depressurized by the second depressurizing device, to the evaporating device; and
the refrigerant circuit switching device is configured to switch the refrigerant circuit such that a flow direction of the refrigerant in the external heat exchanger at a time of switching to and thereby establishing the first circuit coincides with a flow direction of the refrigerant in the external heat exchanger at a time of switching to and thereby establishing the second circuit.

2. The refrigeration cycle device according to claim 1, wherein the refrigerant circuit switching device includes:
a first switching device that is configured to guide the refrigerant, which is outputted from the compressor, toward at least one of the liquid storage and the external heat exchanger;
a joint that is configured to guide at least one of the refrigerant, which is outputted from the first switching device, and the refrigerant, which is outputted from the liquid storage, toward the external heat exchanger; and
a second switching device that is configured to guide the refrigerant, which is outputted from the external heat exchanger, toward at least one of a suction inlet of the compressor and the liquid storage.

3. The refrigeration cycle device according to claim 2, wherein:
the first switching device is configured to guide the refrigerant, which is outputted from the heat releasing device, toward at least one of the liquid storage and the joint; and
the joint is configured to guide at least one of the refrigerant, which is outputted from the first switching device, and the refrigerant, which is outputted from the liquid storage, toward the first depressurizing device.

4. The refrigeration cycle device according to claim 2, wherein:
the first switching device is configured to guide the refrigerant, which is outputted from the compressor, toward at least one of the heat releasing device and the joint; and
the joint is configured to guide at least one of the refrigerant, which is outputted from the first switching device, and the refrigerant, which is outputted from the liquid storage, toward the first depressurizing device.

5. The refrigeration cycle device according to claim 2, wherein:
the first switching device is configured to guide the refrigerant, which is outputted from the compressor, toward at least one of the heat releasing device and the joint; and
the joint is configured to guide at least one of the refrigerant, which is outputted from the first switching device, and the refrigerant, which is outputted from the first depressurizing device, toward the external heat exchanger.

6. The refrigeration cycle device according to claim 2, wherein:
the first switching device is configured to guide the refrigerant, which is outputted from the heat releasing device, toward at least one of the liquid storage and the joint; and
the joint is configured to guide at least one of the refrigerant, which is outputted from the first switching device, and the refrigerant, which is outputted from the first depressurizing device, toward the external heat exchanger.

7. The refrigeration cycle device according to claim 2, wherein the first depressurizing device and the second switching device are integrated together to enable heat exchange between the refrigerant, which is to be inputted into the first depressurizing device, and the refrigerant, which is guided from the second switching device toward the suction inlet of the compressor.

8. The refrigeration cycle device according claim 1, comprising an internal heat exchanger that is configured to exchange heat between:
the refrigerant, which is prior to depressurization by at least one of the first depressurizing device and the second depressurizing device after being outputted from the liquid storage; and
the refrigerant, which is prior to suction into the compressor after being outputted from the evaporating device.

9. The refrigeration cycle device according to claim 1, comprising at least one liquid-storage side depressurizing device that is configured to depressurize the refrigerant to be inputted into the liquid storage.

10. The refrigeration cycle device according to claim 9, wherein the at least one liquid-storage side depressurizing device includes a first liquid-storage side depressurizing device, which is configured to depressurize the refrigerant to be inputted into the liquid storage in a state where the refrigerant circuit switching device switches to and thereby establishes the first circuit.

11. The refrigeration cycle device according to claim 9, wherein the at least one liquid-storage side depressurizing device includes a second liquid-storage side depressurizing device, which is configured to depressurize the refrigerant to be inputted into the liquid storage in a state where the refrigerant circuit switching device switches to and thereby establishes the second circuit.

12. A refrigeration cycle device comprising:
a compressor that is configured to compress refrigerant and includes:
a suction inlet which is configured to suction the refrigerant having a low pressure;
an intermediate-pressure suction inlet which is configured to suction the refrigerant having an intermediate pressure that is higher than the low pressure; and
a discharge outlet which is configured to discharge the refrigerant compressed by the compressor;
a heat releasing device that is configured to release heat from the refrigerant discharged from the discharge outlet;
a liquid storage that is configured to store the refrigerant which is surplus in a cycle in the refrigeration cycle device;
a first depressurizing device that is configured to depressurize the refrigerant;
an external heat exchanger that is configured to exchange heat between the refrigerant, which is outputted from the first depressurizing device, and outside air;
a second depressurizing device that is configured to depressurize the refrigerant;
an evaporating device that is configured to evaporate the refrigerant which is depressurized by the second depressurizing device; and
a third depressurizing device that is configured to depressurize at least a portion of one of:
the refrigerant, which is on an upstream side of the liquid storage; and
the refrigerant, which is outputted from the liquid storage, wherein the third depressurizing device is configured to output the refrigerant, which is depressurized by the third depressurizing device, toward the intermediate-pressure suction inlet; and
a refrigerant circuit switching device that is configured to switch a refrigerant circuit, wherein:
the refrigerant circuit switching device is configured to switch among at least:
a first circuit that is configured to conduct the refrigerant, which is outputted from the heat releasing device, to the liquid storage and conduct the refrigerant, which is outputted from the liquid storage, to the first depressurizing device and conduct the refrigerant, which is depressurized by the first depressurizing device, to the external heat exchanger; and
a second circuit that is configured to conduct the refrigerant, which is outputted from the external heat exchanger, to the liquid storage and conduct the refrigerant, which is outputted from the liquid storage, to the second depressurizing device and conduct the refrigerant, which is depressurized by the second depressurizing device, to the evaporating device;
in a state where the refrigerant circuit switching device switches to and thereby establishes at least one of the first circuit and the second circuit, the refrigerant circuit switching device is configured to switch to and thereby establish a refrigerant circuit that conducts the refrigerant, which is depressurized by the third depressurizing device, to the intermediate-pressure suction inlet; and
the refrigerant circuit switching device is configured to switch the refrigerant circuit such that a flow direction of the refrigerant in the external heat exchanger at a time of switching to and thereby establishing the first circuit coincides with a flow direction of the refrigerant in the external heat exchanger at a time of switching to and thereby establishing the second circuit.

13. The refrigeration cycle device according to claim 12 comprising an internal heat exchanger that is configured to exchange heat between the refrigerant, which is outputted from the liquid storage, and the refrigerant, which is depressurized by the third depressurizing device.

14. The refrigeration cycle device according to claim 12, wherein in a state where the refrigerant circuit switching device switches to and thereby establishes the first circuit, the refrigerant circuit switching device is configured to switch to and thereby establish a refrigerant circuit that conducts the refrigerant, which is outputted from the external heat exchanger, to the suction inlet and conducts the refrigerant, which is depressurized by the third depressurizing device, to the intermediate-pressure suction inlet.

15. The refrigeration cycle device according to claim 12, wherein in a state where the refrigerant circuit switching device switches to and thereby establishes the second circuit, the refrigerant circuit switching device is configured to switch to and thereby establish to a refrigerant circuit that conducts the refrigerant, which is outputted from the evaporating device, to the suction inlet and conducts the refrigerant, which is depressurized by the third depressurizing device, to the intermediate-pressure suction inlet.

16. The refrigeration cycle device according to claim 12, wherein in a state where the refrigerant circuit switching device switches to and thereby establishes at least one of the first circuit and the second circuit, the refrigerant circuit switching device is configured to switch to and thereby establish a refrigerant circuit that conducts the refrigerant, which is depressurized by the third depressurizing device, to the liquid storage and conducts sur, which is outputted from the liquid storage, to the intermediate-pressure suction inlet.
